(19) United States
(12) Patent Application Publication
(10) Pub. No.: US 2017/0004473 A1
(43) Pub. Date: Jan. 5, 2017

(54) System and Method to Design and Perform Computer Application for Multi-Variable Transactions

(71) Applicants: Aaron Wallace, Littleton, CO (US); Glenn Tuscan, Littleton, CO (US)

(72) Inventors: Aaron Wallace, Littleton, CO (US); Glenn Tuscan, Littleton, CO (US)

(21) Appl. No.: 15/202,563

(22) Filed: Jul. 5, 2016

Related U.S. Application Data
(60) Provisional application No. 61/996,998, filed on Jul. 3, 2015.
(60) Provisional application No. 62/218,557, filed on Sep. 14, 2015.

(51) Int. Cl. G06Q 20/18; G06Q 20/10; G06Q 30/06; G06Q 20/20

(52) U.S. Cl. CPC G06Q 20/18; G06Q 20/204; G06Q 20/10; G06Q 30/0643; G06Q 30/0609

(57) ABSTRACT

A system and process to facilitate a multi-variable transaction is described, including software and physical steps.

### CROSS REFERENCE TO RELATED APPLICATION

The application claims the benefit of U.S. Provisional Application No. 61/996,998, filed Jul. 3, 2015, and U.S. Provisional Application No. 62/218,557, filed Sep. 14, 2015, the contents of which are incorporated herein by reference.

### FIELD OF THE INVENTION

The current invention relates generally to systems, methods and user interfaces for facilitating sales and lease transactions, including optimizing multiple transaction variables, presenting such optimization of transaction variables, and providing reporting functions, business analytics and/or other transaction summary information.

The current invention also relates to a unique computer system and application regarding multi-variable transactions that may eliminate or reduce the need to access multiple applications when performing a transaction. The current invention also relates to an improved system and method to design, test, demonstrate and train users for a computer application.

### BACKGROUND OF THE INVENTION

In sales and/or leasing transactions, for example, vehicle transactions, there are often many variables that affect the final terms of the transaction and that require the consumer to deal with multiple aspects of the transaction. This can be confusing and cause mistrust on the part of the consumer. Consumer confusion and mistrust may also arise where consumers are uninformed as to the information and documentation required of them to complete the transaction.

For example, in the field of vehicle sales and leasing, the final terms of the transaction may be influenced by numerous tangible and intangible variables including, for example, vehicle make, model and features, customer credit rating, financing and insurance options, warranties, maintenance plans, etc. To address all these terms, in the past, the consumer typically needed to interact with multiple individuals—for example, a salesperson, a finance person and an insurance person—to complete the purchase or lease transaction.

In the past, the consumer typically had to deal with a salesman and one or more “deal closers.” This type of sales tactic has often been considered intimidating and led to an unenjoyable experience. And while the consumer may have believed that he or she has successfully negotiated the transaction upon reaching an agreement with the salesperson regarding price, in reality, that may have been only a small part of the overall transaction. In such cases, the consumer then typically needs to interact with one or more additional individuals to negotiate and/or make decisions about other variables of the deal, which may have a significant impact on the total price the consumer will have to pay. Moreover, while the consumer may have researched and prepared to select a vehicle and negotiate a price for that vehicle, he or she may not be as well informed about other variables regarding financing and insurance.

Existing sales systems that have attempted to address the foregoing are limited because they may lack transparency about how all the variables may impact the final terms of the deal. In particular, they may lack the ability to show the consumer how a particular transaction term or product impacts the total price and/or monthly payment. Existing systems also do not allow the consumer to make a fully informed decision so as to be able to optimize the variables for their individual needs and/or preferences. Further, existing systems often require that the consumer interact with multiple persons (points of contact) to complete a single transaction which may be intimidating to the consumer.

Thus, there is considerable room for improving the transparency and communication, and thereby the relationship, between a vehicle dealership and its customers. There is also room for improvement regarding transparency and relationship between those customers and any third party service providers such as those in finance, insurance and maintenance.

Furthermore, in the context of vehicle dealerships, the profitability of vehicle sales transactions has generally been decreasing over the years. However, opportunities for profitability exist in the area of accessory products, including, for example, accessories on the vehicle itself, e.g., sport package, as well as peripheral products and services, e.g., insurance, extended warranties, etc., which may be added to the transaction.

In conventional sales processes, it may be difficult for the dealership to accurately determine what vehicle accessories and peripheral products the consumer may actually want and/or need in the first place. As such, the relative costs and benefits of such accessory products may be difficult to explain to the consumer in a transparent, clear and concise manner. Opportunities for profitability may therefore be lost. Thus, there is a need for an effective method for collecting information regarding the wants and needs of the consumer and for providing information to the consumer about the costs and benefits of available accessory products in a transparent, clear and concise manner.

Furthermore, there is a need to improve efficiency in the overall sales transaction, both in terms of reducing the transaction time and in decreasing the number of individuals the consumer must interface with to complete the transaction. A consumer may be more likely to lose interest and walk away from the transaction if he or she perceives that that it will be a lengthy process with multiple steps involving the need to deal with different individuals. Accordingly, there is a need for a system that is more efficient in terms of the time required to complete a transaction, the number of individuals required to be involved in a transaction and the interactivity between the involved individuals, thereby increasing the likelihood of successfully completing the transaction.

There is also a need to collect data on consumers so that it may be used to complete a sales transaction and/or maintain a consumer relationship after the transaction. And where the transaction is not consummated, there is a need to collect consumer data to conduct follow-up inquiries in an attempt to consummate a transaction in the future.

There is also a need for a system and method to monitor sales transactions as they occur in real time, as well as to track historical performance of the sales process. For example, there is a need to determine whether certain steps in the sales process are responsible for sales not being consummated. As another example, there is a need to measure the performance of each salesperson, and how each salesperson performs during each step of the sales process. There is also a need for a business analytics and reporting tools to provide the information on the foregoing in a logical and useful fashion.

There is also a need for a system and method to permit users to search and filter/sort stored data and/or to produce reports incorporating such stored data. For example, there is a need for a system and method that provides consolidated customer histories whereby a user may easily access any stored data relevant to that customer.

There is also a need for a system and method that provides dashboards for allowing a user to view real time transaction status information and data as it is entered in the transaction.

There is also a need for a system and method that provides access to administrative and/or security functions such as configuring electronic forms, assigning user roles and permissions, establishing residual rates and rules, assigning IP address restrictions, and the like.

To improve efficiency in transactions, computers have been employed to replace previously performed manual tasks. But even with such computerized transactions, multiple applications must often still be accessed to perform the transaction. For example, a software application may be used, but other separate, non-integrated third party software may also be necessary to complete the transaction. The requirement to use multiple applications may slow the transaction down significantly. Accordingly, there is a need for a computer application that eliminates or reduces the need to access separate and/or non-integrated applications.

When deploying a computer application, there is often a need to test, demonstrate or perform another function with the application while simultaneously allowing continued development of the application. In many computer applications, however, these activities cannot simultaneously occur; or if they do, the version of the application being, e.g., demonstrated, may be compromised by the simultaneous development work. As such, there is a need for an improved computer application deployment system that allows the foregoing and other functions to occur simultaneously.

### SUMMARY OF THE INVENTION

The current invention addresses the foregoing and other shortcomings of prior transaction management systems and methods, as well as prior computer systems, computer applications and computer deployment systems, by the various inventive aspects described herein. In an aspect of the current invention, a streamlined process for addressing multi-variable transactions is disclosed. For example, in a vehicle sales transaction, the system and method of the current invention may include software to address certain variables or terms of the transaction such as finance options, vehicle type, accessories, mandatory financial disclosures and other variables or terms. The software may provide a number of graphical user interfaces (GUIs) that may solicit information to be inputted by a salesperson/user, and present options and terms to the consumer. This preferably increases efficiency, transparency and consumer satisfaction.

In another aspect of the invention, the software may include a drag and drop option in one or more GUIs or stages of the process so that different terms in the transaction may be adjusted, and so that adjusted terms may be provided to the consumer. This preferably allows the transaction to be customized or otherwise altered to address a consumer's desires and/or other commercial realities and allows the salesperson/user to clearly and concisely demonstrate the relative costs and benefits of adjusting a given term or terms.

In another aspect, the current invention also includes the manner in which the software may interact or cause physical steps to occur in the sales process. These physical steps may include interfacing with a potential buyer at different stages, seeking and obtaining approvals during the transaction to proceed, initiating a test drive, and coordinating inspections for trade-in vehicles, vehicle delivery, follow-up maintenance and other physical steps.

For example, a GUI associated with the software of the current invention may include a button that indicates a consumer has completed or will be completing the steps necessary to take a car on a test drive. This button may initiate the physical process of preparing that car for the test drive and pulling it up to the consumer while the consumer is busy with other aspects of the transaction. It is preferred that this allows the overall transaction to proceed smoothly and efficiently so that the consumer does not lose interest. As another example, a GUI may include a button for a sales person to notify his or her supervisor that a supervisor approval is needed to proceed and/or to suggest that the supervisor introduce himself or herself to the consumer to facilitate the transaction.

The application of the current invention also involves other physical aspects. For example, the application may include a dashboard or other screen that provides visual cues regarding the length of time being spent by the user/salesperson on a particular aspect of the transaction. In a preferred embodiment, these visual cues may be running time clocks keeping track of the time a user spends on an aspect of a transaction, where green means that an acceptable length of time is being spent and red means the user is taking too long. This visual use may also prompt the sales manager to physically visit the user and consumer to get the flow of the transaction back on track.

The system and method of the current invention represents an advance over current online vehicle purchasing sites that merely offer access to a collection of cars online. That is, the current invention helps a consumer navigate through the many aspects of a vehicle purchase or lease from beginning to end. For example, the consumer may be provided with guidance through different aspects of the transaction, such as sales terms, warranty, insurance and other terms of the overall transaction. The system and method may also provide final terms of the transaction as opposed to a quote or an estimate. The system and method may also ensure that mandatory disclosures that are intended to protect the consumer are indeed made to, and acknowledged by, the consumer. This preferably helps the organization selling the vehicles or other items to comply with disclosure laws and regulations.

The current invention also provides a training tool for a dealership's sales force. In this regard the system supports the proficiency of individuals in a sales force in areas outside of their conventional roles. For example, with the present system, sales people may be trained to become more proficient in the sales aspects of the transaction, as well as in the payment/finance, warranty and other aspects that now form part of the overall transaction. The system also supports improved interactivity between different individuals in a sales force. For example, with the click of a button, a sales person may prompt a manager to join the discussion or indicate that a certain vehicle should be made ready for a demo drive.

The current invention also involves improved systems and methods to collect information on the consumers' wants and/or needs. This may occur through a series of GUIs. And after the information is collected, the salesperson may then more effectively provide information on accessories and peripheral products and/or services.

The comprehensive system of the present invention may facilitate a multi-variable sale or lease transaction from initiation to completion and may include, for example, a meet and greet, a concept conversation, a wants and needs analysis, consumer relationship management (CRM) input, a vehicle selection, walk-around, and accessories introduction, a demo drive, alternative trial close procedure(s), a trade-in evaluation, a base payment calculation and agreement, a finance products and final amount due presentation, and finally, a documentation finalization, vehicle delivery, and customer service index (CSI) presentation. The current invention includes software module to perform the foregoing, and the manner in which these modules work together improves the operation of a computer system.

In another aspect of the invention, the system facilitates the collection and use of data, including but not limited to consumer and transaction-related information, at multiple steps of the system. For example, the system allows tracking of the time spent on each step of a given transaction. This information may advantageously be used for reporting purposes and metric analysis. It may also be used, for example, to glean information about areas where additional training may be advantageous (for example, it may indicate that an individual does not spend enough time discussing accessory products, and therefore, fails to maximize potential profitability).

In another aspect of the invention, the system facilitates searching and filtering/sorting stored data and the production of reports incorporating such stored data. For example, the system may provide consolidated customer histories whereby a user may easily access any stored data relevant to that customer. This may in turn reduce or eliminate the need to access separate third party services, e.g., third party DMS or CRM services.

In another aspect of the invention, the system provides dashboards for allowing a user to view real time transaction status information and data as it is entered in the transaction. The dashboard may also be provided to a manager to monitor the progress of transactions being conducted by various users.

In another aspect, the system provides a user access to a plurality of administrative and/or security functions such as configuring electronic forms, assigning user roles and permissions, establishing residual rates and rules, assigning IP address restrictions and the like.

Other aspects of the invention regard the computer software and application that facilitates various steps of a transaction, as well as the infrastructure supporting the application and the manner in which the computer application may be developed and/or deployed. These aspects are thus not necessarily tied to transactions involving the sale or lease of vehicles. Instead, these aspects of the invention reflect improvements in the operation of computer systems and advances in how computer applications operate.

For example, the computer application of the current invention may perform various steps in a transaction by itself while eliminating the need to access other applications and/or reduce the number of other applications that may need to be accessed. In another example, the computer application of the current invention may be integrated with other applications so that they may operate together seamlessly and/or in an efficient manner.

The current invention also involves an improved manner in which the computer application may be deployed while being developed. For example, a version of the application may be demonstrated to users while development simultaneously occurs. This is an improvement over current systems where simultaneous demonstration or other use, and continued development either cannot occur or may occur but where the software becomes impaired, or versions become mixed or other problems are created.

Other features and advantages of the invention will become apparent from the following detailed description of the preferred embodiments taken with the accompanying drawings, which illustrate, by way of example, the principles of the invention.

### BRIEF DESCRIPTION OF THE DRAWINGS

Embodiments of the current invention are described below, by way of example only, with reference to the following drawings.

FIG. 1 is a flow diagram illustrating a system in accordance with various aspects of the invention.

FIG. 2 illustrates a user interface, showing consumer repayment options with disclosures.

FIG. 3 illustrates a user interface for providing a user login.

FIG. 4 illustrates a user interface for providing a customer search option.

FIG. 5 illustrates a user interface for providing a customer search option.

FIG. 6 illustrates a user interface for providing a customer search option.

FIG. 7 illustrates a user interface for providing a customer search option.

FIG. 8 illustrates a user interface for providing a base payment determination.

FIG. 9 illustrates a user interface for providing a base payment import.

FIG. 10 illustrates a user interface for providing a base payment import.

FIG. 11 illustrates a user interface for providing a vehicle information confirmation.

FIG. 12 illustrates a user interface for providing a deal structure.

FIG. 13 illustrates a user interface for selecting finance products.

FIG. 14 illustrates a user interface for providing a cost and coverage verification.

FIG. 15 illustrates a user interface for providing a product selection finalization.

FIGS. 16-36 illustrate user interfaces for providing a consumer repayment option presentation.

FIG. 37 shows an application process breakdown, Transaction Selection.

FIGS. 38A and 38B show an application breakdown, Report Overview.

FIG. 39 shows an overview of a sales process that combines the use of computer implemented steps and physical steps of an overall process.

FIGS. 40.1-40.3 shows a sample report that may be generated by the system of the current invention.

FIGS. 40A-40C show an alternate overview of a sales process that combines the use of computer implemented steps and physical steps of an overall process.

FIGS. 41A and 41B each show an overview of a wants and needs analysis.

FIG. 42 illustrates a user interface for providing a wants and needs analysis.

FIG. 43 illustrates a user interface for displaying a question for a wants and needs analysis.

FIG. 44 illustrates another user interface for displaying a question for a wants and needs analysis.

FIG. 45 illustrates another user interface for displaying question for a wants and needs analysis.

FIG. 46 illustrates another user interface for providing a wants and needs analysis.

FIG. 47 illustrates a user interface for providing a vehicle search and vehicle selection.

FIG. 48 illustrates a user interface for providing a customer information and/or vehicle information confirmation.

FIG. 49 illustrates a user interface for providing a test drive agreement.

FIG. 50 illustrates another user interface for providing a test drive agreement.

FIG. 51 illustrates a user interface for selecting a test drive agreement.

FIG. 52 illustrates a user interface for ending a test drive.

FIG. 53 illustrates a user interface for providing a finance payment calculator.

FIG. 54 illustrates a user interface for providing a customer acknowledgment of basic terms agreement.

FIG. 55 illustrates a user interface for providing a quick quote.

FIG. 56 illustrates a user interface for providing a menu.

FIG. 57 illustrates a user interface for providing a deal search.

FIG. 58 illustrates a user interface for providing a trade-in evaluation notice.

FIGS. 59A-E illustrate user interfaces for providing a finance payment calculator including a trade in.

FIG. 60 illustrates a user interface for providing customer acknowledgement of basic terms agreement.

FIG. 61 illustrates a user interface for providing a product selection.

FIG. 62 illustrates a user interface for providing a customer search.

FIG. 63 illustrates a user interface for editing customer data.

FIG. 64 illustrates a user interface for providing a customer history.

FIG. 65 illustrates a user interface for providing customer authorization of electronic signature.

FIGS. 66A and B illustrate user interfaces for providing an electronic signature capture.

FIG. 67 illustrates a user interface for providing an event dashboard.

FIGS. 68 and 69 illustrate user interfaces for providing an event type page.

FIG. 70 illustrates a user interface for providing a traffic log.

FIGS. 71 and 72 illustrate user interfaces for providing deals reports.

FIGS. 73-76 illustrate user interfaces for providing electronic forms configuration.

FIGS. 77-80 illustrate user interfaces for providing electronic forms presentation.

FIGS. 81-83 illustrate user interfaces for providing roles and permission assignments.

FIG. 84 illustrates a user interface for providing residual rates.

FIG. 85 illustrates a user interface for providing residual rules.

FIG. 86 illustrates a user interface for providing IP address restrictions.

FIGS. 87A-87B show the modules of the computer application and the manner in the modules interact with each other and third party services.

FIG. 88 is a system diagram showing the infrastructure of the current invention.

FIGS. 89-90 show infrastructure and the manner in which the computer application of the current invention may be deployed.

### DETAILED DESCRIPTION OF THE PREFERRED EMBODIMENTS

The current invention provides a system and streamlined process to address various aspects of a multi-variable transaction, such as the purchase of a vehicle. The system and process involves software and a series of user interfaces that allow a consumer to iteratively select a vehicle, accessories, payment and financing options, insurance and other aspects to consummate a vehicle purchase. Required disclosures may also be made to the consumer throughout the process and the consumer may also acknowledge that such disclosures were made.

However, the current invention is more than a series of computer screens that may be used during a sales process. The manner in which the software presents the transaction preferably enhances the sale process and avoids the stress and discomfort of typical haggling. The system also involves the manner in which physical steps may be addressed and carried out. To this end, certain user interfaces may be used to trigger the preparation and delivery of a car to test drive while other aspects of the transaction are simultaneously being addressed. In this manner, the transaction may proceed efficiently and smoothly to avoid losing the consumer's interest which in turn preferably helps increase the number of successful transactions. Beyond the foregoing, the system and method allow transactions and the steps thereof to be monitored to provide analytics and other reporting functions.

The current invention also relates to an improved computer application and supporting software, as well as the computer system and infrastructure supporting the software. The current invention allows a computer to operate more efficiently in terms of completing a transaction or the manner in which the application may be deployed.

The current invention is now described with reference to the figures, which represent examples and are not intended to be limiting.

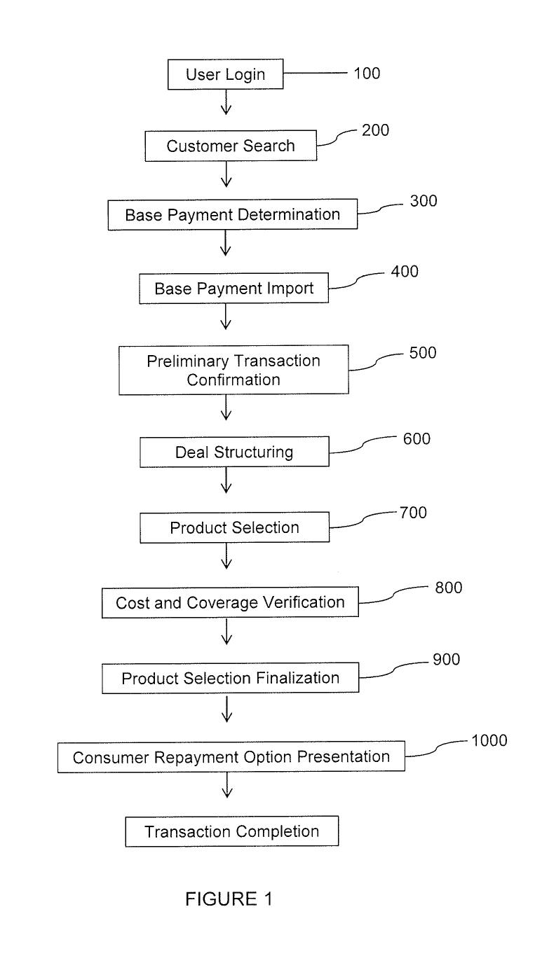

FIG. 1 shows a flow diagram illustrating an aspect of the system 10 and method of the current invention. More specifically, FIG. 1 generally shows the steps that may occur during the “desking” aspect of a transaction such as the sale or lease of a car or other vehicle and/or steps that are related thereto. The desking aspect of the invention generally relates to the collection and/or accessing of customer information, and the determination of financing and other sales terms of the car purchase or lease once the car has been chosen. The desking aspect may also provide the opportunity for the car dealership to offer various items such as accessories, warranties and other items, and then determine financing terms based on what the consumer desires to purchase. As discussed in more detail later, the computer application of the current invention may incorporate a desking aspect, or efficiently interface with a third party desking service.

System 10 may generally include a computer implemented system for facilitating multi-variable transactions such as sales and/or lease transactions of vehicles. In one embodiment, system 10 preferably facilitates a single point-of-contact sale, lease or other transaction. That is, system 10 may guide a consumer through the sales process so that he or she preferably interacts with one salesperson or representative (or a reduced number of representatives) through the transaction. System 10 may also optimize multiple transaction variables, and present such optimization of transaction variables to a consumer.

As illustrated in FIG. 1, system 10 may provide a vehicle sale and/or lease facilitation procedure including a user login 100, a customer search 200, a base payment determination or “desking” 300, a base payment import 400, a preliminary transaction confirmation 500, a deal structuring 600, a product selection 700, a cost and coverage verification 800, a product selection and finalization 900, and a customer repayment option presentation 1000. The user may generally be a salesperson or other representative or individual handling the transaction.

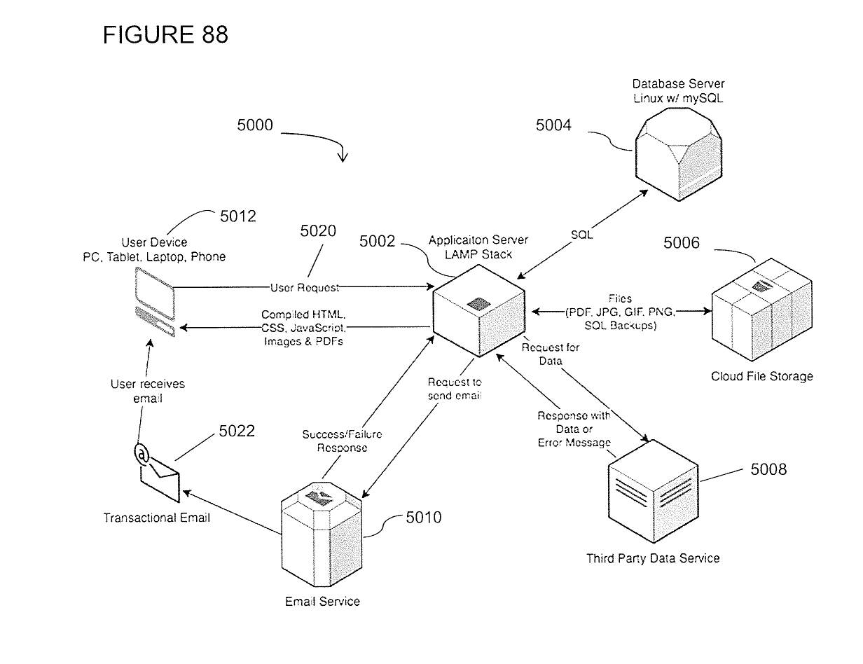

System 10 may reside on a server or servers, or other platform that may be accessed through a user interface on a computer, tablet, a website or other device having a series of user interfaces, pages, or screens which address various aspects of the transaction. In certain embodiments, system 10 may also be accessed by smartphones and other mobile devices. System 10 also preferably includes a database, web server and/or other means to store and provide information. As shown in FIG. 88, system 10 may also be configured to access third party databases and information to the extent necessary that such third information facilitates the sale, lease or other transaction.

In a preferred embodiment, one or more of the user interfaces, pages or screens may be displayed by the user, such as a salesperson, on a computer screen, tablet, mobile device or other screen for the consumer to view during the course of the transaction. This may occur as the consumer views a vehicle at a dealership and discusses the transaction with a salesperson or other representative. In other embodiments, system 10 may be directly used by a consumer who may not be accompanied by a salesperson. As such, the consumer is a user himself or herself. In this manner, the series of user interfaces may provide assurance to the consumer throughout the transaction. For example, various parameters of the transaction may be changed by the consumer during the transaction to customize the terms of the transaction to the particular consumer, and system 10 may recalculate and provide the consumer with the terms of the transaction based on these changes.

In a preferred embodiment, system 10 is compatible and/or integrated with a system administrator's dealer management system (DMS) that may provide calculation of financing terms and other aspects of the transaction. For example, the user may input information collected by system 10 and log into a DMS, which may then use the collected information to determine sales terms. Information that was previously input into the DMS may also be pulled up so that a particular transaction may be accessed, for example, for accounting purposes. As another example, DMS may be accessed to address or finalize documents associated with state agencies and/or banks.

While system 10 may be compatible with a DMS system, in a preferred embodiment, the system and method of the current invention may contain storage capability and software to provide these functions itself to avoid or reduce the need to access separate applications. But even where a third party DMS service is used, system 10 preferably interfaces with such third party service to avoid slowing the transaction.

Additionally, system 10 may be compatible and/or integrated with a system administrator's Customer Relationship Management (CRM) System so that the dealership's interactions with current and future customers may be managed. To this end, CRM systems may automate and coordinate follow-up communications with customers or potential customers. For example, if a customer ultimately chooses not to complete a transaction facilitated by system 10, the data that was collected during the attempted sale may still be stored by a CRM system so that it is accessible and usable in the future, to allow the dealership to follow up with a consumer in an informed and personalized matter to try to re-engage the consumer in the future to again attempt a sale. For example, information collected by the wants and needs analysis described herein may be used to more effectively target marketing material to the appropriate consumer. Alternatively, that information may be referenced for future marketing and/or demographic purposes.

While system 10 may be compatible with a CRM system, in a preferred embodiment the system and method of the current invention may contain storage capability and software to store pertinent information and provide CRM functions. But again, the use of any third party CRM service preferably occurs efficiently to avoid slowing the transaction.

In one form, system 10 may provide a sale and/or lease facilitation procedure for an automobile dealership. While the following description focuses on facilitating vehicle sales transactions, the current invention may be used in connection with any type of sales and/or lease transaction.

Reference again to FIG. 1, system 10 may be used by a salesperson representing an automobile dealership, to walk a customer through each step in the sales/lease process en route to a completed transaction. System 10 advantageously permits the salesperson or representative to be the customer's single or primary point-of-contact for the entire transaction. This is contrary to conventional systems where the customer may interact with different individuals—for example, the salesperson, the sales manager and the finance/insurance person—to complete the transaction. As such, system 10 fosters a one-on-one situation, or a situation with a reduced number of dealership representatives.

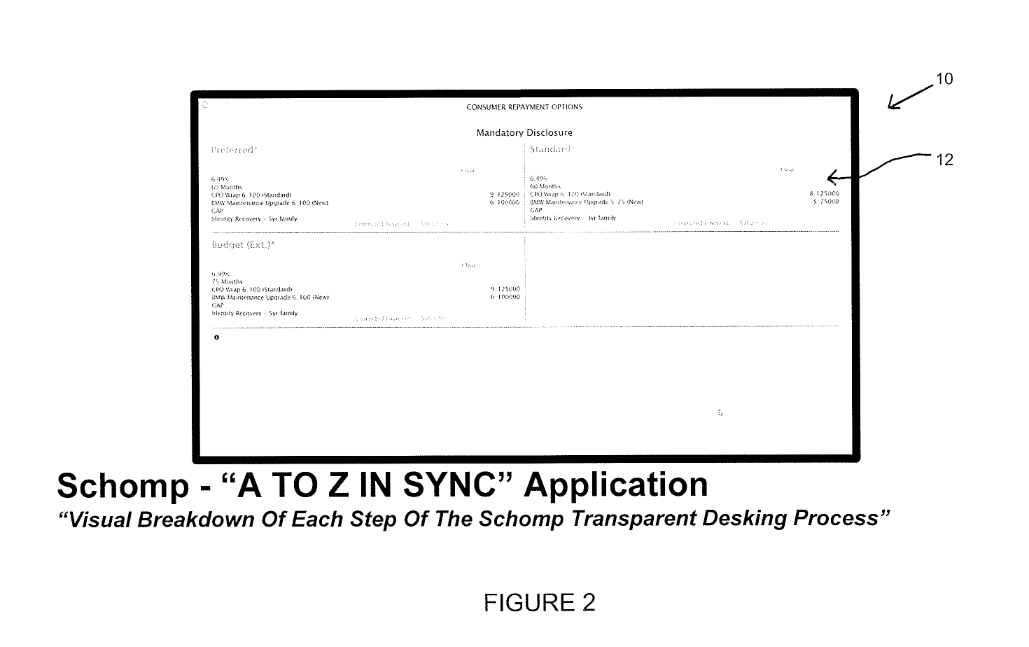

An aspect of system 10 regarding the “desking” of a car sale or lease and related steps are now further described with reference to FIGS. 2-36. As shown, FIGS. 2-36 may comprise a series of user interfaces 12 that may be displayed on a tablet or other electronic device. System 10 may be accessed and utilized through one or more of these user interface(s) 12. In a preferred embodiment, the user interfaces may comprise a plurality of graphical user interface (GUI) screens or pages 12 arranged, for example, in a hierarchical format that may chronologically address the different steps of the sales transaction.

Each GUI screen or page of the user interface 12 may include a number of data fields for entering data information. They may also include a number of tabs, buttons, and/or links that a salesperson or user may select or “click” to perform a function such as saving newly entered or edited data items or navigating forward or backward between the pages. FIG. 2 is a sample GUI relating to consumer repayment options and mandatory disclosures. This GUI may be used later in the desking process as described later.

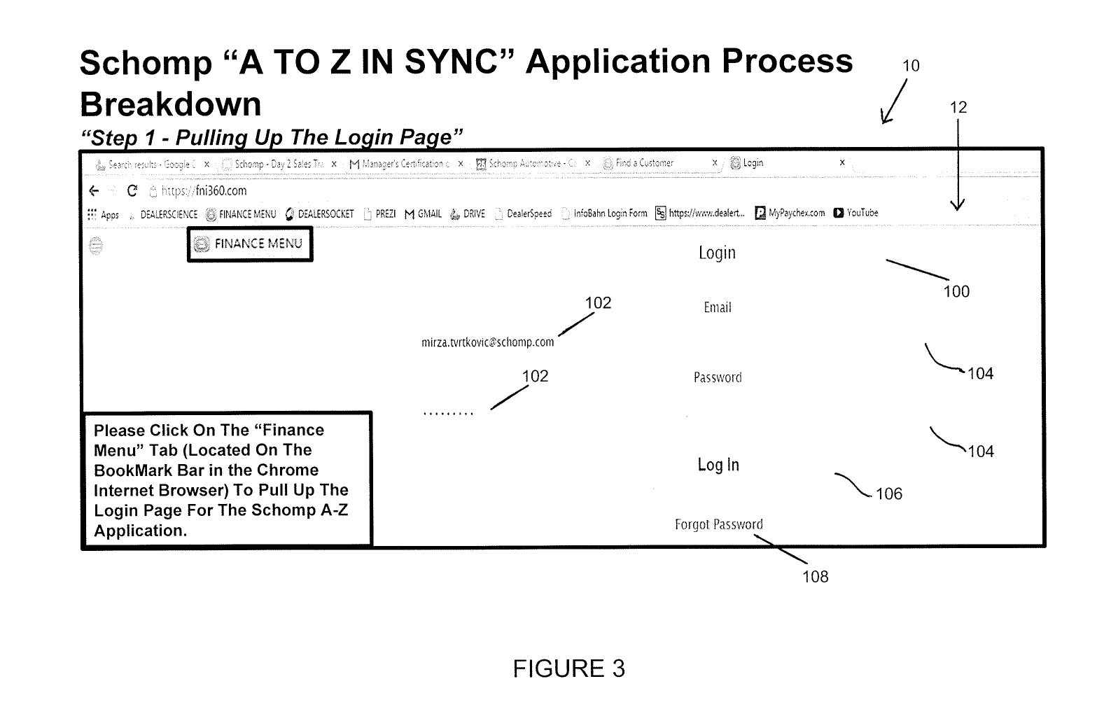

As shown in FIG. 3, a user may first log in to the system 10 at a user login 100 screen. In a preferred embodiment, the user may be a car salesperson who may use system 10 during an attempted sale, lease or other sales transaction. However, the current invention is not limited to just car salespeople, but may instead apply to other industries and other types of users. In any event, the user may log in by entering one or more login data items 102 in one or more login fields 104, for example, a user name, an email address, and/or password and then clicking a login button 106, or any other suitable method.

The user seeking to use system 10 preferably goes through a preliminary registration process that may facilitate security and provide information for accounting, marketing or other business analytics purposes. Once a user has been registered to use system 10, he or she may log in as described above. By logging on, For example, the time spent on system 10 by particular users may be tracked. More particularly, the time spent on each step of the sales process as described herein may be tracked, which may provide useful business analytics to train salespeople. For example, if a particular salesperson is spending too much time on a particular step, and loses the potential customer at that point in the process, the reporting function of system 10 may identify that as a problem and the salesperson may be trained accordingly. Conversely, salesperson successes may also be tracked and reported by system 10.

As shown, the user login 100 screen may also include a forgotten data link or button 108 that a user may select if he or she has forgotten or misplaced his or her personal login data items 102. The user and/or system 10 administrator may also establish an internet bookmark for allowing the user to quickly pull up the user login 100 screen.

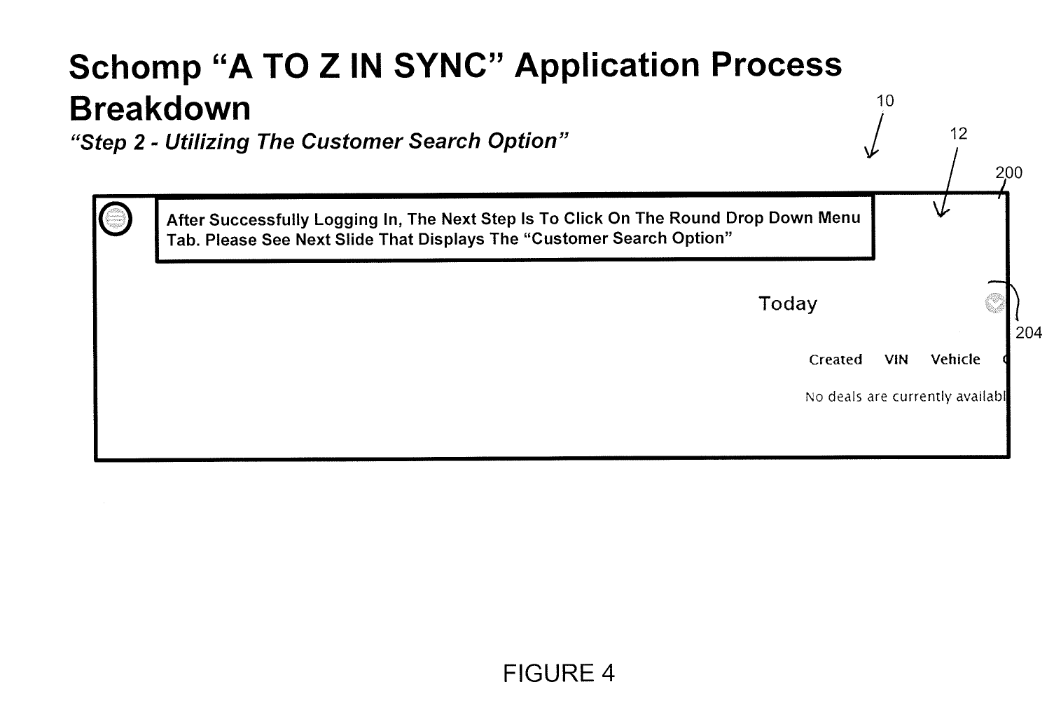

As shown in FIGS. 4-7, once logged in to system 10, the user may access a customer search 200 function. It is preferred that the salesperson perform the customer search before proceeding with the transaction so that the salesperson knows whether there is any history between the consumer and the dealership. If so, the salesperson's efforts during the current transaction will benefit from knowing more about the consumer and the manner in which prior transactions or attempted transactions have occurred.

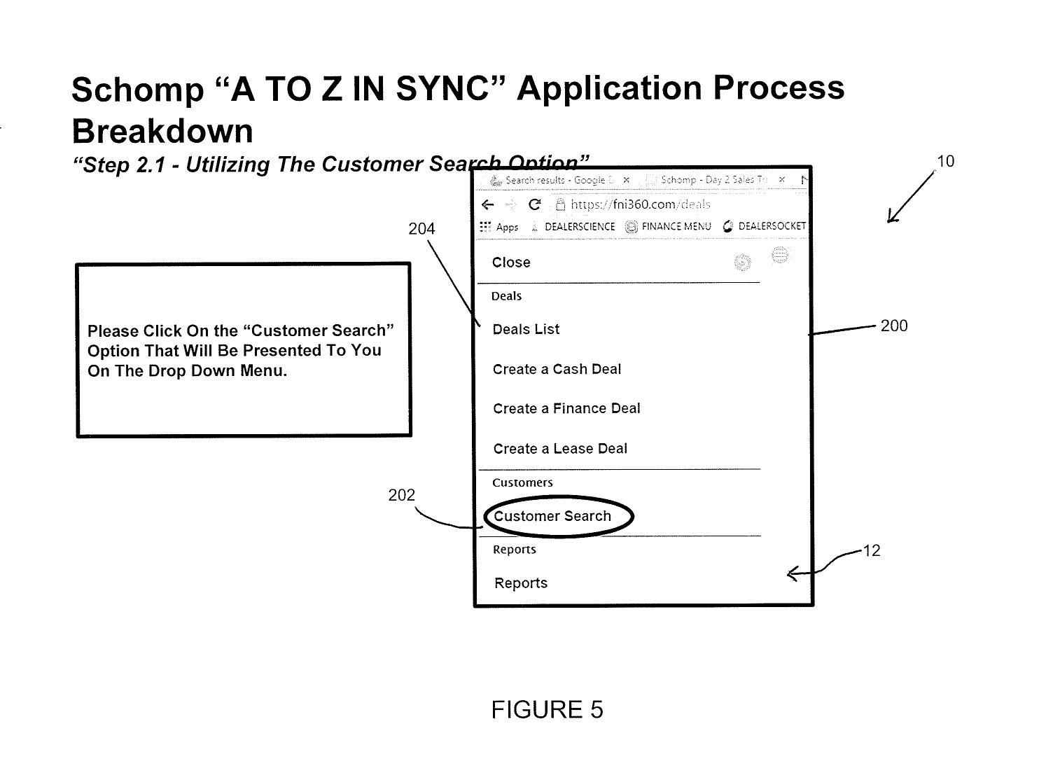

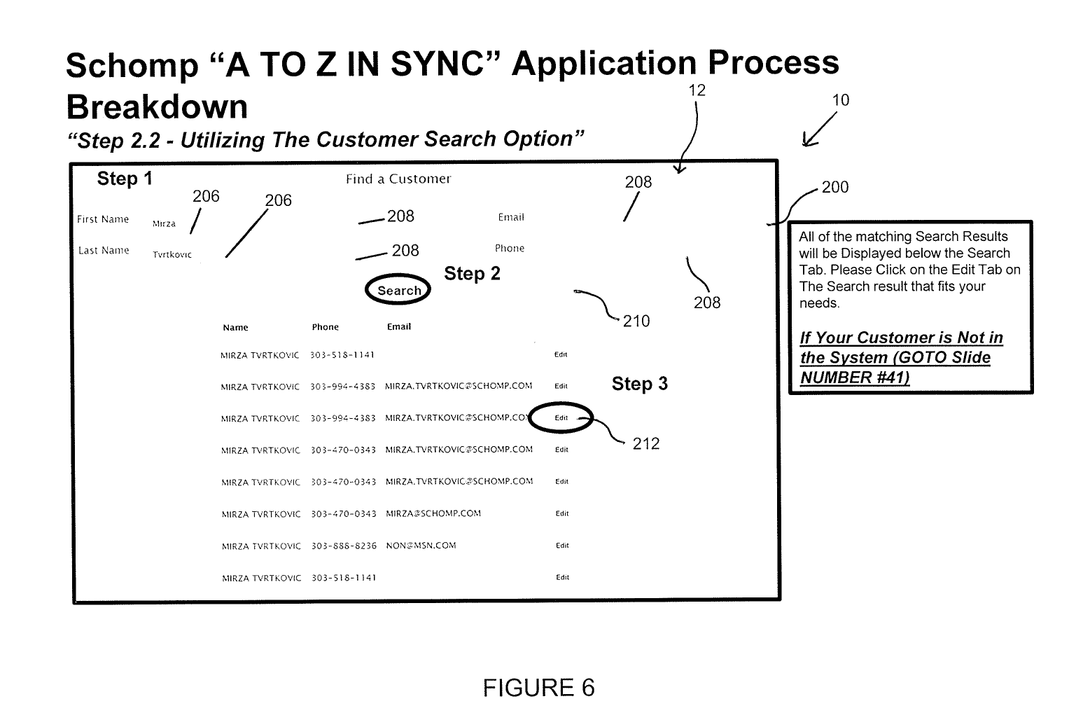

As shown in FIGS. 5 and 6, the user may select the customer search function 202 from a menu 204 of available functions and then inputting one or more customer data item(s) 206, such as the first or last name, e-mail address, social security number, phone number, home address, and the like in one or more customer data search field(s) 208 and clicking a search tab 210 to search the system 10 database.

As shown in FIG. 6, where the information about that customer is already stored in the system 10, the GUI may display a list of any search results containing matching customer data, and the user may select from the displayed search results by clicking a button 212 next to a particular search result to retrieve any stored customer data. As noted above, accessing any stored customer data from prior transactions may help the salesperson in the current transaction. For example, the salesperson may more quickly learn about the customer and thus need not spend time gaining background information. This is preferred in order to avoid prolonging the overall transaction which may cause the consumer to lose interest and result in a lost sale.

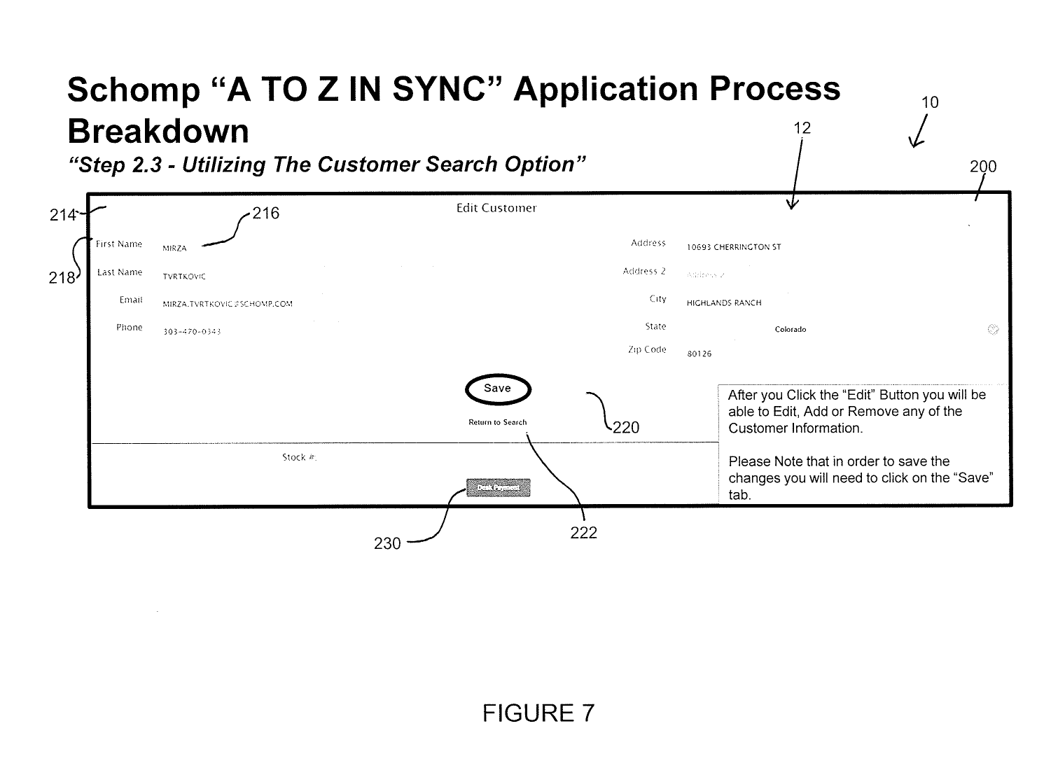

As shown in FIG. 7, upon selecting a certain search result, the user may access a stored customer entry 214 and edit any stored customer data items 216, by making additions, deletions, and/or revisions within a number of customer data fields 218, and saving the revised customer data to the database, for example, by clicking a save button 220. The stored customer entry 214 screen may also include a return button 222, that the user may select to return to the search results.

Alternatively, if the customer search 200 does not return any search results with matching customer data, for example, in the event the person is a new customer not yet included in the system 10 database, system 10 may include a new customer entering field for allowing the user to create a new customer entry.

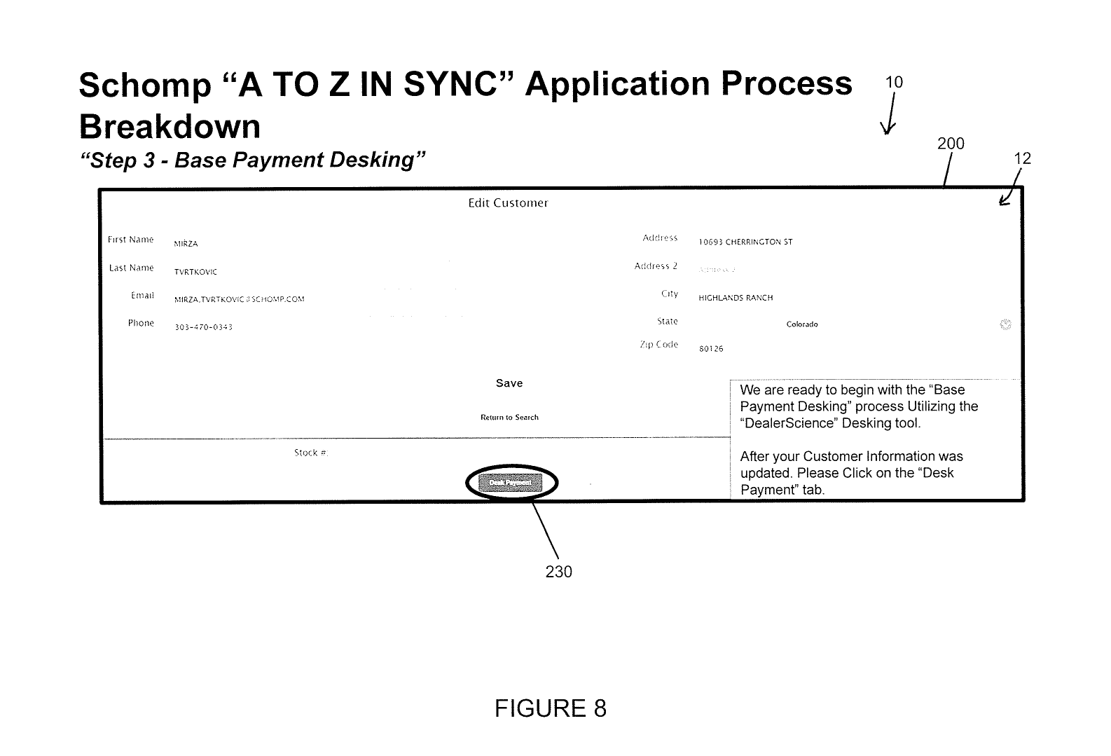

Once a customer is identified or entered in the system 10 and/or the customer data is updated as appropriate, the user may proceed to a base payment determination 300 screen (of FIGS. 1 and 8), for example, by clicking a desk payment button 230 as illustrated in FIG. 8.

The base payment determination or “desking” 300 step and GUI may incorporate a base payment or lease desking tool 302. In one form, the desking tool 302 may be a web-based desking tool that compiles and updates information from manufacturers and lenders and generates estimated monthly payments for financing and/or lease transactions. It may be accessible by a computer or mobile device.

The desking tool 302 may allow the user to select a particular vehicle and present payment options to the customer. It may allow the user to present comparisons of different financing and/or lease options from different lenders. It may be customizable, for example, by modifying lender details and/or options to select the transaction variables that meet the individual customer's needs. It may also allow the user to copy and paste text, including payment summaries and explanations, into the user's email to assist with follow-up.

The desking tool 302 may be integral with system 10 or it may be a separate web-based system. In one form, the desking tool 302 may be a commercially available product such as the DealerScience™ desking product or other suitable desking product, but it should be noted that the current invention may be used with other desking products, and as noted above, system 10 may itself include software to provide the desking function. In this manner, the current invention preferably avoids or reduces the need to access separate applications. In any event, if the desking tool 302 is a separate system, it is preferably compatible with system 10 such that the base payment determination and/or other appropriate data may be imported into system 10 via a base payment import 400. In one form, this may include screen scraping and copying data and programming into system 10. In this embodiment, system 10 may store information culled from a third party service in an appropriate database.

It is preferred that after a particular vehicle is selected, the desking function of system 10 may quickly perform calculations of various financing and other sales terms to avoid slowing down potential sales transactions. For example, different financing options may be quickly provided to the consumer so that the consumer knows his or her options which may help the transaction being consummated. As another example, terms that would be associated with a sale may also be converted to terms that would be associated with a lease. As other examples, trade-in value, accessories, warranties and/or other items may be factored in. Besides avoiding the consumer losing interest because time is lost crunching the numbers, the efficient performance of these calculations also preferably increases the overall efficiency of the dealership.

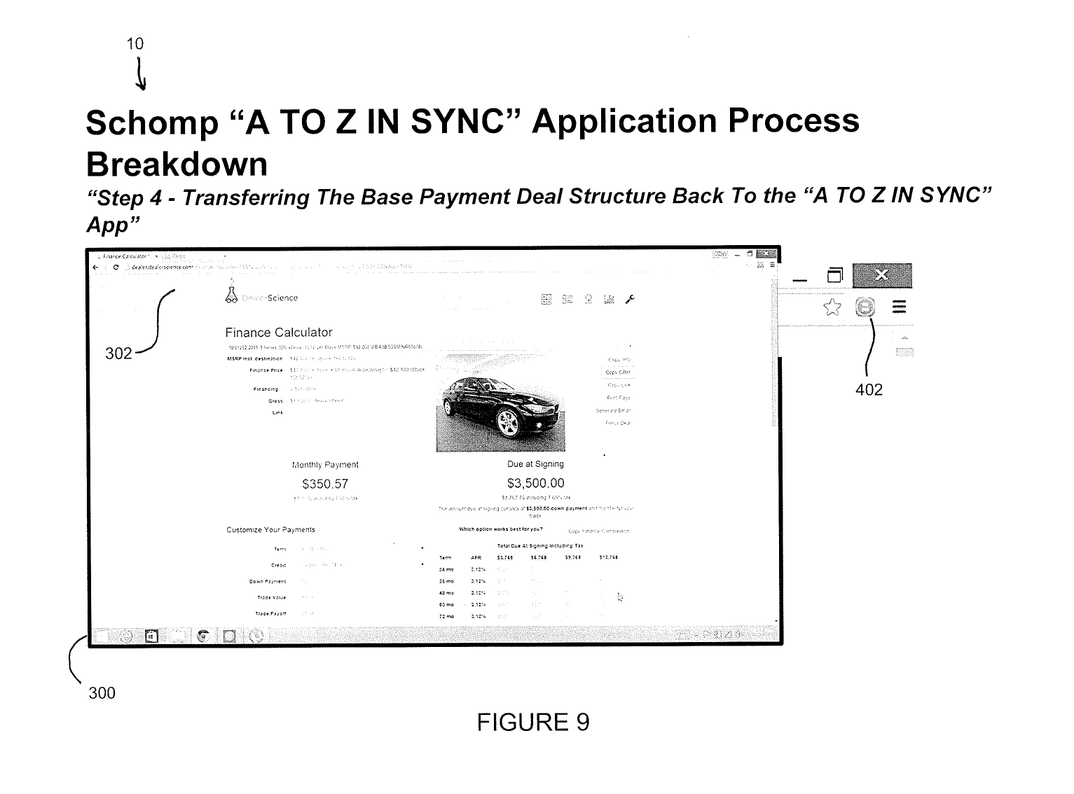

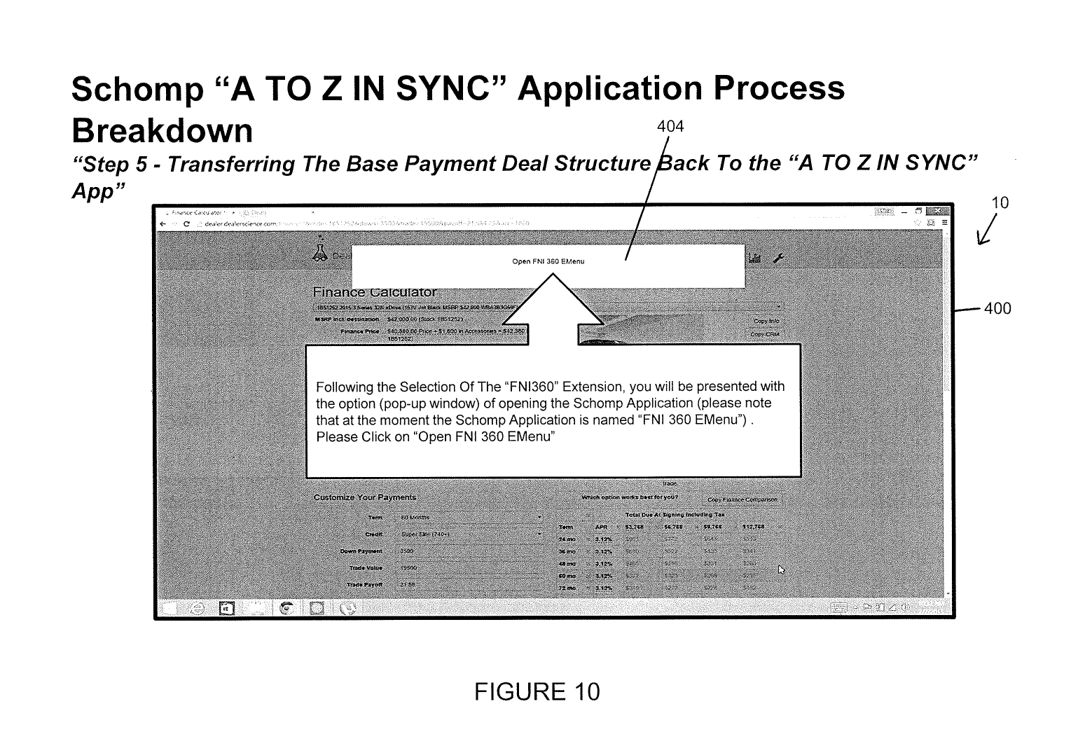

After the base payment determination 300 has been made, as illustrated in FIGS. 9 and 10, the base payment import 400 may occur, for example, by the user clicking an icon 402 representing the system 10 to initiate the base payment import 400 process and then clicking an open tab 404 to open system 10. Where system 10 internally includes software that provides the desking function, a separate import step is unnecessary.

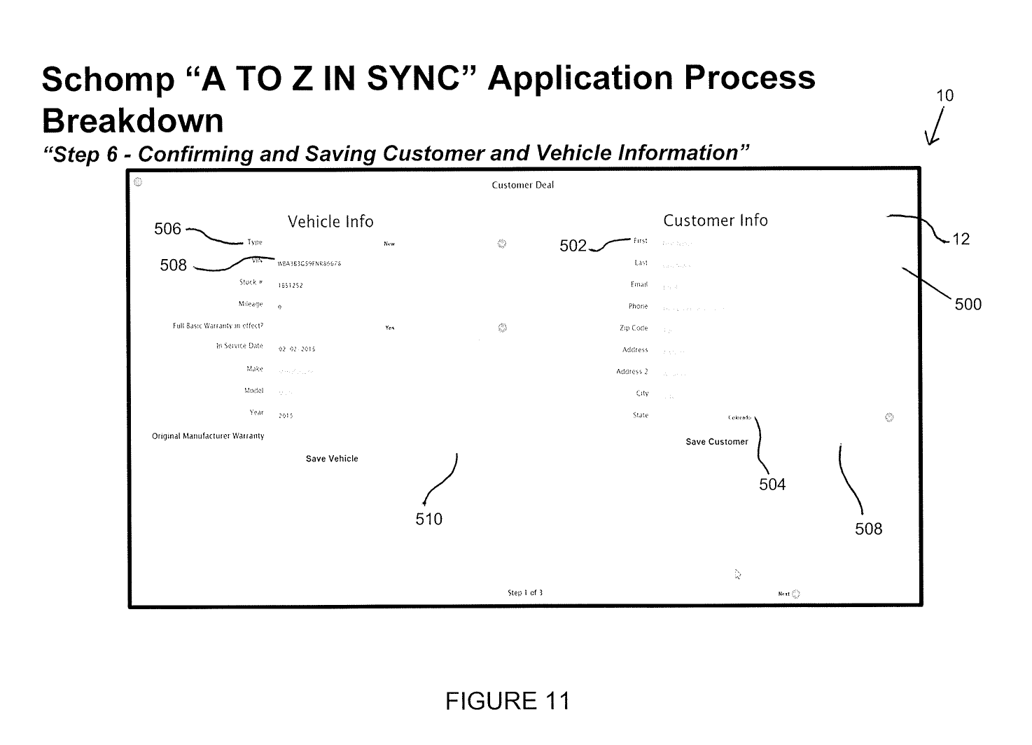

As shown in FIG. 11, once the base payment has been imported into system 10, the system 10 may provide a preliminary transaction confirmation 500 page. The preliminary transaction confirmation 500 page may include one or more customer data fields 502 displaying one or more customer data items 504 that had been previously entered into system 10, for example, first and last name, email address, phone number, address, city, state, and the like, and/or one or more vehicle data fields 506 displaying one or more vehicle data items 508, for example, type (new or used), vehicle identification number (VIN), stock number, mileage, warranty status, in service date, make, model, year and the like.

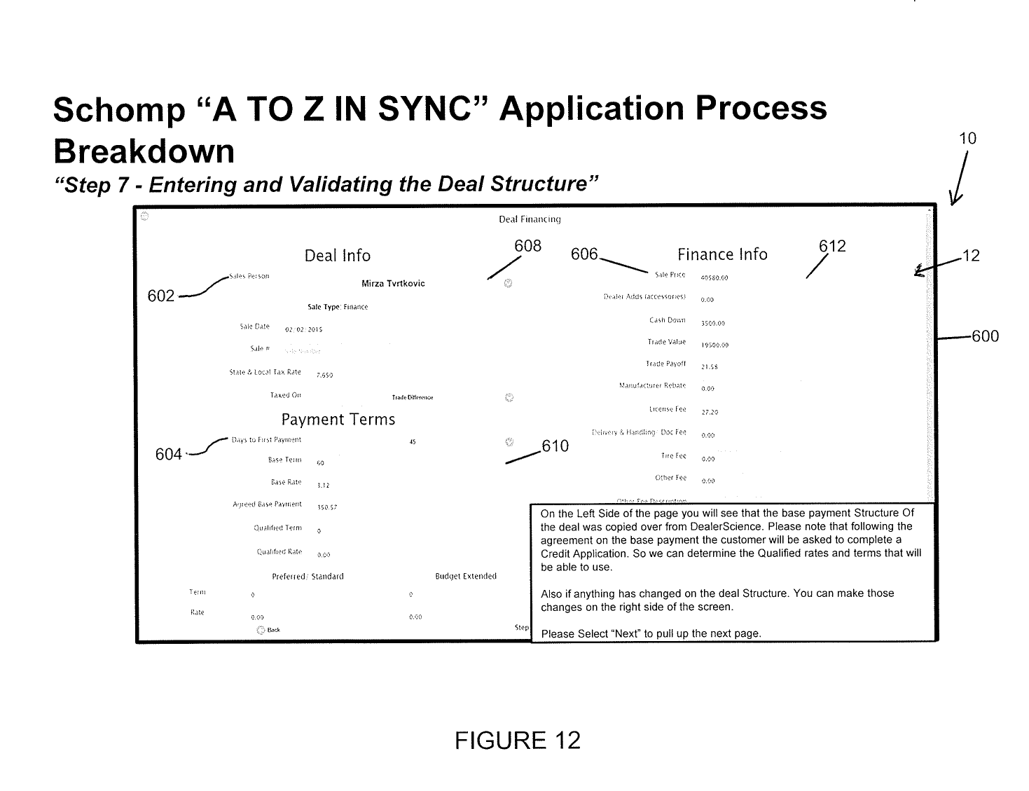

The customer data items 504 and/or vehicle data items 508 may be reviewed and/or revised as appropriate, for example, by clicking one or more customer data fields 502 and/or vehicle data fields 506 and entering any required changes. The user may then click a save customer button 508 and/or save vehicle button 510 to save any changes to the customer information and/or vehicle information, which may lead the user to the GUI regarding deal structuring as shown in FIG. 12.

As shown, deal structuring 600 page may include a plurality of fields for additional transaction terms. For example, the deal structuring 600 may include one or more deal information data fields 602, one or more payment terms data fields 604, and/or one or more finance information data fields 606 for entering one more deal information data items 608, one or more payment terms data items 610, and/or one or more finance information data items 612, respectively.

The deal information data fields 602 may include but are not limited to, for example, salesperson name or identification, sale type (for example, finance, cash or lease), sale date, sale identification number, state and/or local tax rate, taxed on amount, and the like. The payment terms data fields 604 may include, but are not limited to, for example, days to first payment, base term, base rate (base interest rate), agreed base payment, qualified term, qualified rate (qualified interest rate), and the like. This may include a comparison of preferred, standard, and budget extended terms. The finance information data fields 606 may include, but are not limited to, for example, sale price, dealer adds (e.g. accessories), cash down, trade value, trade payoff, manufacturer rebate, license fee, delivery and handling and/or document fee, tire fee, other fees, and the like. Each item of data may be added, edited, and/or deleted as appropriate.

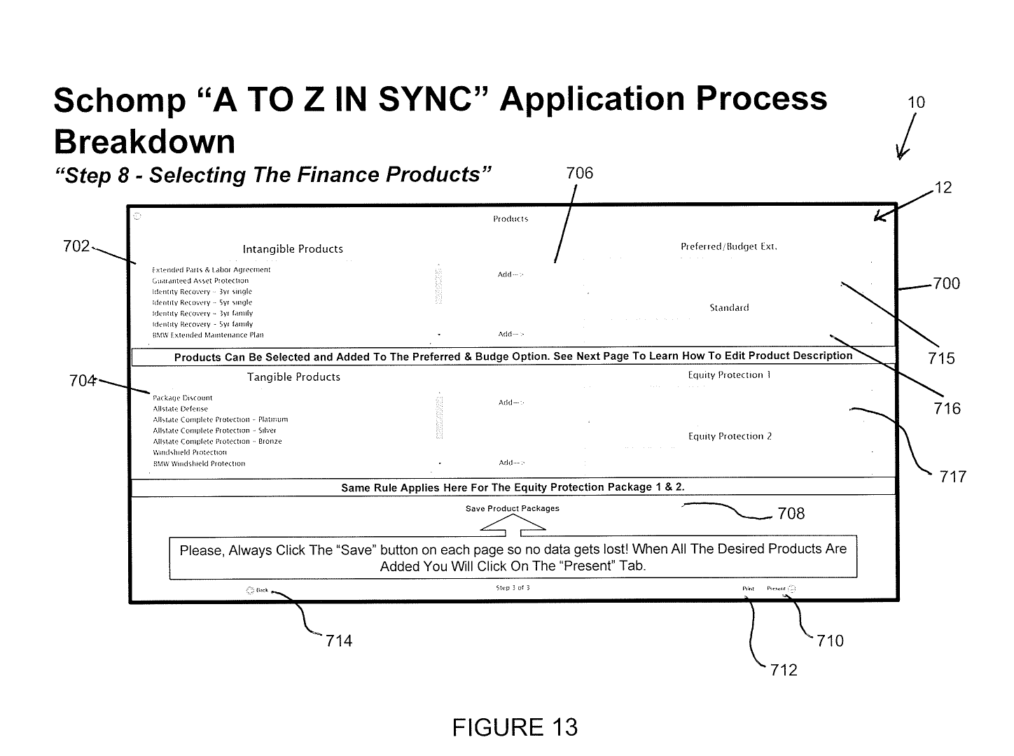

In one form, the base payment structure may be imported or copied from the desking tool 302. Upon reaching agreement with the customer concerning the base payment, the customer may also complete a credit application to obtain a personalized qualified rate. The user or consumer may select a next button to move on to a finance product selection 700 GUI or page as shown in FIG. 13.

As shown in FIG. 13, the product selection 700 page may include a list of available intangible products 702 and a list of available tangible products 704. Intangible products may include, but are not limited to, for example, extended parts and labor agreements, guaranteed asset protection, identity recovery plans, extended maintenance plans and the like. Tangible products may include, but are not limited to, for example, package discounts, insurance, protection, plans, part protection, and the like.

In one form, one or more tangible and/or intangible products may be selected by the user and added to the customer's transaction, for example, by highlighting a product and clicking an add button 706. In one form, the tangible products may be added and displayed in a preferred/budget option field 715 and/or a standard option field 716 depending on which add button 706 the user clicks after selecting a product. Likewise, intangible products may be added to one or more equity protection package fields 717 by clicking the appropriate add button. It is preferred that the products selected reflect the customer's wants and needs as would have preferably been communicated by the customer through appropriate inquiries by the user salesperson.

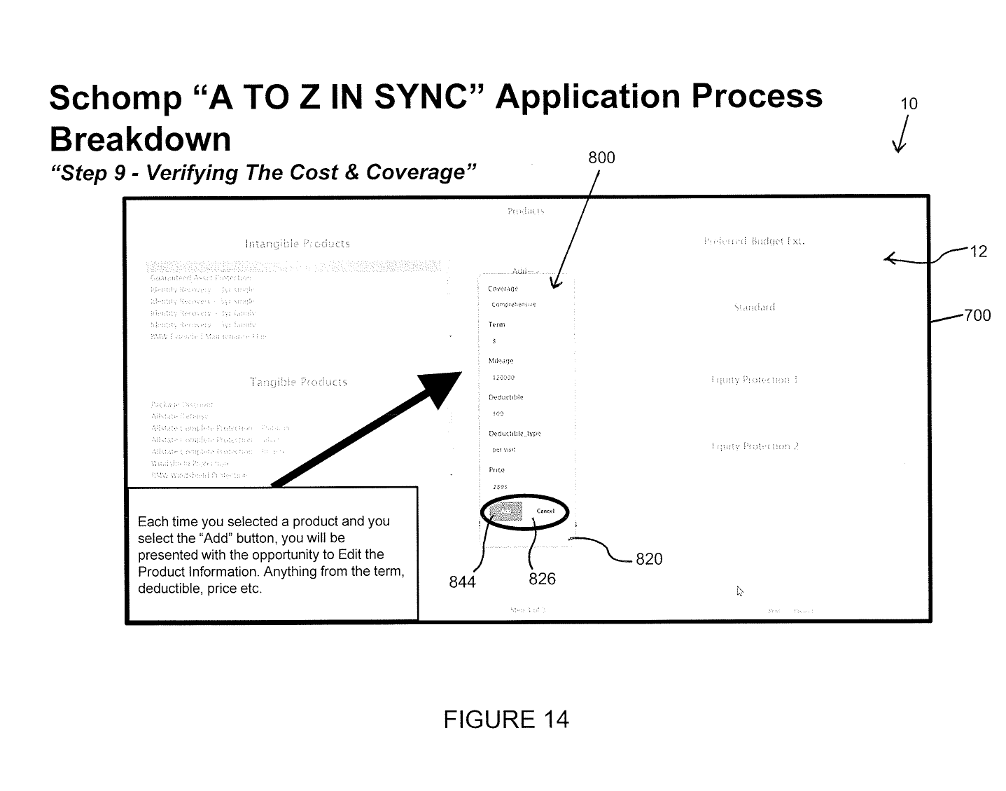

As shown in FIG. 14, in one form, the system 10 may display a product cost and coverage verification 800 screen each time the user or consumer selects a product to add. The product cost and coverage verification 800 screen may have one or more editable product data fields 822. The product data fields 822 may include, but are not limited to, for example, coverage, term, mileage, deductible amount, deductible type, price, and the like. The cost and coverage verification 800 screen may include an add button 824 for confirming the addition of the product and a cancel button 826 for canceling the addition of the product.

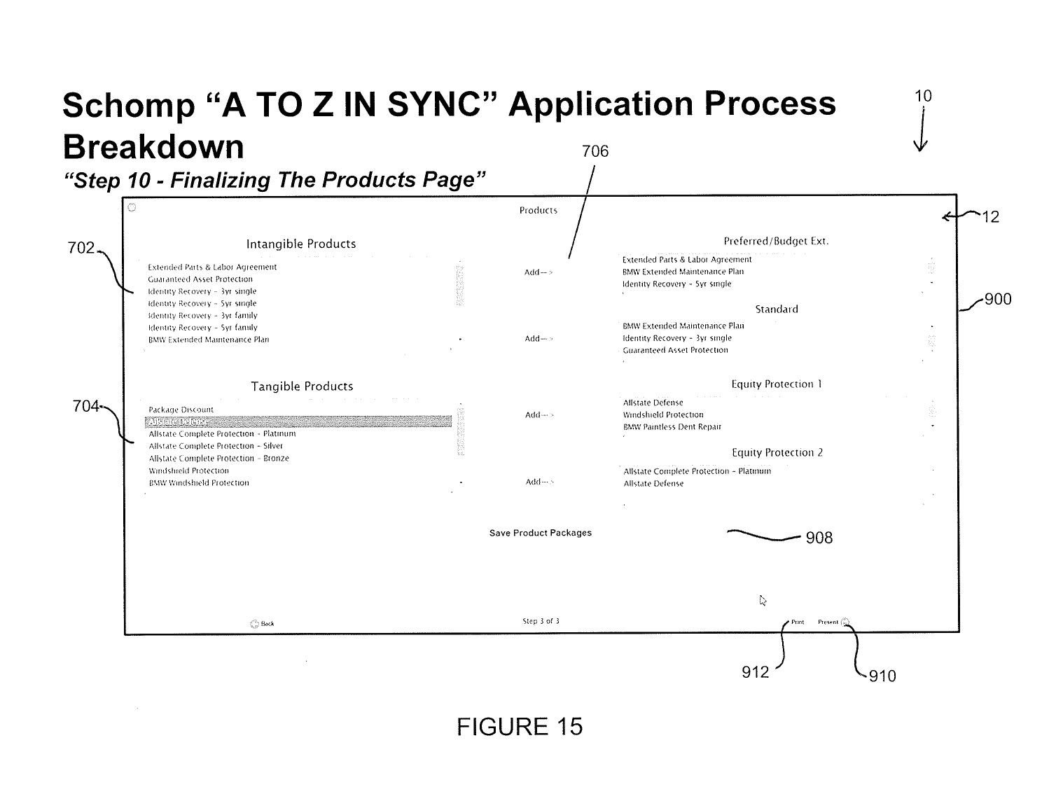

With reference to FIG. 15, once the user has added all of the desired products, a product selection finalization 900 screen allows the user or consumer to click a save button 908 to save the package options. Then the user may click a present button 910 to proceed to a consumer repayment option and presentation 1000 page.

Optionally, the user may click a print button 912 to send the presentation to an available printer for printing a hard copy.

At this point in the transaction, the user may apprise the consumer that certain disclosures regarding the sales terms must occur. As described below, certain GUIs may later appear which allow the consumer to initial or sign the GUI to confirm that the disclosure was indeed made.

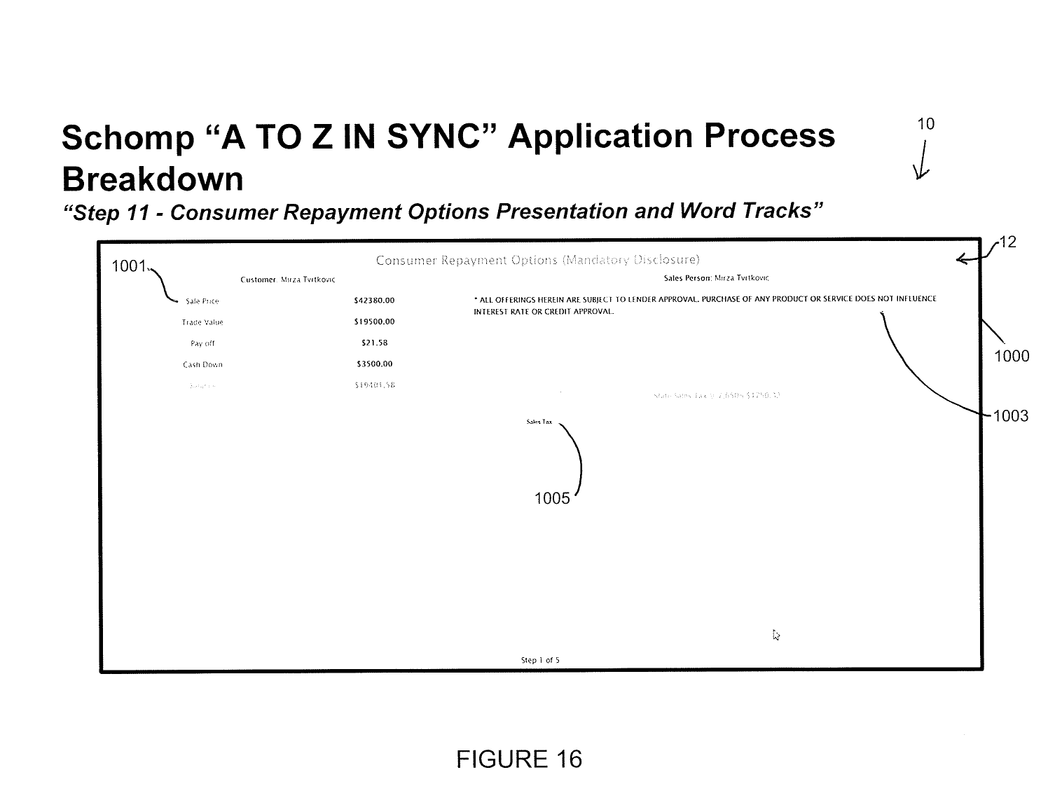

With reference to FIGS. 16-36, the system 10 next provides a consumer repayment option presentation 1000. The consumer repayment option presentation 1000 may include numerous screens or pages. It preferably includes presentation of certain mandatory disclosures. As described in further detail below, in one form, the user or consumer must click certain buttons, tabs, or links to display certain screens and/or mandatory disclosure statements prior to proceeding with the transaction via the system 10. In another form, the system 10 may include a timekeeper that tracks the amount of time the system 10 displays certain screens and/or mandatory disclosures.

As shown in FIG. 16, the consumer repayment option presentation 1000 screen may include one or more data fields 1001, including but not limited to, for example, customer name and/or identification, sale price, trade value, pay off, cash down, balance, salesperson name and/or identification. It may also include one or more disclosure statements 1003, such as a statement that the offerings are subject to lender approval or that the transaction is subject to sales tax.

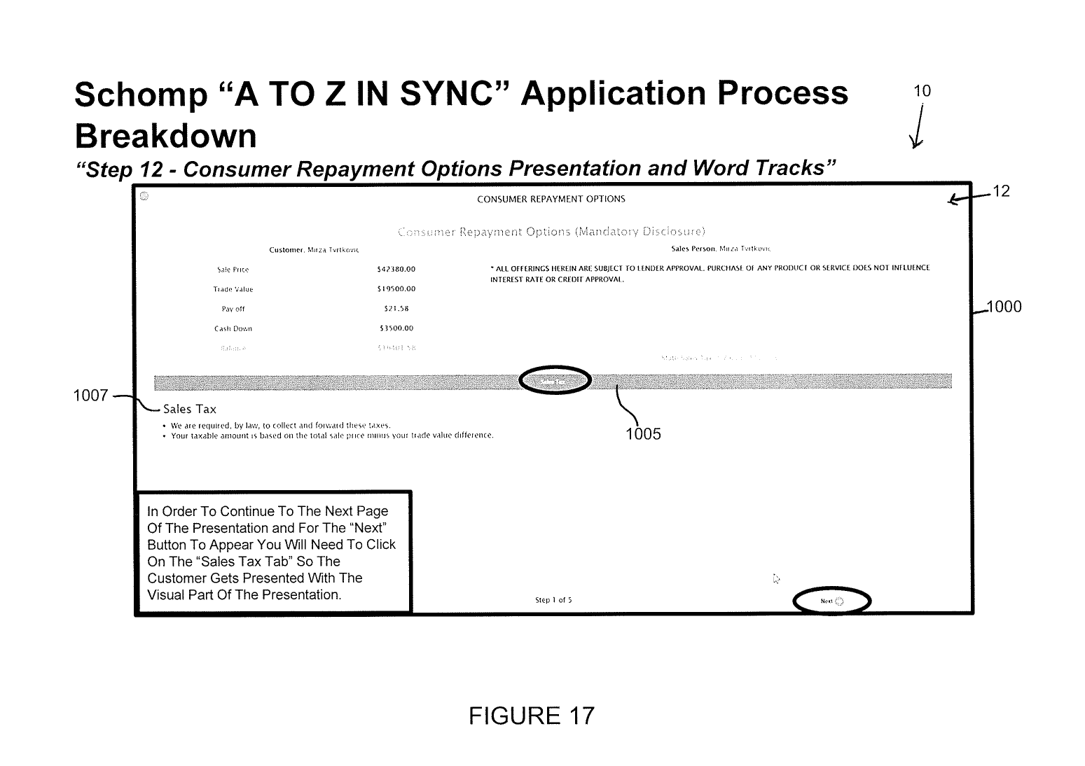

As shown, for example, in FIG. 17, in one form, the user or consumer must click on a sales tax button 1005 to display a sales tax disclosure statement 1007 prior to proceeding to the next page. This serves to ensure that the sales tax disclosure was indeed made. In one form, the sales tax disclosure statement 1007 may include a statement informing of the dealer's legal obligation to collect and forward sales tax and/or the manner of calculating the consumer's taxable amount (e.g. total sale price mines trade value). In another form, the system 10 may include a timekeeper (not shown) capable of tracking and saving the amount of time that the sales tax disclosure statement 1008 or other screen or disclosure statement is displayed. While sales tax disclosure has been discussed herein, it will be readily understood that the system 10 may include other types of disclosures, both mandatory and non-mandatory.

In this manner, the system 10 may assist the user in ensuring the user makes certain disclosures both mandatory and non-mandatory. Additionally, it may provide valuable information to the system administrator about whether a certain user may need additional training or information about making appropriate disclosures.

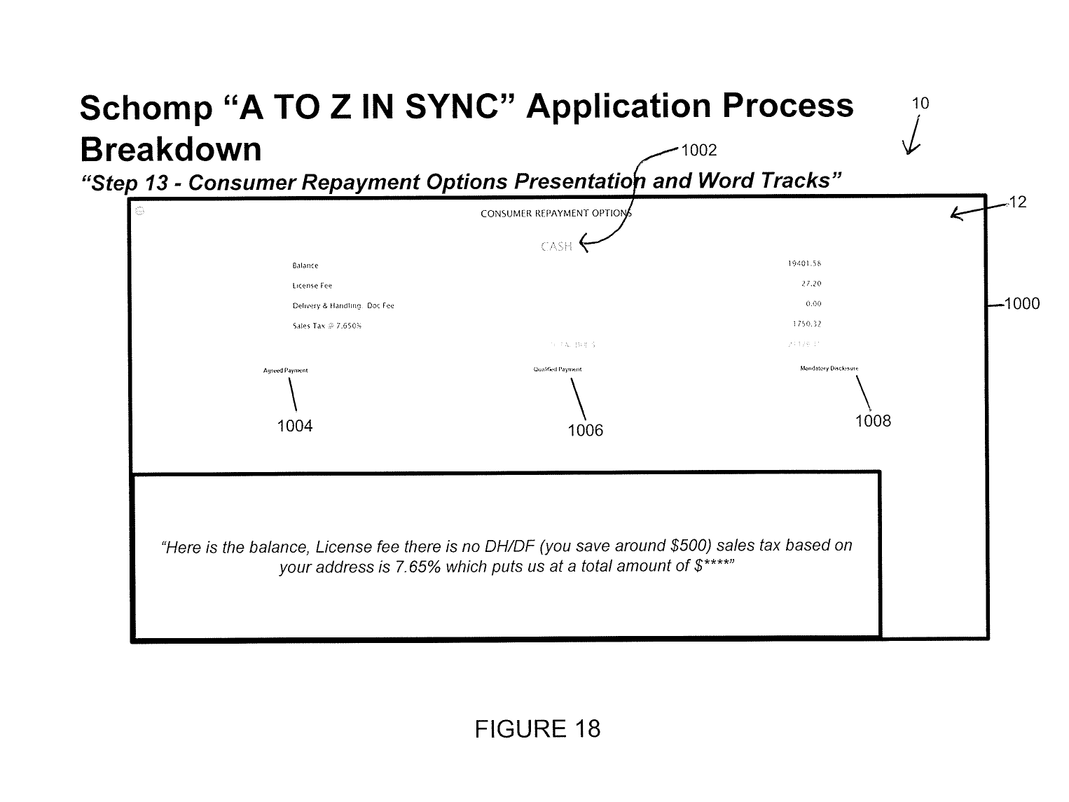

In one form, as shown in FIG. 18, the consumer repayment option presentation 1000 may display both cash and financing repayment options. In one form, a consumer repayment option presentation 1000 may include a cash payment data 1002 screen, displaying, for example, balance, fees, such as license fees, delivery and handling fees, document fees, sales tax amount, and total due should the consumer pay in cash.

In one form, the user or consumer may click one or more tabs or buttons within the cash payment data 1002 screen before proceeding to a financing repayment 1016 screen. For example, in one form, the consumer repayment option presentation 1000 may include an agreed payment button 1004, a qualified payment button 1006, and a mandatory disclosure button 1008. In one form, each button must be clicked by the consumer or user, before the system 10 will proceed to the next screen.

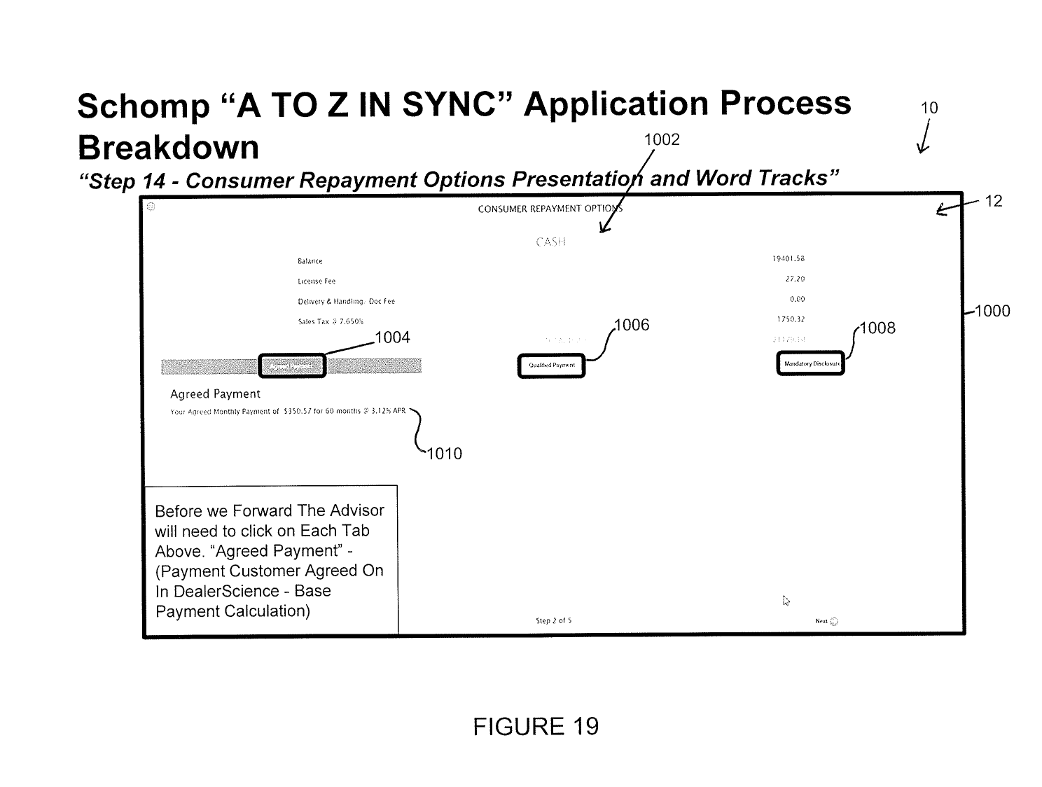

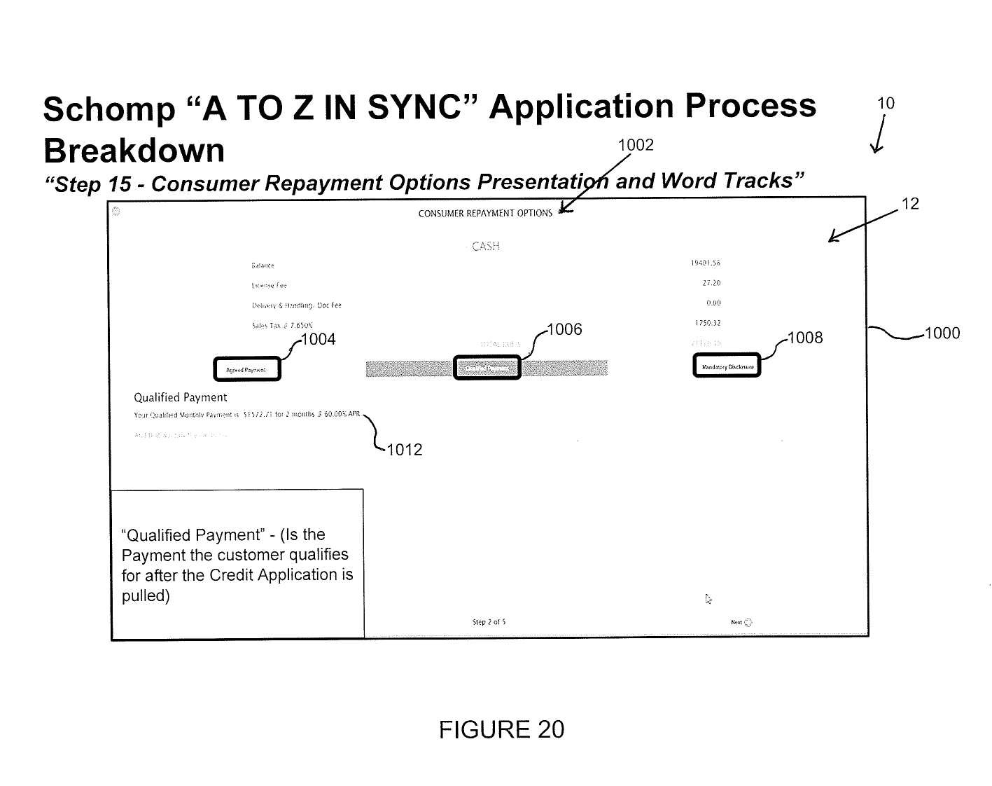

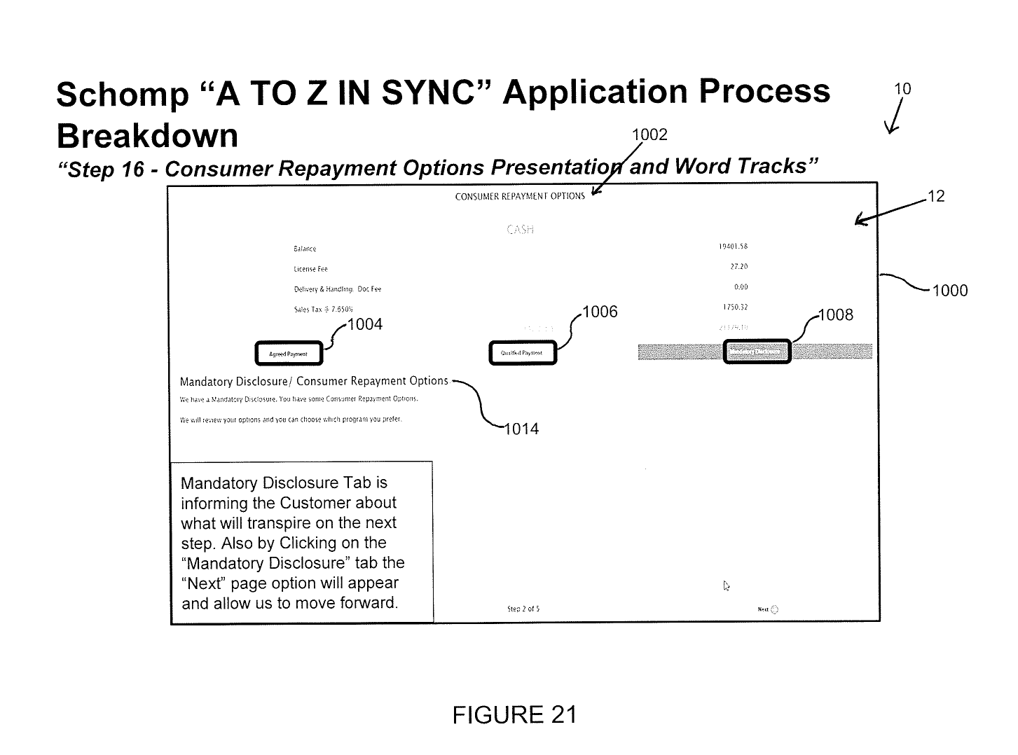

As illustrated in, for example, FIGS. 19-21, clicking on each one of the tabs may cause the display of certain disclosure statements. In one form, as shown in FIG. 19, clicking on the agreed payment button 1004 may cause the display of an agreed payment disclosure statement 1010 concerning the terms of the agreed payment (for example, monthly payment, term, APR). As shown in FIG. 20, clicking on the qualified payment button 1006 may cause the display of a qualified payment disclosure statement 1012 concerning the terms of the consumer's qualified payment (for example, monthly payment, term, APR). As shown in FIG. 21, clicking the mandatory disclosure button 1008 may cause the display of a mandatory disclosure statement 1014 (for example, a statement concerning the consumer's right to choose between available repayment options). The consumer may initialize, sign or otherwise acknowledge that he or she has been shown the content of the mandatory or other disclosures before the transaction may proceed. Alternatively, system 10 may record that the pertinent buttons were pressed so that the disclosures were shown to the consumer.

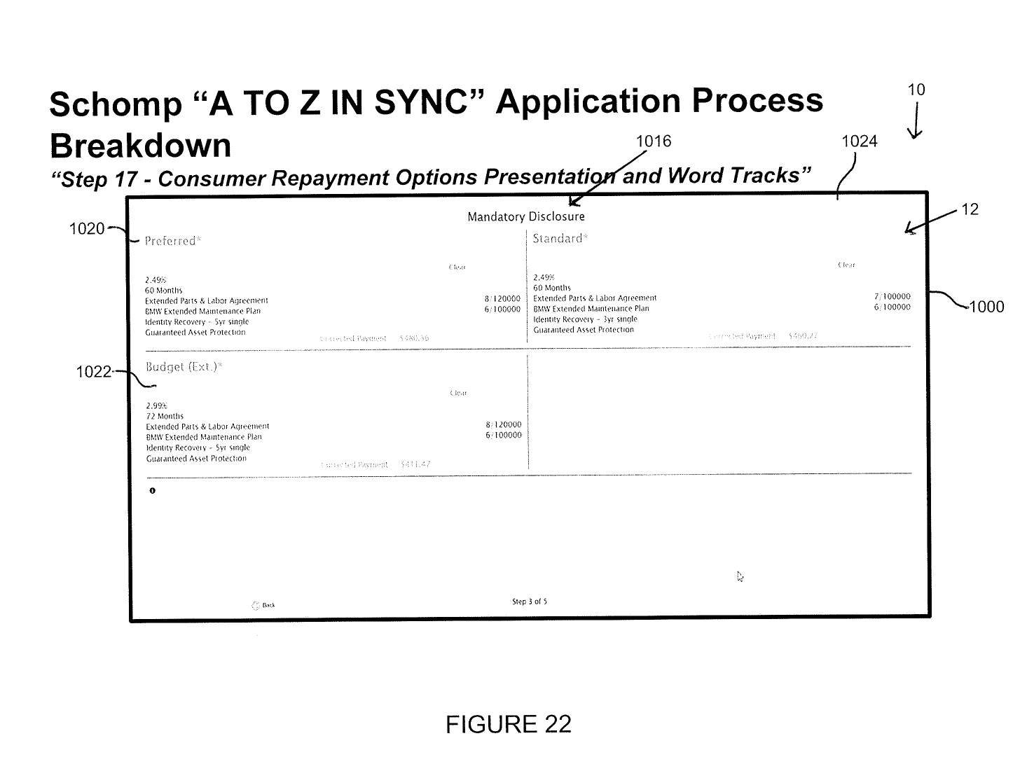

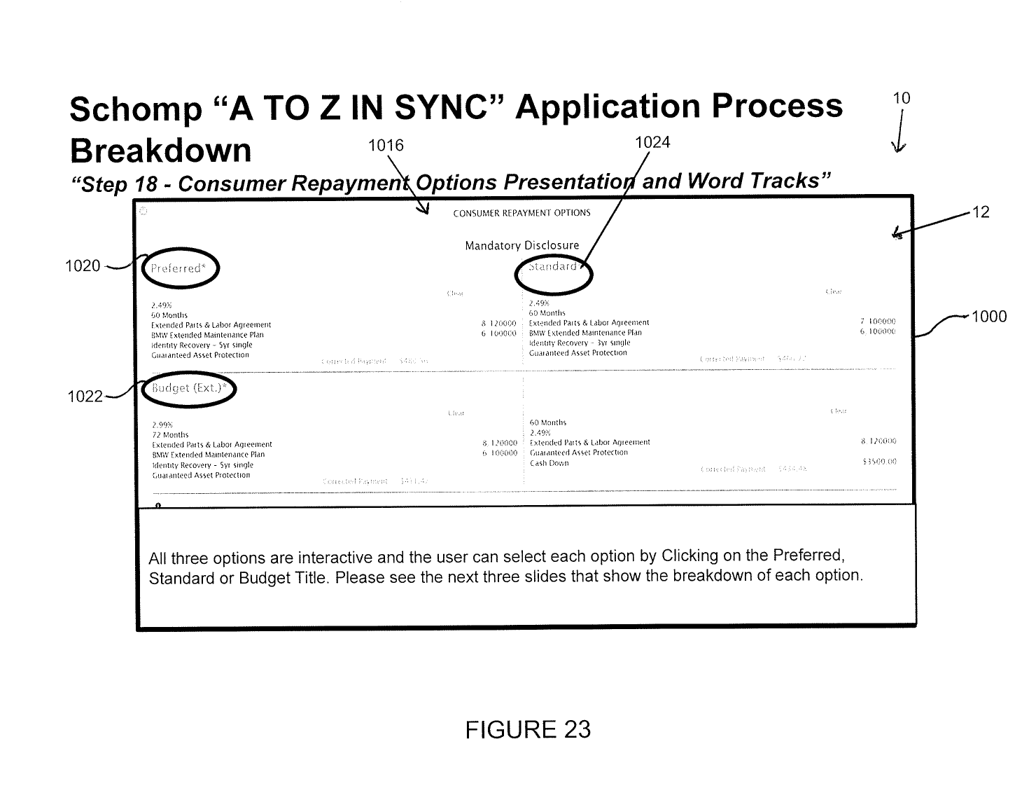

As illustrated in FIGS. 22 and 23, the consumer repayment option presentation 1000 may next display financing repayment options. In one form, the consumer repayment option presentation 1000 displays one or more repayment option fields. In one form, there are at least three repayment option fields 1020, 1022, 1024. The repayment option fields 1020, 1022, 1024 may include, for example, preferred, budget or extended, and standard options or packages. The repayment option fields may display one or more terms and products associated with each repayment option, including but not limited to, for example, APR, term, included products/accessories, and a monthly payment.

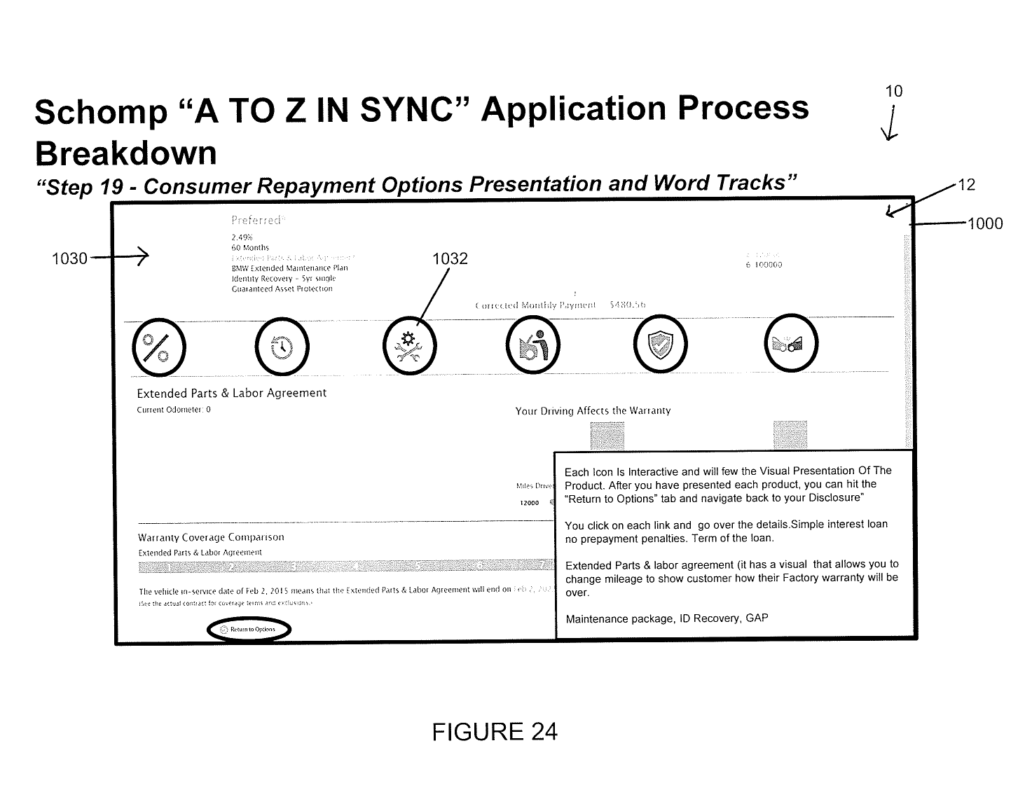

In one form, as illustrated, for example, in FIG. 23, the consumer or user may click a tab, button, or link associated with each repayment option to proceed to a detail screen 1030 (as illustrated in FIGS. 24-26) for each option. Thus, for example, if the consumer or user clicks on the preferred option link, the system 10 will proceed to a preferred plan detail screen 1030. Likewise, if the consumer or user clicks on the budget option or standard option link, the system 10 will proceed to a budget plan detail screen or a standard plan detail screen.

As illustrated in FIG. 24-26, in one form the detail screen 1030 is interactive such that it may include a number of interactive icons 1032 representing certain products and/or terms associated with the individual package/option. Thus, the consumer or user may click on each of the icons 1032 to cause the system 10 to display additional information concerning the associated product or term.

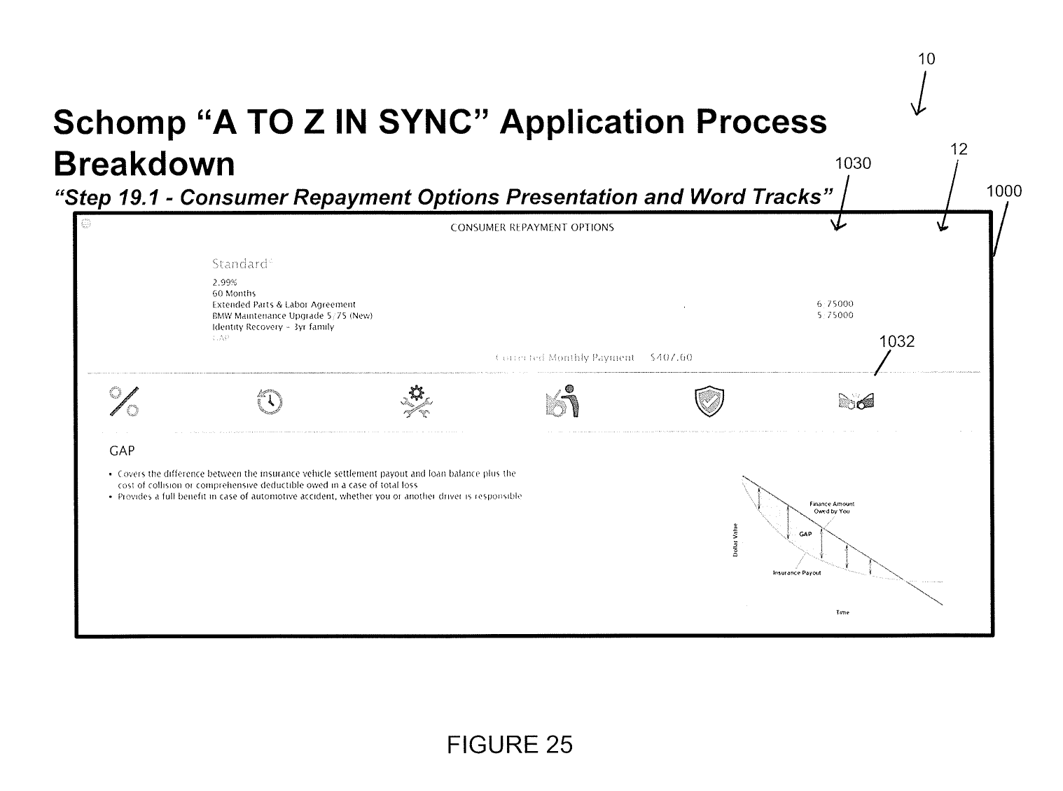

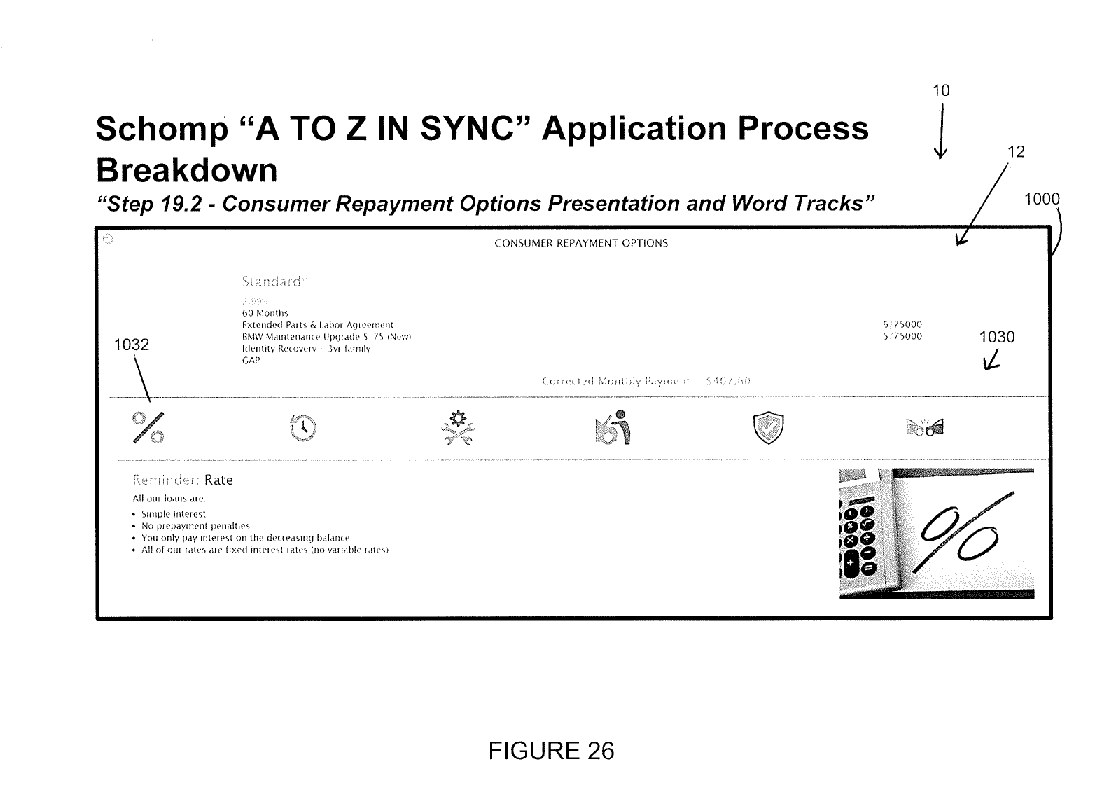

Thus, for example, as shown in FIG. 24, the user or consumer may click on the icon 1032 representing warranty coverage to display information about the warranty coverage associated with that package/option (including, for example, vehicle in-service date and expiration date). Likewise, as illustrated in FIGS. 25 and 26, the user or consumer may click on the icons 1032 representing guaranteed asset protection (GAP) coverage or rate to display information about the GAP coverage or rate associated with that package/option.

The detail screens 1030 may include any number of icons representing any suitable product or transaction term that may be included in a given package/option. The icons may include, but are not limited to, for example, annual percentage rate (APR), term, warranty coverage and extended parts and labor agreement, maintenance plan, identity protection, GAP coverage, and the like.

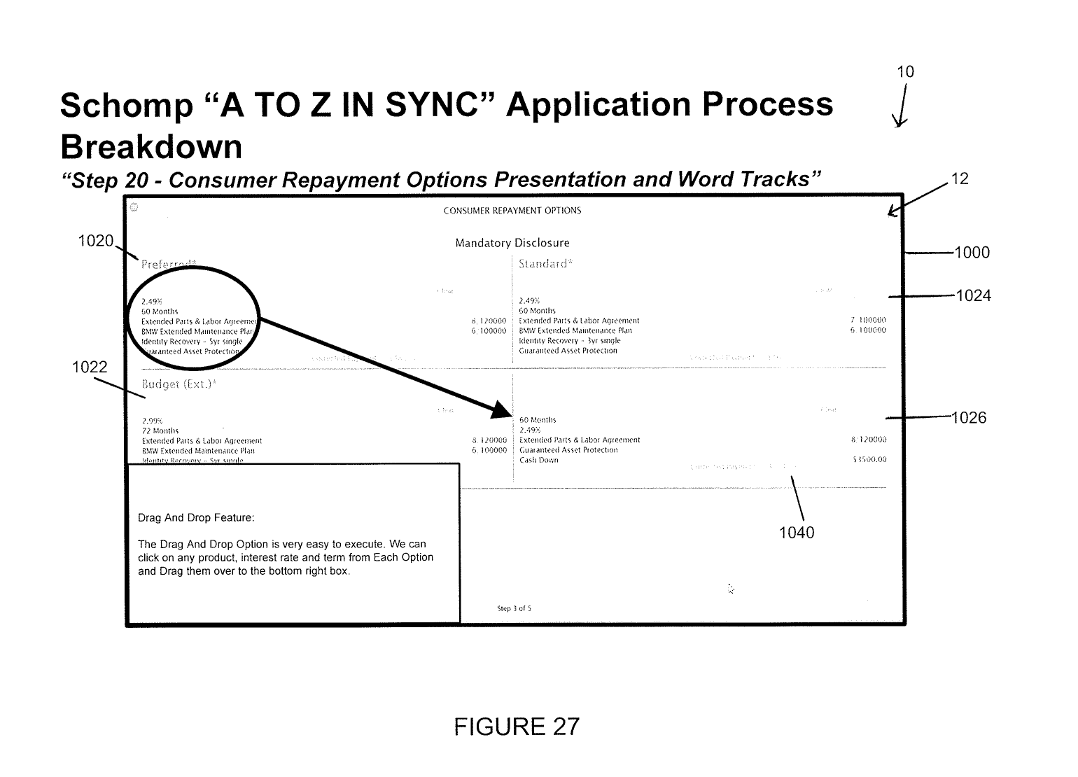

With reference to FIG. 27, in one form, the consumer repayment option presentation 1000 screen itself may be interactive. For example, the user or consumer may select one or more desired terms or products from one or more of the repayment option fields 1020, 1022, 1024 and add them to one of the other repayment option fields and/or to a customized repayment option field 1026 to build a customized repayment plan. In one form, this may take the form of a drag and drop feature whereby term(s) and/or product(s) from one field may be dragged and dropped into another field.

In one form, the repayment option fields 1020, 1022, 1024, and 1026 include a corrected payment calculation 1040 that may display the corrected monthly payment based on the term(s) and/or product(s) added or removed from a given repayment option. This advantageously allows the consumer to see precisely how each added or removed term or product impacts the overall cost of the transaction. In this manner, the consumer may optimize the transaction variables to best meet the consumer's individual needs and preferences.

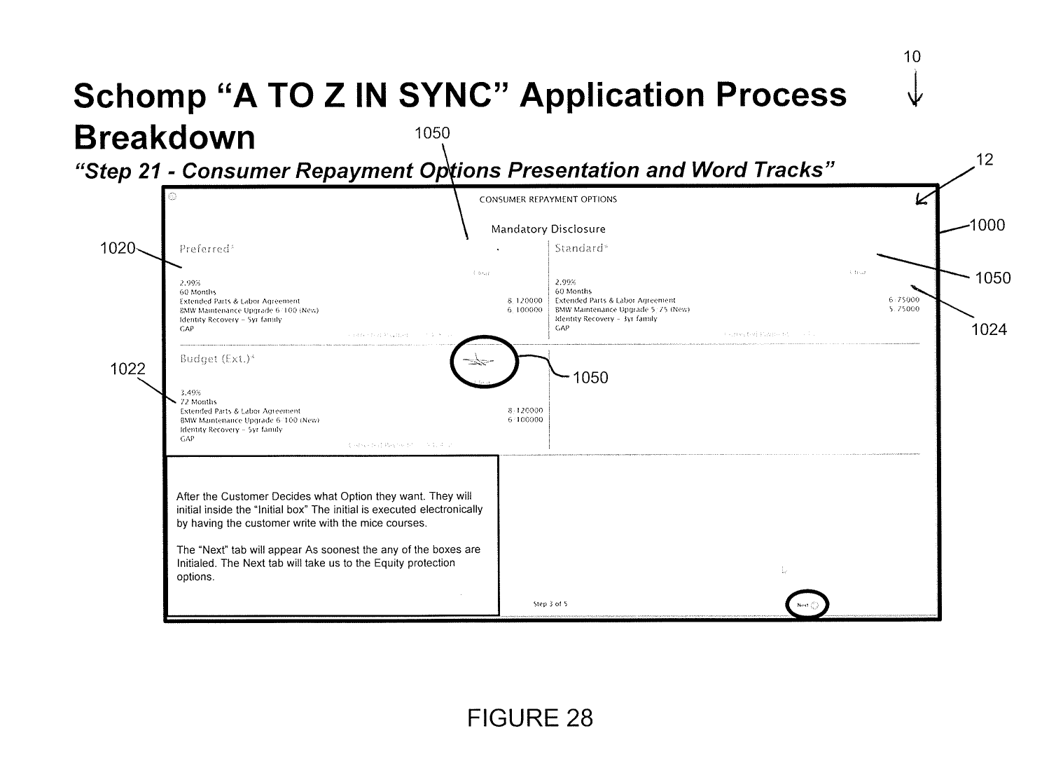

As illustrated in FIG. 28, the consumer repayment option presentation 1000 screen may also include selection boxes 1050 for indicating the consumer's selected repayment option. In one form, for example, the selection box 1050 may include a signature or initial box. The consumer may execute the signature/initial box associated with a certain repayment option to indicate the consumer's selection of that option. In one form, this may be done electronically.

The consumer repayment option presentation 1000 may also include an equity protection package 1060 screen. The equity protection package 1060 screen may include one or more equity protection package fields 1062 displaying a list of the products associated with each equity protection package. The equity protection package 1060 screen may also include one or more interactive icons 1064 each representing an available equity protection product. As with icons 1032, the user or consumer may click on each icon 1064 to display additional information about the equity protection product represented by the icon.

The equity protection package 1060 screen itself may be interactive. For example, the user or consumer may select one or more desired products from one or more of the equity protection package fields 1062 and add them to one of the other equity protection package field 1062. In one form, this may take the form of a drag and drop feature whereby product(s) from one field may be dragged and dropped into another field.

In another form, highlighting or clicking on a product listed in an equity protection package field 1062 may cause a modify and/or delete button 1066 to be displayed adjacent to the listed product. The user or consumer may click on the appropriate button to modify or delete the product.

In one form, the equity protection package fields 1062 may preferably include a cost calculation 1068 for each package. In one form, both a total cost and a monthly cost calculation may be displayed. In another form, the cost calculation is preferably interactive, such that the cost calculation for the equity protection package is automatically recalculated and updated as product(s) are modified and/or deleted.

Again, this advantageously allows the consumer to see precisely how each added, removed, or modified product impacts the overall cost of the transaction. In this manner, the consumer may optimize the transaction variables to best meet the consumer's individual needs and wants.

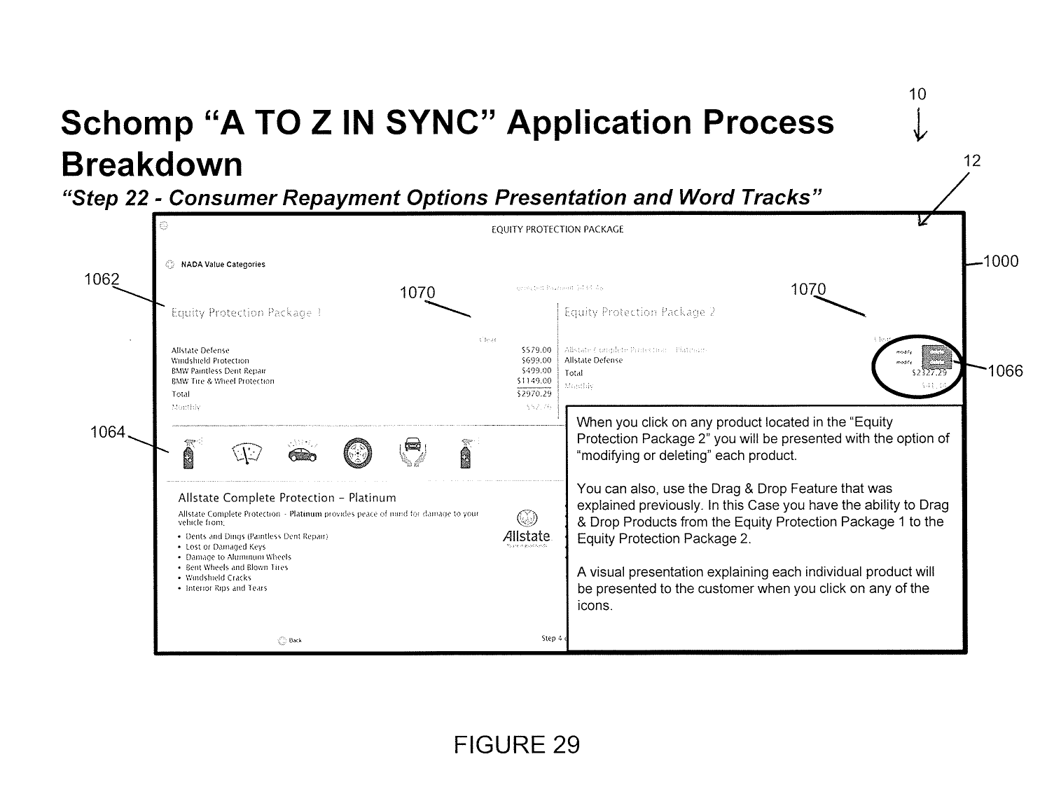

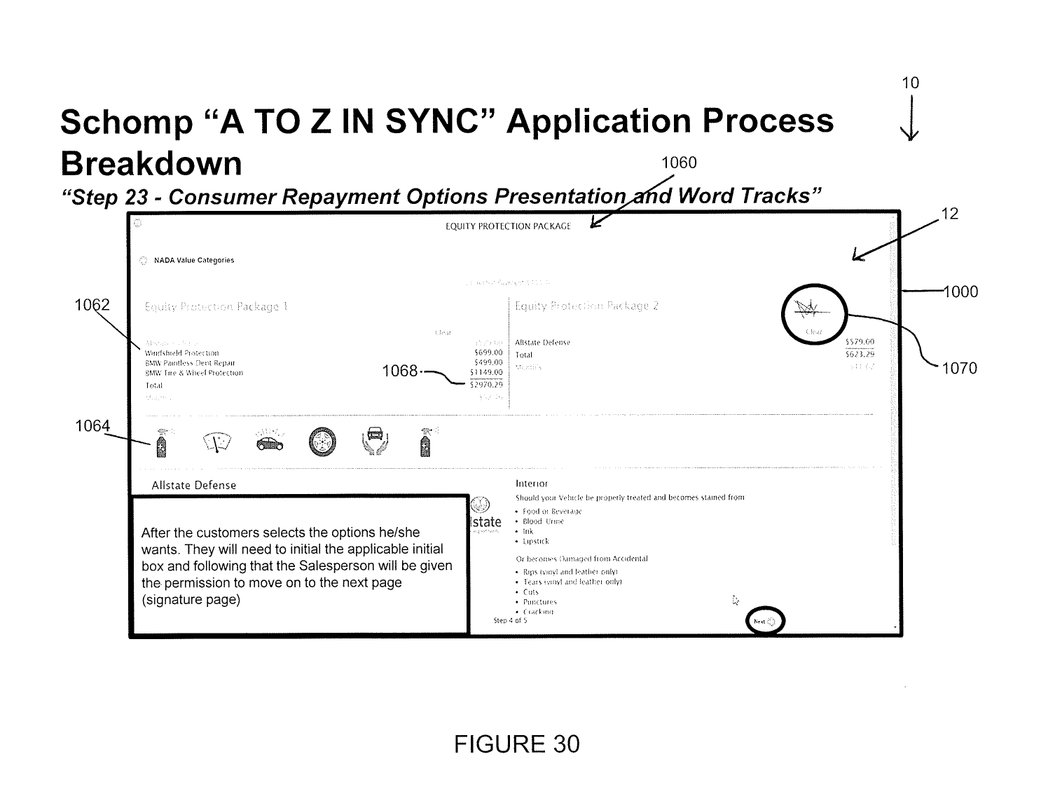

As illustrated in FIGS. 29-30, the equity protection package 1060 screen may also include selection boxes 1070 similar to selection boxes 1050 for indicating the consumer's selected equity protection package. Like selection box 1050, selection box 1070 may include a signature or initial box, which the consumer may execute electronically to indicate the consumer's selection of that equity protection package.

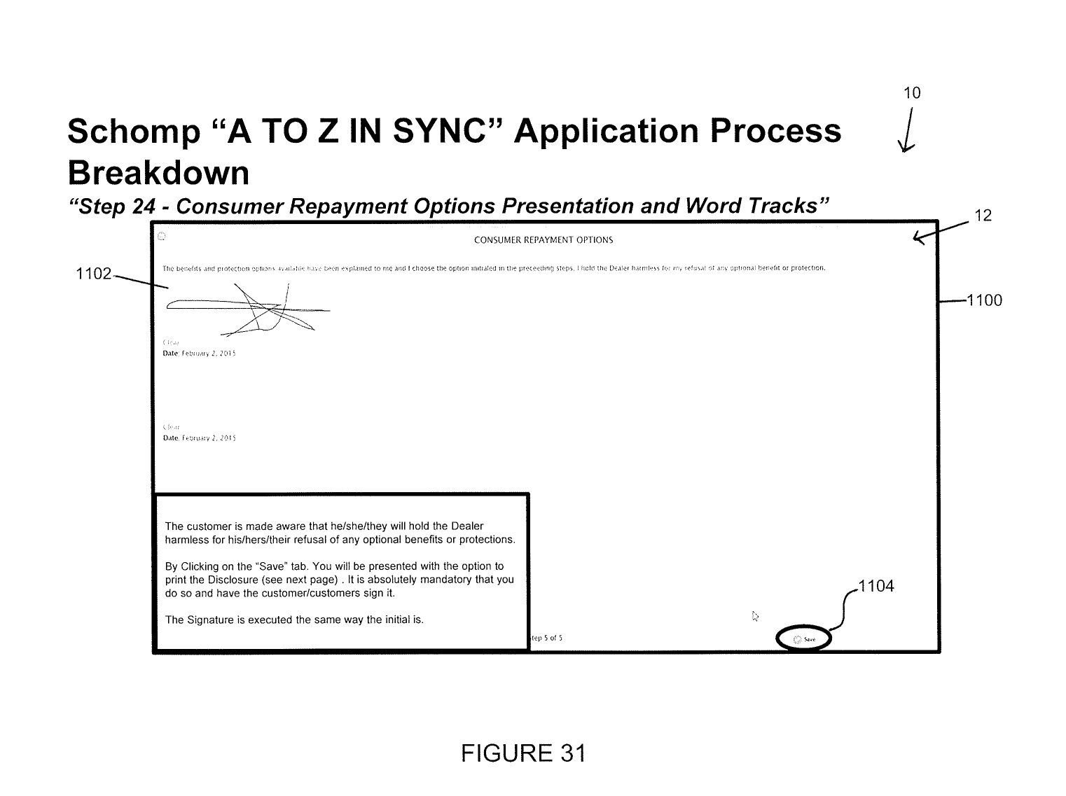

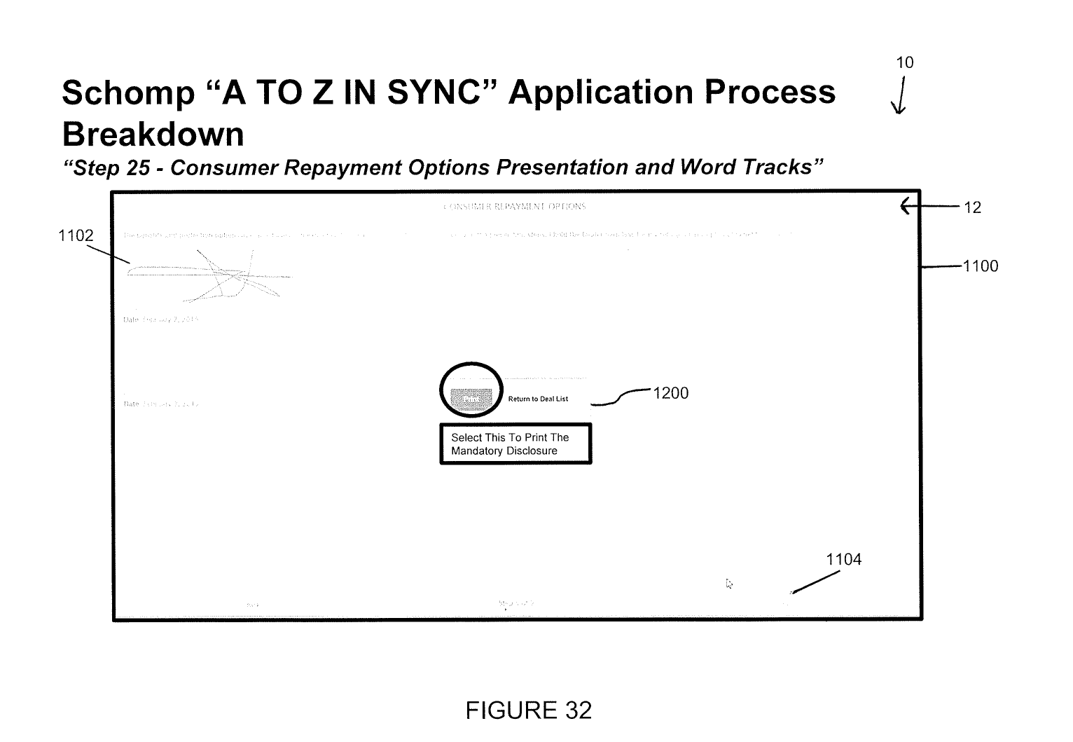

As illustrated in FIGS. 31-32, after the consumer repayment option presentation 1000 is complete, the system 10 provides a signature 1100 page for completing the transaction. The signature 1100 page may include one or more signature boxes 1102 for the parties to execute. It may include a date field that automatically displays the current date or the date on which the signature field 1102 is executed. In one form, the signature 1100 page may also include a verification statement 1104 whereby the consumer, with his or her signature, may verify that certain information has been disclosed, for example, repayment options, equity protection package options, and costs and benefits associated with each. In one form, the signature may be executed electronically.

The signature page 1100 preferably includes a save button 1104 allowing the user to save the transaction data and consumer's signature. Upon saving the transaction, the system 10 may display a print/return screen 1200 allowing the user, for example, to choose to print the transaction, return to the system 10 home page/deal list, and/or previous screen.

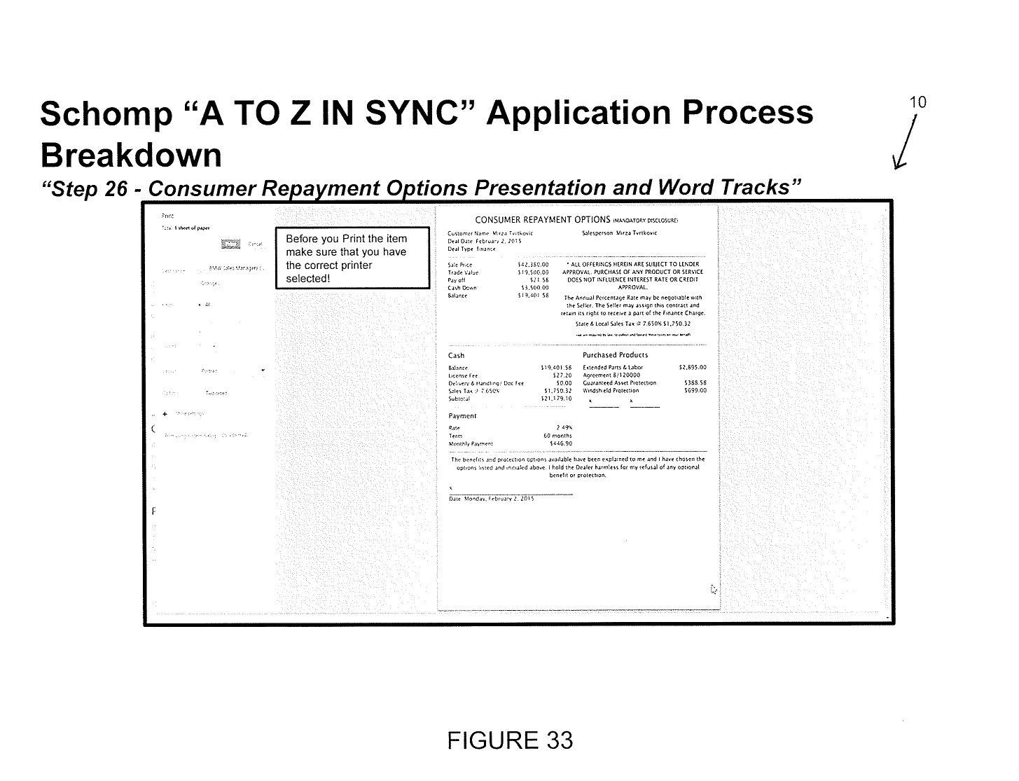

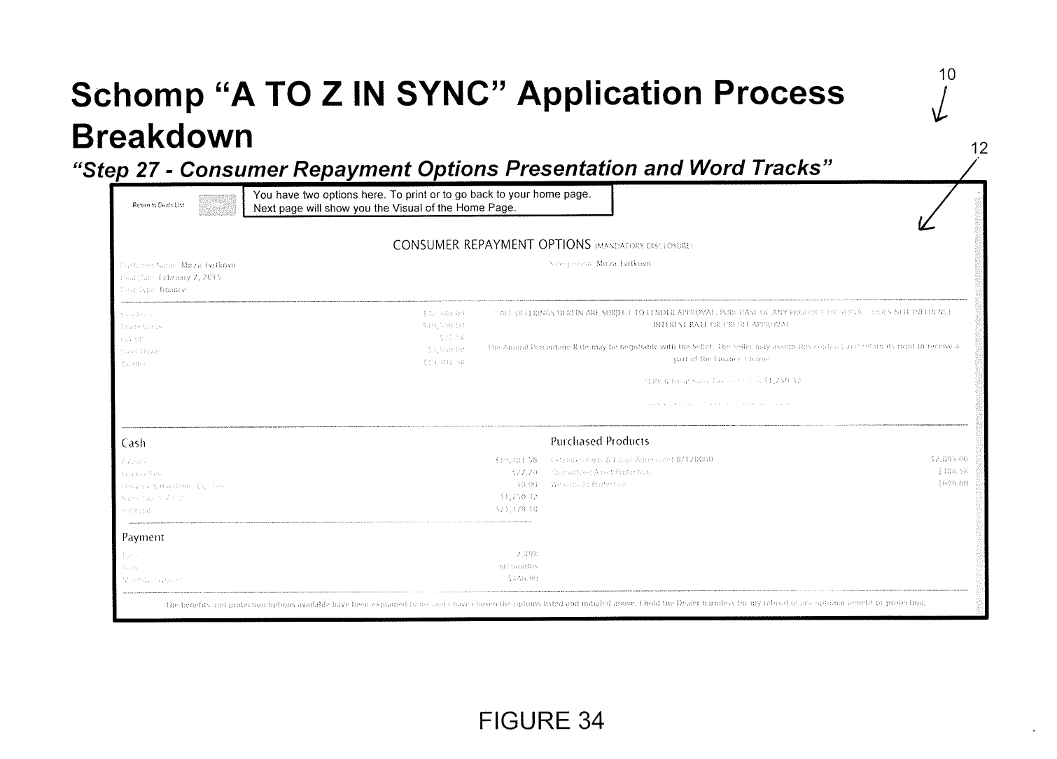

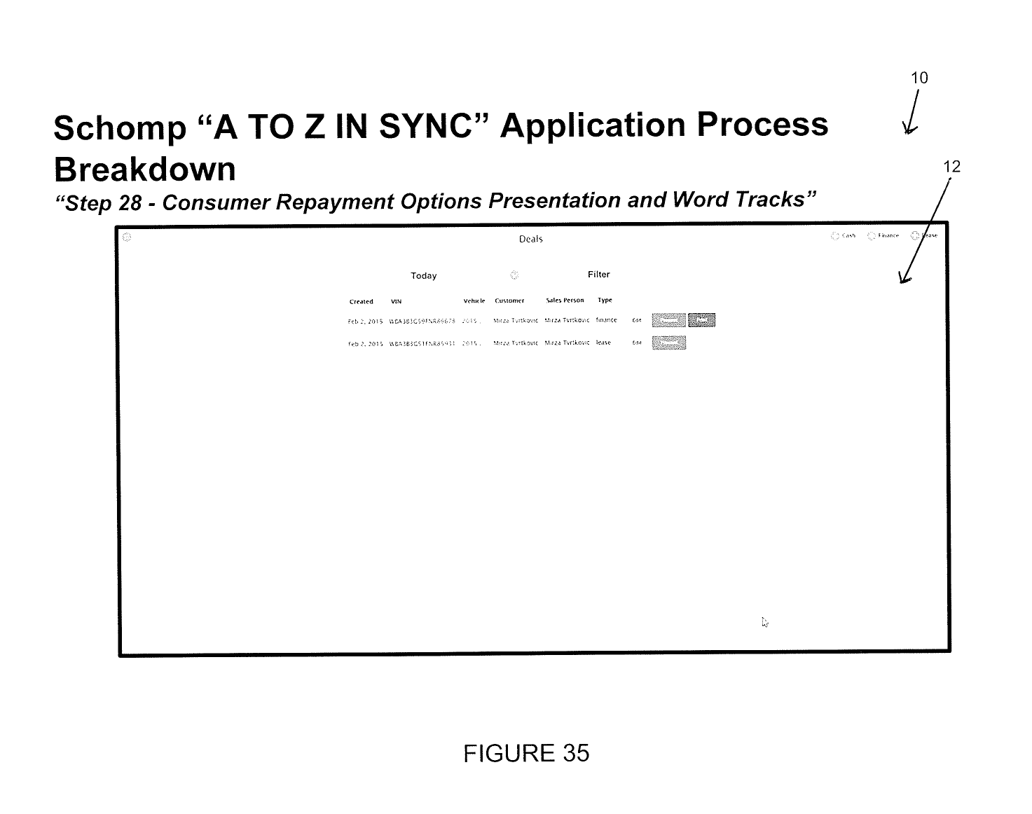

As shown in FIG. 33, upon choosing to print the transaction a copy of the complete transaction may be printed out in hard copy or as a pdf document for easy viewing by the consumer, user, or other person. As illustrated in FIG. 34, upon printing the complete transaction, the system 10 may provide the option to print and/or return to the system 10 home page/deal list. As illustrated in FIG. 35, in one form, the completed transaction is listed on the system home page/deal list adjacent to buttons allowing the user to perform certain functions with the transaction data, including but not limited to, editing the transaction, presenting the transaction, printing the transaction. Other options will be readily apparent, including, but not limited to, transmitting the transaction, such as by email or facsimile, importing the transaction into the DMS or CRM system, and the like.

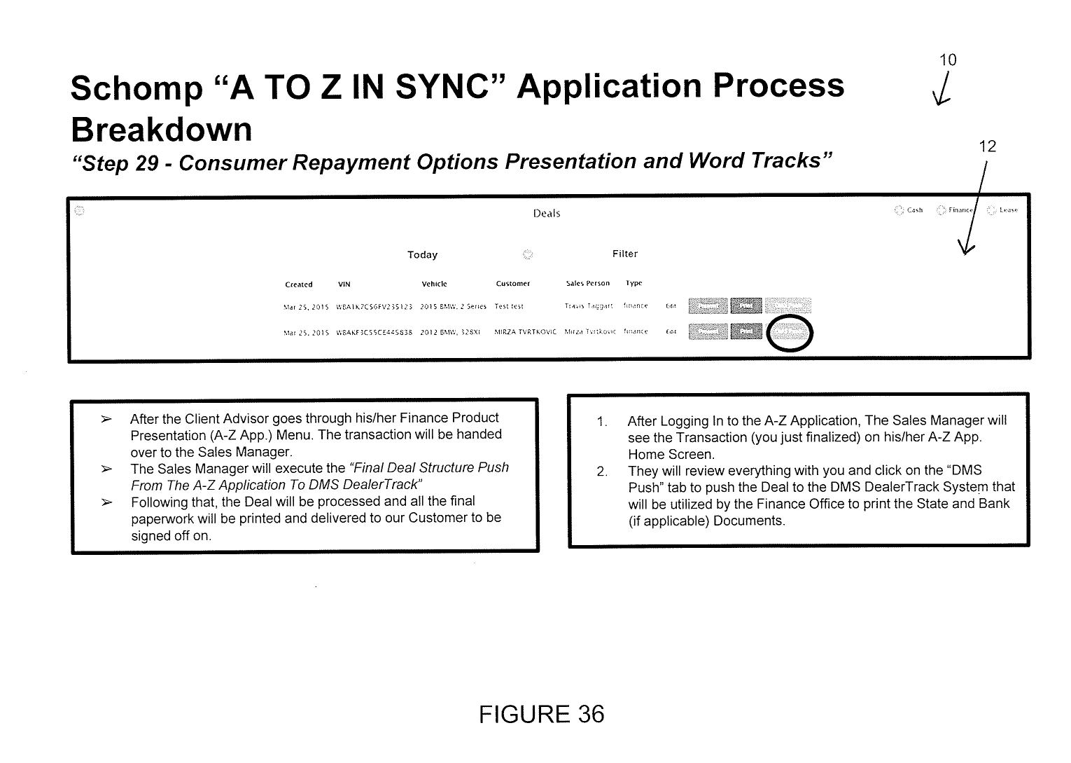

For example, as shown in FIG. 36, in one form, following the completion of the transaction, the system 10 may allow for the transaction to be transmitted to and/or accessed by another party, such as the user's supervisor, manger, etc. who may in turn execute a final deal structure push from the system 10 to the DMS. In one form, this may occur by clicking a DMS push button. Alternatively, the DMS function may be provided by software comprising part of system 10 and may thus be internally processed. Either way, this may allow the user to address, finalize and/or print state and/or bank documents.

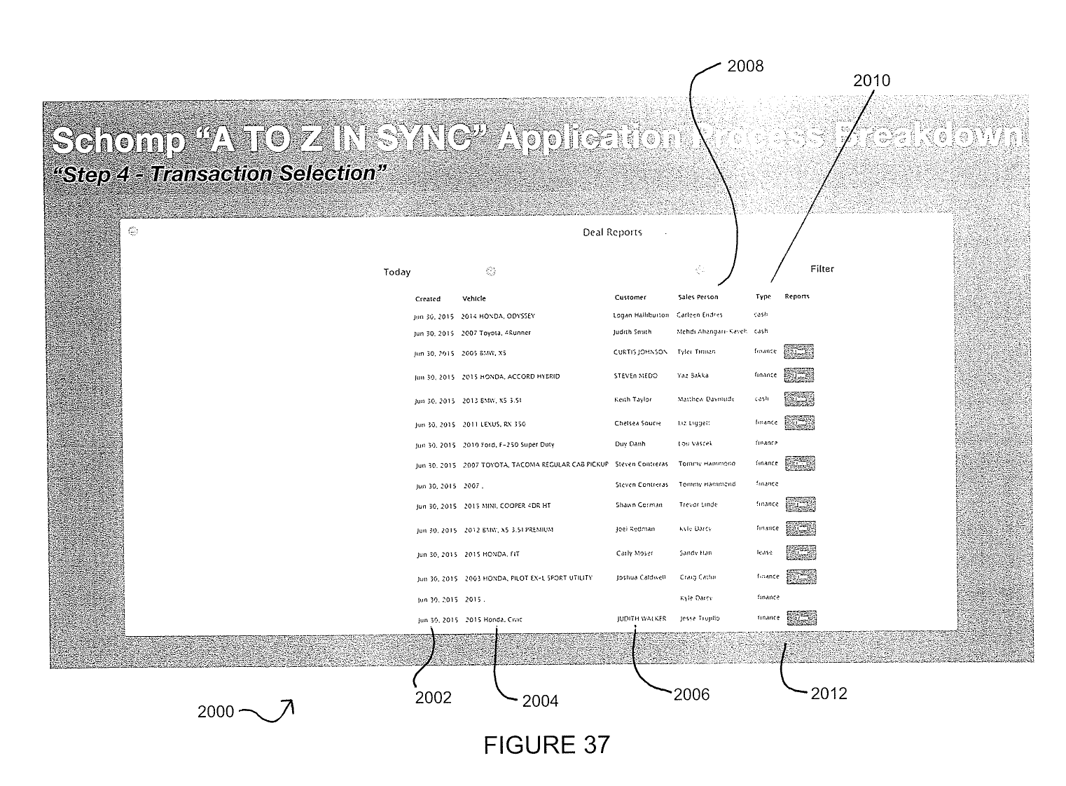

Beyond the GUIs and adjustment of transaction terms, the current invention may provide reporting functions, business analytics and/or other summary information. For example, as shown in FIG. 37, a summary page or report 2000 may list transactions that have been addressed by system 10. As shown, report 2000 may include transaction dates 2002, vehicle type 2004, customer identification 2006, user or salesperson 2008, payment type 2010 and reports 2012 that may provide information on each transaction. For example, reports section 2012 may provide information on how much time was spent on each transaction or stages of a transaction. Other information regarding transactions may also be provided.

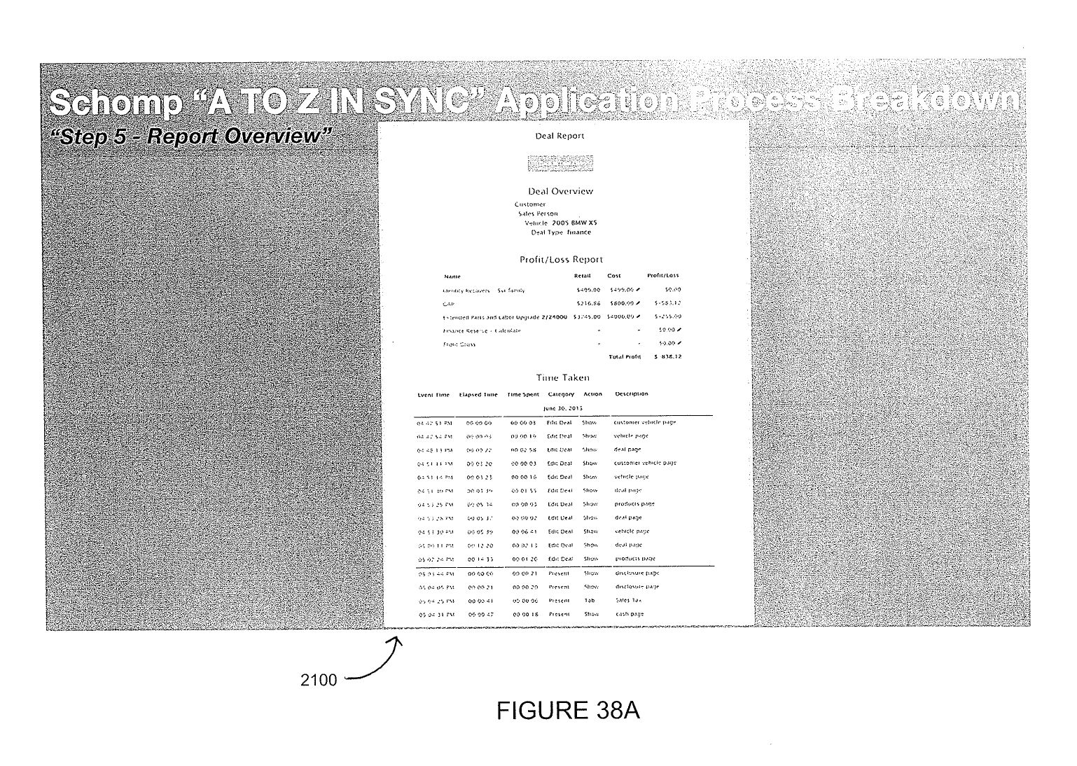

FIGS. 38A-38B show how the time spent on a transaction may be reported. Report 2100 shows how much time was spent on various aspects of a transaction. This may provide useful business analytics reports. Additionally, it may be used to glean information about areas where additional training may be advantageous. For example, it may indicate that an individual does not spend enough time discussing accessory products, and therefore, fails to maximize potential profitability.

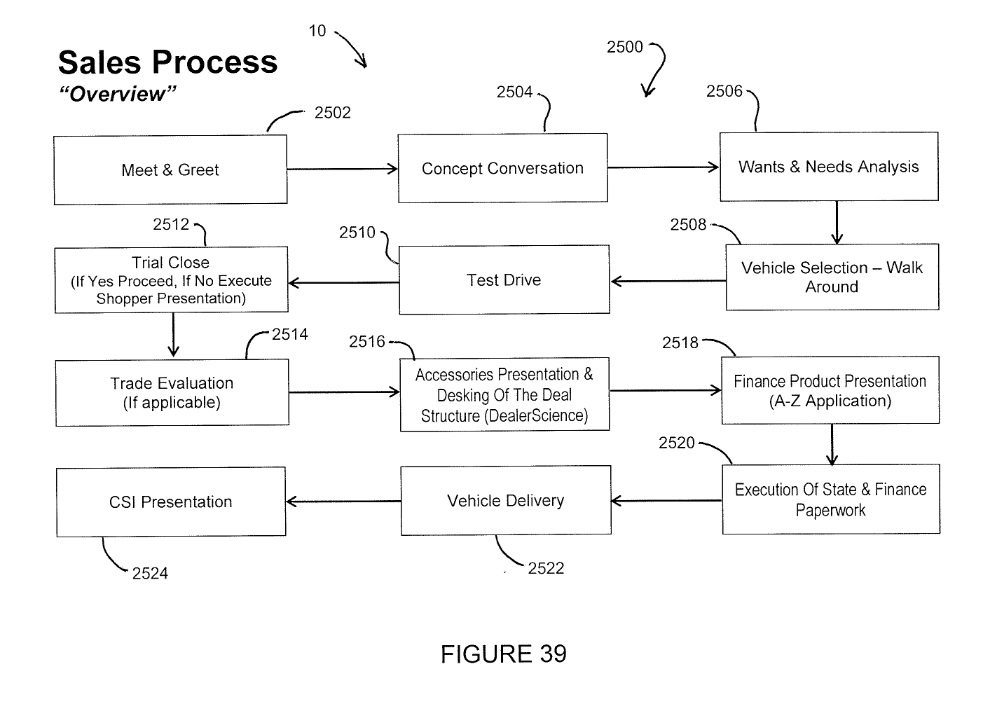

FIGS. 40.1-40.3 show another report showing a deal overview and profit/loss information. This report may also show the time spent on various steps of system 10. It should be noted that system 10 may provide visual cues to, e.g., a manager, in the form of color-coded time information reflecting whether the user/salesperson is spending an appropriate time (green) or inappropriate time (red) on various steps.

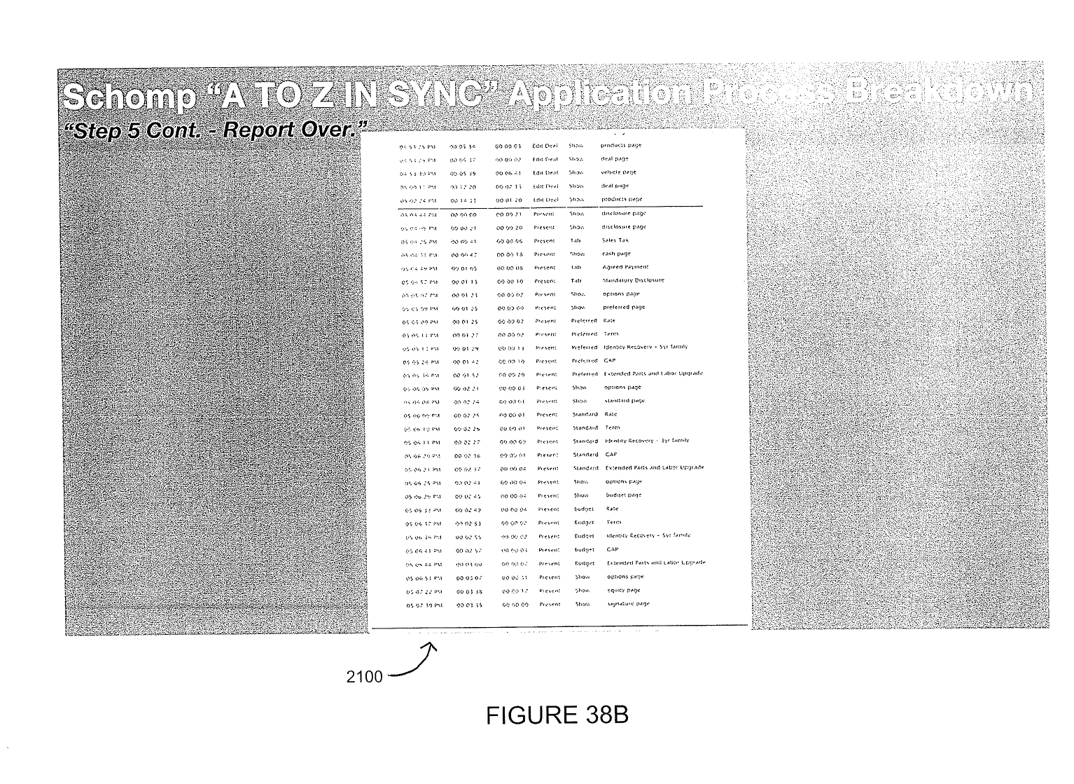

FIG. 39 shows an overview 2500 of a system and process including the system 10 of the current invention, including various additional steps that may be included. As shown, the process may start with a meet and greet 2502 where a consumer is engaged by a salesperson or other user representative. This may proceed to a concept phase 2504 where various aspects of what the consumer desires to obtain out of the transaction are addressed. An analysis of the consumer's wants and needs 2506 may then occur where the user representative may be provided with a framework of the prospective transaction.

Where the system and method 10 of the current invention are used in a vehicle sale or lease transaction, the next step may involve a physical inspection 2508 of potential vehicles. A test drive 2510 may then occur. After that, the user or sales representative may gauge the interest of the consumer in actually closing the transaction 2512.

If there is sufficient interest by the consumer, the transaction may proceed. For example, if the consumer has a vehicle to trade in, the vehicle trade-in potential 2514 may be evaluated.

Thereafter, vehicle accessories and other aspects of the vehicle purchase may be presented as shown in the figures above and in step 2516 of FIG. 39.

The consumer may then be presented with financing options as shown in step 2518 and in the above figures. If the transaction proceeds, execution of state and finance documents may occur as in step 2520. Vehicle delivery 2522 and later reporting or presentation 2524 may occur.

FIGS. 40A-40C show an alternate overview 2600 of a system and process of the current invention, including various additional steps that may occur in the overall sales transaction. In general, it is preferred that the steps provide a positive customer experience through the series of GUIs that provide information to the consumer in a concise and user-friendly format, and the efficient manner in which the sales transaction may proceed to avoid losing consumer interest. The system and method of the current invention also preferably provides for increased success in consummating sales transactions and providing follow-up or future business opportunities, as well as for increased consumer loyalty. To this end, the system and method of the current invention may provide for the automatic follow-up from the car dealer to the consumer.

As shown, the process may start with a meet and greet 2602 where a consumer is engaged by a salesperson or other representative of the car dealership or other type of user. During the meet and greet 2602, the user representative may introduce himself or herself to the consumer and obtain information about the consumer, including, for example, the consumer's name, whether the consumer is a first-time visitor or return visitor, whether the consumer has a scheduled appointment with an individual, whether the consumer is seeking price information, product information, or both. In general, the user may collect information about the consumer which may be input into the system at the same time or at a later time. Furthermore, the meet and greet step 2602 preferably conveys the up-front and comfortable sales environment that are later reflected in the GUIs of the system.

A concept conversation 2604 may occur next. In the concept conversation 2604, the user representative may discuss the core message and/or philosophy of the business. For example, in the context of an automobile dealership, the concept conversation may include, for example, discussion of the dealership's history, business philosophy, what separates the dealership from others, pricing, available products and services, etc. The concept conversation may also include a discussion on the efficiency of the sales process as reflected by the series of GUIs that are later used to guide the consumer through the sales process. This may reflect, for example, the ONE PRICE, ONE PERSON, ONE HOUR™ brand of sales transactions and customer service. Information regarding the foregoing may be displayed on a tablet or other electronic device that the salesperson may show to the consumer. Additionally, the user representative may use the concept conversation to build rapport with the consumer and to assess what aspect(s) are most valued by the consumer.

The concept conversation 2604 may also include questions that allow the salesperson or other representative to understand and/or profile the type of consumer at issue. The information obtained during this process may influence the manners in which the salesperson addresses the consumer and uses the GUIs of the system. At this point, a “soft” credit report may be run to gain a general understanding of the price level of cars or other items that are within the consumer's reach. This information may also guide the salesperson how to address the consumer. This is beneficial in that this type of credit report may be obtained based on cursory information such as address and name, and also does not show up as a formal credit check that may affect the consumer's credit. It is preferred that the system of the current invention may be connected to a credit reporting module that may provide a soft credit report. One exemplary credit reporting tool is the 700Credit™ tool. Alternatively, the software of the current invention may itself include this functionality. The credit reporting tool may also allow a “hard” credit report inquiry, which may allow the consumer to pre-qualify for a loan.

Next, an analysis of the consumer's wants and needs 2606 may occur where the user representative may ask questions to continue to build rapport with the consumer as well as gather information about what the consumer desires to obtain out of the transaction and why. The information gathered may be used to develop a framework of the prospective transaction. The questions asked of the consumer and the information obtained by the user may also help profile the type of consumer at issue. This information may be stored in a CRM database and may also be used for future follow-up or marketing purposes.

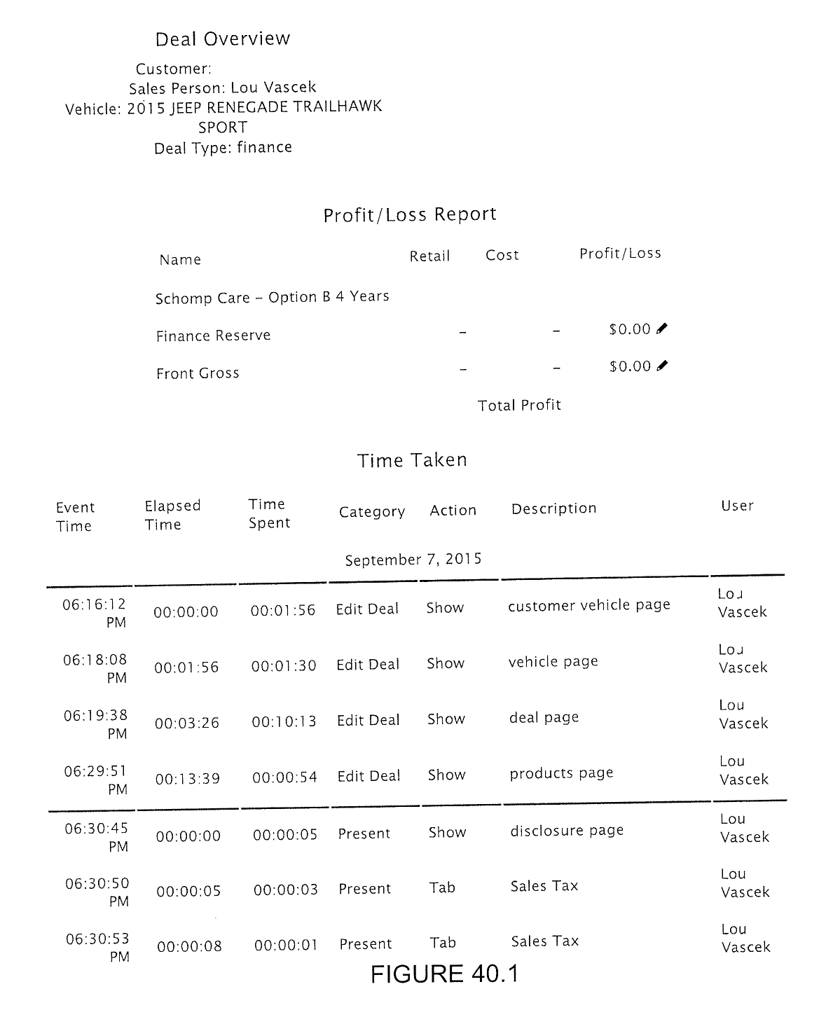

The wants and needs analysis 2606 is now described in more detail with reference to FIGS. 41A, 41B and 42-46.

FIGS. 41A and 41B each show a flowchart providing an overview 2700A and 2700B respectively, of the wants and needs analysis 2606, including examples of questions that the customer may be asked as part of the analysis. Questions that the customer may be asked may include, but are not limited to questions about who the primary driver of the vehicle will be, questions about the vehicle the person is currently driving, questions about any vehicle trade-in, questions about the customers “must-haves” in a new vehicle, questions about the customers “wants” in a new vehicle, questions about how long the customer plans to keep the vehicle, questions about how much the customer plans to pay for the new vehicle, questions about the customer's lifestyle and how they plan to use the vehicle, and also questions giving the customer an opportunity to bring up anything not yet addressed.

For example, as illustrated in the flowchart in FIG. 41A, in one form, the wants and needs analysis may begin by presenting the question who is the primary driver of this vehicle?” Depending on the customer's response to this question, the wants and needs analysis may proceed generally along one of two lines of questioning. If the customer indicates the he or she will be the primary driver of the vehicle, then the customer may be asked to provide information about the vehicle he/she is currently driving, what he/she likes and does not like about it, whether he/she plans to trade it in, and why/why not.

Next the customer may be asked if there is a payoff on his/her current vehicle. If the customer answers “no”, he/she may be asked if he/she is in possession of the free and clear title and why/why not. If the customer answers that there is a payoff on the vehicle, then he/she may be asked what approximately he/she owes on the vehicle and who the lien holder is.

Next the customer may be asked questions about the type of vehicle he/she is looking for. For example, the customer may be asked, what type of vehicle are you interested in? What are your “must haves” and why? Do you have any “don't wants” and why? How long are you planning on keeping the vehicle? How are you planning on paying for you next vehicle?

Next the customer may be asked about his/her lifestyle. For example, in one form, the system may include a GUI page with a plurality of boxes next to a plurality of activities, interests, and/or lifestyles from which the customer may select as many as are relevant to his/her interests and/or lifestyle. The GUI may list categories including, for example but not limited to, pets, city driving, outdoor activities, track driving, skiing, snowboarding, football, work commute, children, highway driving, basketball, golf, off-roading, mountain biking, running, and the like.

Finally, the customer may be asked if there is anything the user/representative forgot to ask the customer. This allows the customer an opportunity to inform the user/representative of any other information potentially pertinent to the transaction.

If the customer answers the initial question that someone else will be the primary driver, then the questions may proceed somewhat differently. For example, the customer may be asked who the vehicle is for and what the customer trying to accomplish for that person.

Next the customer may be asked if he/she will be the primary decision maker for the purchase. If the customer answers “no”, then he/she may be asked why that is. Next, the customer may be asked when the primary decision maker will be available to visit the dealership.

If the customer responds that he/she will be the primary decision maker for the purchase, then he/she may be asked for information about the vehicle the primary driver is currently driving. The customer may be asked if the current vehicle is going to be traded-in and why/why not.

Next the customer may be asked if there is a payoff on the current vehicle. If the customer answers “no”, he/she may be asked if he/she is in possession of the free and clear title and why/why not. If the customer answers that there is a payoff on the vehicle, then he/she may be asked what approximately is owed on the vehicle and who the lien holder is.

Next the customer may be asked questions about the features and benefits the primary driver must have in the next vehicle. Thereafter, the customer may be asked about the primary driver's lifestyle. For example, in one form, the system may include a GUI page with a plurality of boxes next to a plurality of activities, interests, and/or lifestyles from which the customer may select as many as are relevant to the primary driver's interests and/or lifestyle. The GUI may list categories including, for example but not limited to, pets, city driving, outdoor activities, track driving, skiing, snowboarding, football, work commute, children, highway driving, basketball, golf, off-roading, mountain biking, running, and the like.

Finally, the customer may be asked if there is anything the user/representative forgot to ask the customer. This allows the customer an opportunity to inform the user/representative of any other information potentially pertinent to the transaction.

As illustrated in the flowchart in FIG. 41B, in another form, the wants and needs analysis may begin by presenting the question is this vehicle for you or someone else?” If the customer indicates the vehicle is for him/herself, then the customer may be asked what he/she is looking to accomplish today. Next, he/she may be asked what he/she is currently driving.

Next, the customer may be asked if he/she is trading-in his/her vehicle. If the customer answers “no”, then he/she may be asked what his/her likes and dislikes are on the current vehicle. Alternatively, if the customer answers that he/she is trading-in his/her vehicle, then the customer may be asked if the vehicle is here (i.e, currently at the dealership) and what the customer dislikes about the current vehicle.

Next the customer may be asked questions about the type of vehicle he/she is looking for. For example, the customer may be asked, what type of vehicle are you interested in? If the customer indicates he/she is interested in pre-owned, he/she may be asked if he/she would consider a new vehicle lease. The customer may be asked what are your “must haves” and why? What are your wants?

Next the customer may be asked for information about his/her lifestyle. Finally, the customer may be asked if there is anything the user/representative forgot to ask the customer. This allows the customer an opportunity to inform the user/representative of any other information potentially pertinent to the transaction.

With reference to the top of the flowchart of FIG. 41B, it the customer responds to the initial question that the vehicle is for someone else, then the questions may proceed somewhat differently. For example, the customer may be asked who the vehicle is for and whether the customer will be the final decision maker on the vehicle purchase.

If the customer indicates he/she will not be the final decision maker, then he/she may be asked what he/she is trying to accomplish for the final decision maker and when the final decision maker will be available to come in (i.e. to visit the dealership in person).

Next the customer may be asked if the driver is planning on replacing his/her current vehicle and what vehicle he/she currently drives. Next, the customer may be asked what type of vehicle the driver is interested in. If the customer indicates he/she is interested in a pre-owned vehicle, the customer may be asked if he/she would be interested in leasing a new vehicle.

Next, the customer may be asked what options he/she must have in the new vehicle, what his/her lifestyle is like, and what, if anything, the user/representative may have forgotten to ask.

The wants and needs analysis may include other questions, in addition to, or instead of, the questions outlined above. For example, in another form, when the customer indicates the vehicle is for the customer him/herself, the questions may include the following. What are you looking to accomplish today? What are you currently driving? Are you trading-in your current vehicle? Is your vehicle here now? What do you dislike about your current vehicle? Why type of vehicle are you interested in? Would you consider a new vehicle lease? What are your must haves and why? What are your wants? Tell me about your lifestyle. Is there anything I forgot to ask you?

Alternately, when the customer indicates the vehicle is for someone else, the questions may include the following. Who is the vehicle for? Will you be the final decision maker on this vehicle purchase? What are you looking to accomplish for him/her today? When can she/he come down to see us? Is she/he planning on trading-in/replacing his/her current vehicle? What vehicle does she/he currently drive? What type of vehicle is she/he interested in? Would she/he be interested in leasing a new vehicle? What are the options she/he must have in the new vehicle? What is her/his lifestyle like? Is there anything I forgot to ask you?

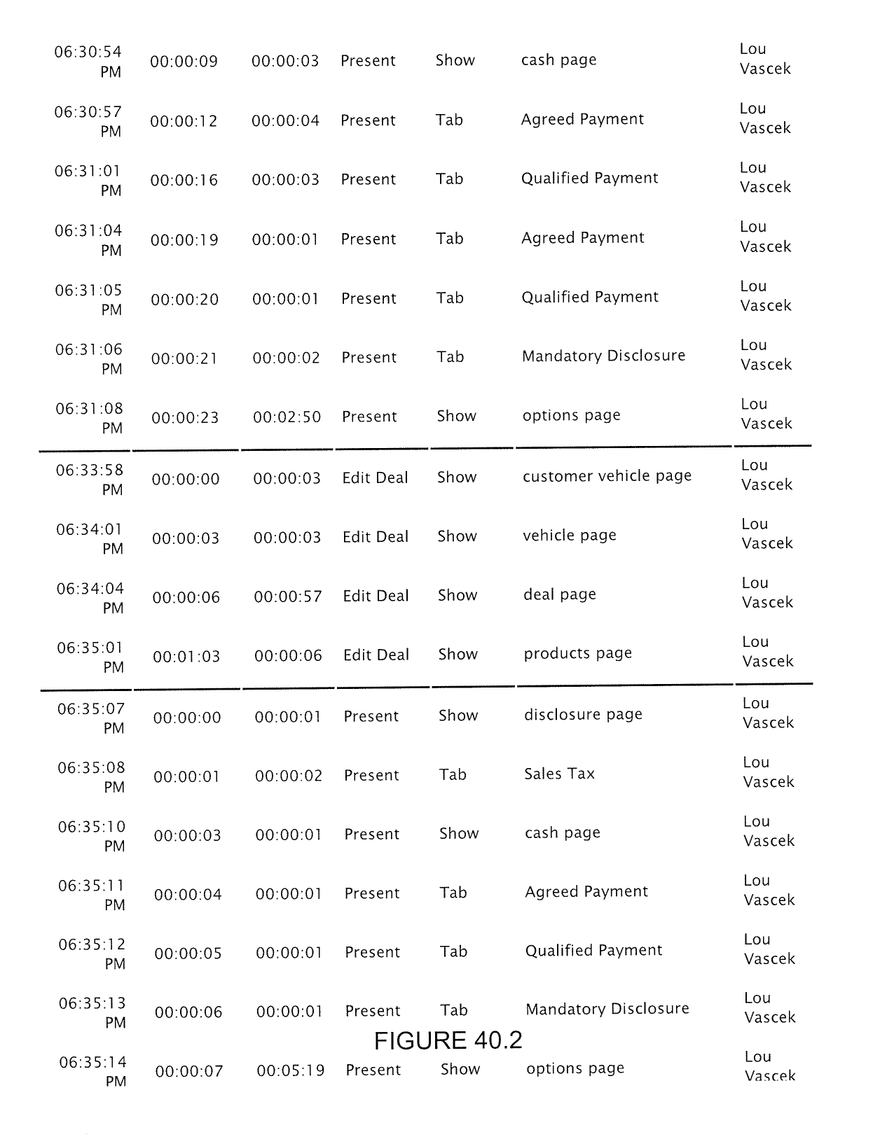

In a preferred embodiment, system 10 may prompt the user to perform the wants and needs analysis 2606 through one or more GUIs. For example, as shown in FIG. 42, upon completing a customer search and locating and/or adding the customer in the database, the system may display a GUI with various options for proceeding with the transaction. The GUI may include an option to proceed to the wants and needs analysis 2606 by clicking or selecting a Wants/Needs button 2702.

By clicking the Wants/Needs button 2702, the user may prompt the system to display one or more GUIs to walk the user and customer through the wants and needs analysis 2606. In a preferred embodiment, the questions in the wants and needs analysis 2606 may be presented in a series of GUIs. Each question may be presented in a separate GUI.

The series of questions presented to the customer may be customizable. For example, each question displayed to the customer may depend on his or her response(s) to one or more prior questions. Thus, if the customer responds that the primary driver of the vehicle will be someone other than the customer himself/herself, then the questions that follow will be directed to acquiring information about the primary driver rather than the customer him/herself. To this end, the GUIs may be presented in the order of questions shown in the flowcharts of FIGS. 41A, 41B.

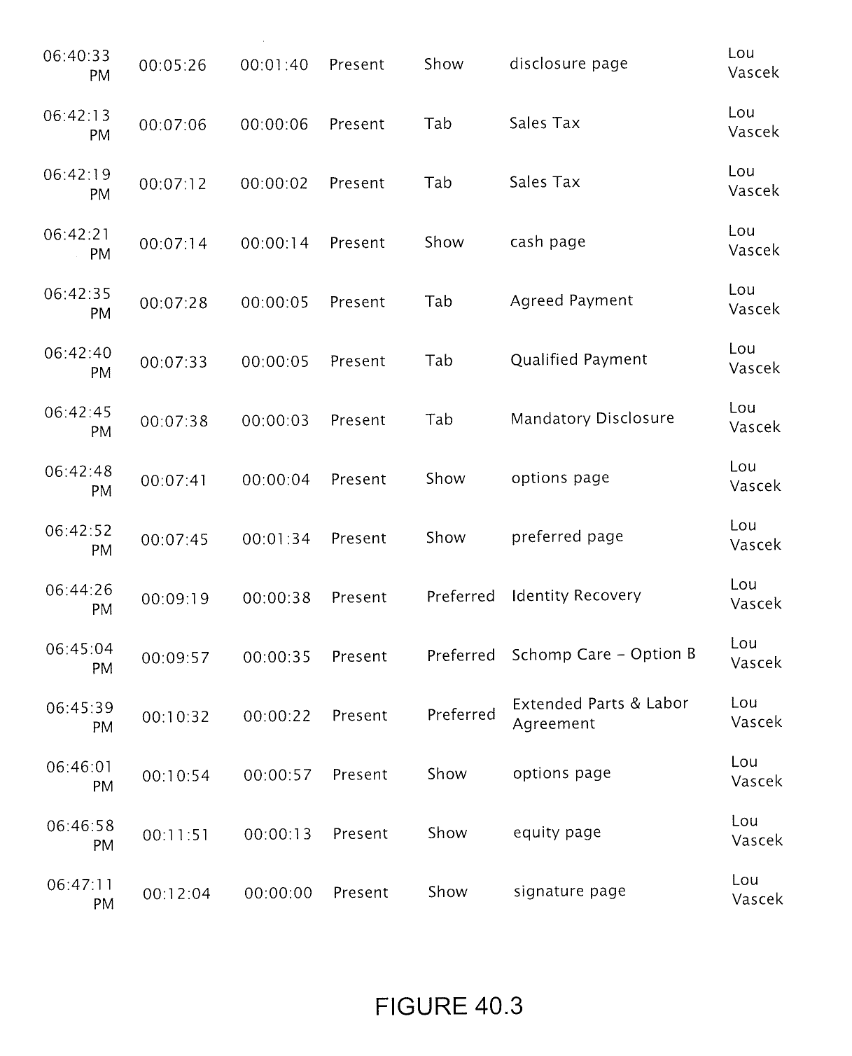

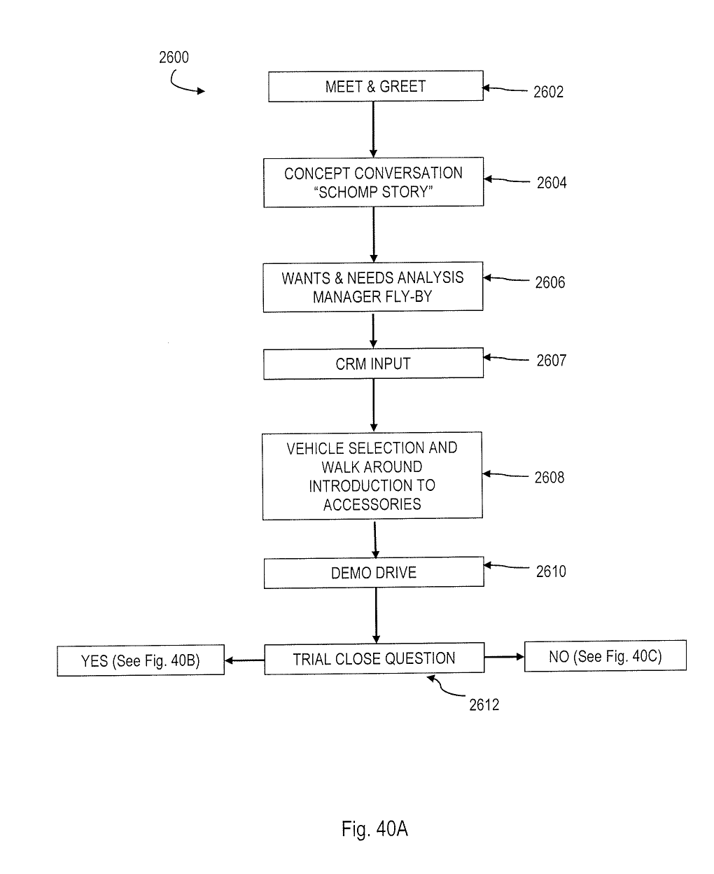

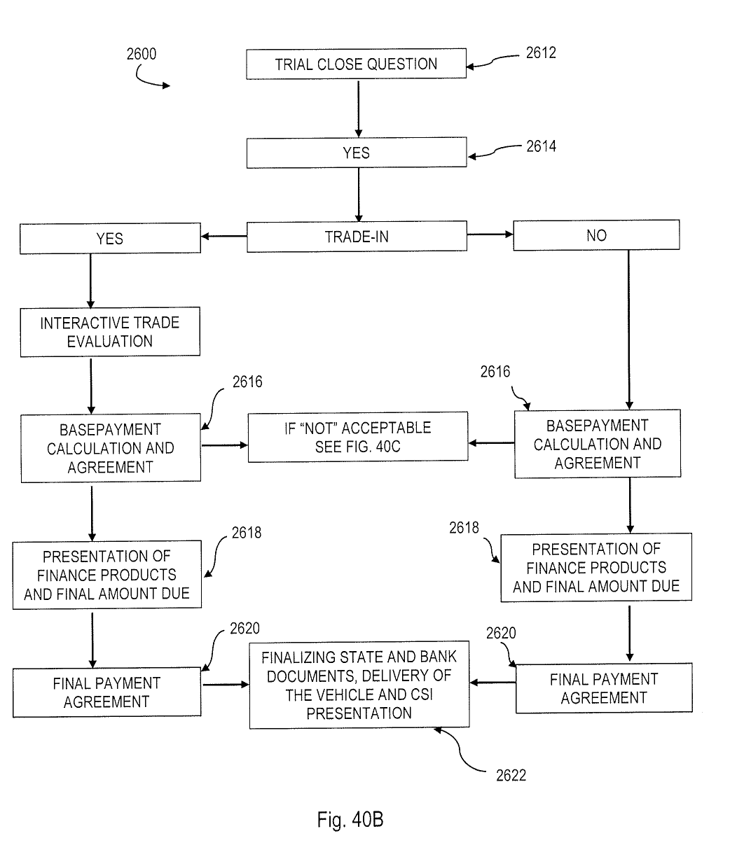

The customer and/or user may input information into the system in response to the questions in a number of ways. For example, as illustrated in FIG. 43, one or more of the wants and needs questions may be followed by a blank data field 2704, in which the user or customer may type-in a response. As illustrated in FIG. 44, one or more of the wants and needs questions may be followed by two or more option buttons 2706. Rather than type-in a response, the customer/user may input a response by simply selecting an appropriate one of the option buttons 2706. As described above, and illustrated in FIG. 45, other questions may be followed by a plurality of multiple option buttons 2708. The user or customer may select as many of the multiple option buttons 2708 as are relevant to the customer and/or primary driver.

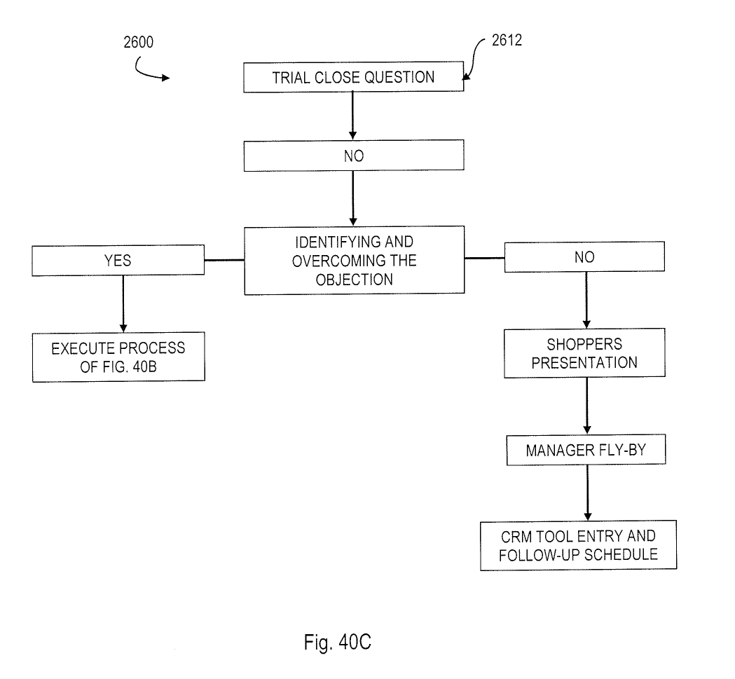

At the conclusion of the wants and needs analysis 2606 the system may display a wants and needs summary 2710 page, for example, as shown in FIG. 46. The wants and needs summary 2710 may include a wants/needs tab 2712 and a notes tab 2714. The user may select the wants/needs tab 2712 to display a listing of all of the wants and needs questions and the customer's responses thereto. In one form, the user may return to any questions to make any required revisions to the customer's responses. The user may select the notes tab 2714 to display a notes field where the user may enter any additional information pertaining to the customer's and/or primary driver's wants, needs, and/or individual circumstances.

In accordance with another aspect, the system may utilize information obtained during the wants and needs analysis 2606 (for example, the customer's responses to various questions) to pre-populate or auto-populate certain terms in certain data fields presented later in the process. For example, the customer's responses during the wants and needs analysis 2606 may be used to auto-populate certain customer data fields (for example, customer data fields 502 described above), vehicle data fields (for example, vehicle data fields 506), and/or deal information data fields (for example, deal information data fields 602). In particular, the system may use a customer's responses to the wants and needs questions to pre-populate one or more data fields in, for example, in one or more of the base payment determination 300, deal structuring 600, product selection 700, cost and coverage verification 800, product selection and finalization 900, and customer repayment option presentation 1000 steps of the system described above and/or in the business CRM module as described in further detail below. This may include, for example, accessory products and/or finance products (such as insurance) that may have particular advantages in view of the customer's vehicle preference(s) and/or other responses to the wants and needs questions. Although the system may advantageously pre-populate these items, they may be deleted from the final deal should the customer so choose. The system may be configured to require a manager approval to do so.

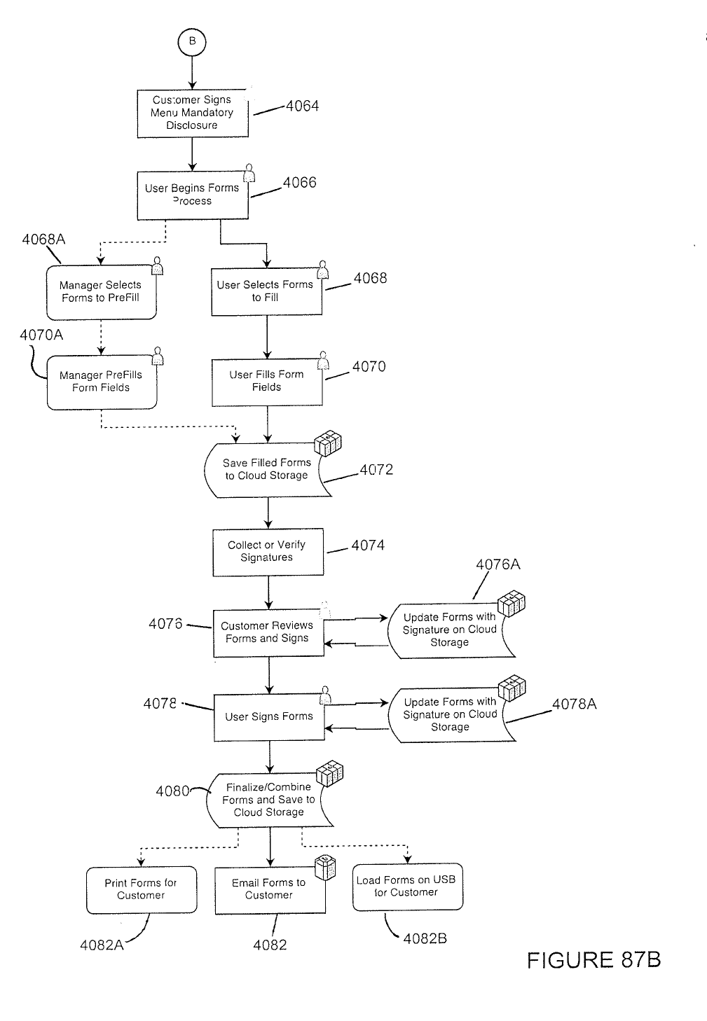

The above-described data gathered through the wants and needs analysis may be stored in an appropriate database as described later in connection with FIGS. 87A, 87B and 88. To this end, the data may be internally processed and/or used in connection with third party software.

During the wants and needs analysis 2606 or prior to proceeding to the next step, the user representative's manager or supervisor may join the conversation in a “manager fly-by” as shown in step 2606 in FIG. 40A. This may be coordinated by the salesperson hitting a button on a GUI that sends an e-mail or other communication to the supervisor indicating that the salesperson is ready for the manager fly-by to occur. In other embodiments, it may include the use of an instant messaging or chat mobile application, for example, the Google Hangouts widget or other suitable tool. In other embodiments, the system 10 may provide a physical cue for the manager, such as a certain color or flashing screen, an audible alarm or other physical cue. Early introduction of the manager/supervisor may assist the continued building of rapport with the consumer. It also allows the manager/supervisor to meet the consumer early on in the transaction in a positive situation rather than waiting until a potential conflict arises. It may also allow the manager/supervisor to more effectively act as a trade-in evaluator later in the process.

Still referring to FIG. 40A, in a preferred embodiment, prior to proceeding to the next phase of the transaction, the user representative may input the consumer's information into the system as shown in the CRM input 2607 step. The information input may include information obtained during the wants and needs analysis into the system, as well as the meet and greet step. Consumer information may be input through one or more GUIs as described above. Certain information may be auto-populated from data provided by the customer in previous steps in the process.

To provide the capability to collect and store consumer information, the system may include or interface with a business CRM module such as Dealer Socket. However, other CRM systems may be used which generally provide an approach to managing a company's interaction with current and future customers. Generally, CRM systems may involve using technology to organize, automate, and synchronize sales, marketing, customer service, and technical support. In this situation, it is preferred that the system allows the user to efficiently access the CRM module from the system to avoid slowing the transaction. Alternatively, the system may itself include software that provides this functionality.

As noted above, in the context of a vehicle dealership, the business may also include a dealership management system (DMS) or auto dealership management system. The DMS system may include software that caters to the needs of the finance, sales, parts, inventory, and/or administration components of running the dealership. Again, however, system 10 may itself include this functionality to avoid or reduce the need to access separate applications.

The DMS system may include support for all aspects of running a dealership such as: sales tracking, parts inventory, customer marketing and/or follow-up. It may include a central server which stores all data, allowing multi-user access, and interactivity between users.

The CRM system may interface with the DMS system and/or other systems utilized in the overall process, including, for example, the system 10 described above.

In one form, the CRM system may be computer implemented and may be accessed and utilized through one or more user interface(s) similar to those described above for system 10. And as noted above, the CRM system may be integral with system 10 described above or it may be a separate software or web-based system. In one form, the CRM system may be a commercially available product.

Preferably, the user interfaces, such as the GUIs described above, allow the user representative to input a number of consumer data items in consumer data fields. The consumer data items may be used in proceeding with the transaction and/or may be used to follow-up with a consumer later regardless of whether the transaction is completed, for example, to provide marketing materials and/or to assess consumer satisfaction.

It is preferred that information entered into the CRM or DMS system may be scraped and imported into other aspects of the system, especially where a third party CRM or DMS service is used. In this manner, the fields in GUIs that are used later in the process may be prepopulated with the imported information. And as noted above, it is also preferred that the different options provided to the consumer may be dragged and dropped into other GUIs as desired.

In one form, the CRM system allows interactivity between various different individuals in the sales force. For example, the CRM system may allow the user representative to create a status or event for a consumer, for example, to initiate the manager flyby or to indicate that a certain vehicle should be prepared for the consumer to do a demo drive.

As shown in FIG. 40A, where the system and method of the current invention are used in a vehicle sale or lease transaction, the next step may involve a vehicle selection and physical inspection or walk-around 2608 of potential vehicles. At this step, the user representative may also provide an introduction to accessory products, for example, accessory products that may have particular advantages in view of the vehicle and/or the analysis of the consumer's wants and needs.

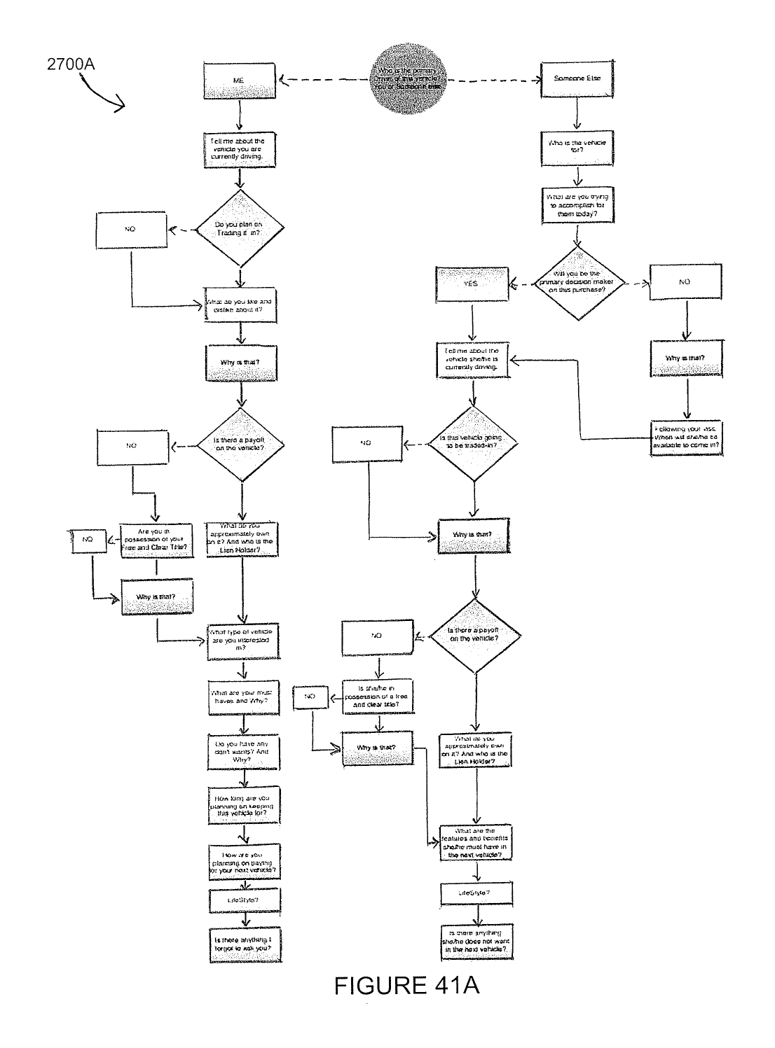

This is now more fully described with reference to FIG. 47. As shown, the vehicle selection step 2608 may include a vehicle search 2800 of available inventory. The vehicle search 2800 may allow the customer and/or user to search for vehicles meeting certain criteria. In one form, the vehicle search 2800 may include a quick search field 2802 where the customer and/or user may enter key words for one or more search parameters (including for example, vehicle make and/or model, etc.) to pull up a list of available vehicles meeting that search parameter. The vehicle search 2800 may also include one or more drop down search filters 2804 for narrowing the search parameters. In one form, the search filters 2804 may allow the customer/user to select (and therefor narrow the search to), for example, the type of vehicle, vehicle make, vehicle model, vehicle year, price. In one form, the price filter may include fields for both minimum and maximum price.

By clicking a search button 2806, the vehicle search 2800 may apply the customer/user's search parameters (including any search filters) and display a vehicle list 2808 of vehicles meeting the search parameters. In one form, the vehicle list 2808 may include a summary display 2810 for each vehicle, which may include, for example, a picture of the vehicle, the year, make, and/or model of the vehicle, additional details about the vehicle, which may include, but are not limited to, engine, transmission, color, mileage, and price. In one form, the price listed in the summary display 2810 may be identified as the dealership's best price for the vehicle. The summary display 2810 may also include a details button 2812, which the user or customer may click to pull up a page providing further details about the vehicle. It may also include a “select vehicle” button 2814, which may allow the user/customer to initiate a test drive of that vehicle and/or calculate a base payment for the vehicle.

Depending on the search parameters/filters, the vehicle list may include multiple vehicle summary displays 2810 and/or multiples pages of such vehicle summary displays 2810. Thus, the vehicle list 2808 may include one or more page number tabs 2816 for selecting a specific page of the vehicle list 2810 and/or forward and backward tabs 2818, 2820 for moving forward and/or backward to different pages in the vehicle list 2808. Finally, the vehicle list 2808 may include a drop down sort menu 2822 allowing the customer/user to sort the vehicle list by a given parameter, such as price, mileage, year, etc.

The vehicle list 2808 and/or summary displays 2810 may be generated from internal inventory data. In addition, or in the alternative, the vehicle list 2808 and/or summary displays 2810, may include data obtained from a mobile application and/or website, which may include, for example, one or more third party sources such as Homenet Automotive, dealer.com, etc. In a preferred embodiment however, the inventory search avoids the user/salesperson from accessing the dealer′ website as a prospective customer, to in turn avoid skewing the metrics associated with customer traffic.

By clicking the select vehicle button 2814 for a particular vehicle, the system may initiate the desking aspect of the transaction. As described above, the desking aspect of the system may include the collection and/or accessing of customer information, determination of financing and other sales terms of the car purchase or lease once the car has been chosen, and/or the selection of various items such as accessories, warranties and other items.

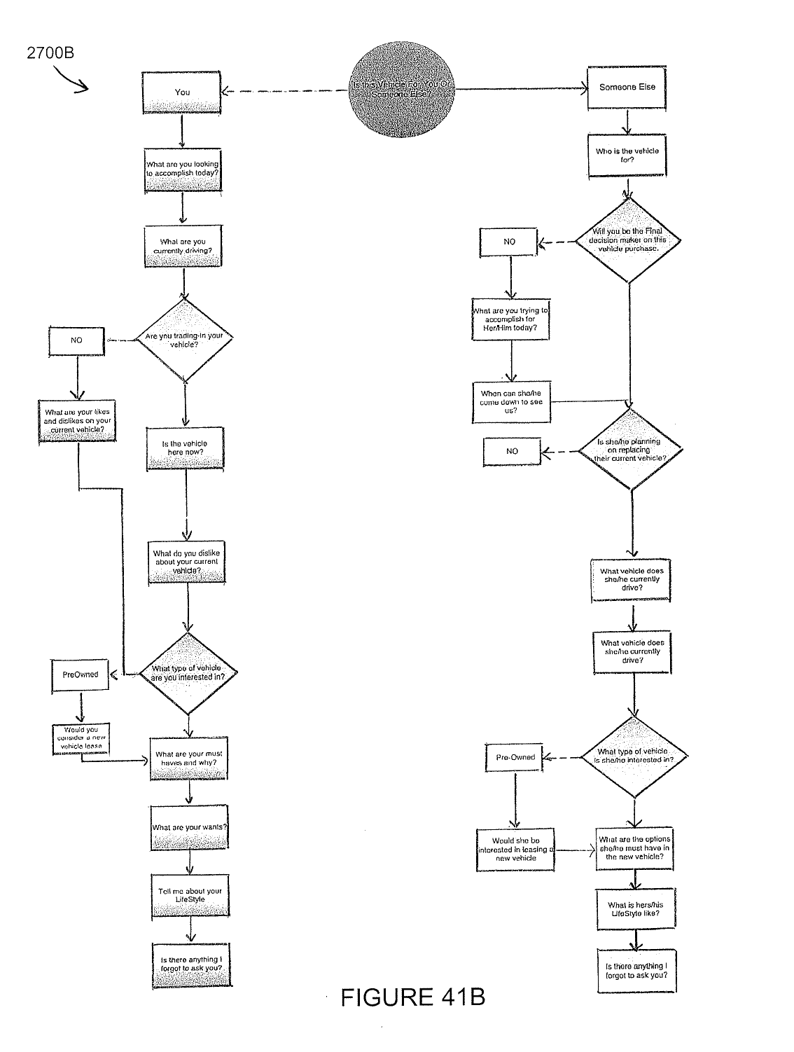

In one form, by clicking the select vehicle button 2814, the system may bring up a preliminary transaction confirmation page (such as preliminary transaction confirmation 500 page described above and as shown in FIG. 48). The preliminary transaction confirmation page may include one or more customer data fields displaying one or more customer data items that had been previously entered into system and/or auto-populated from the customer's answers during the wants and needs analysis 2606. The customer data may include, for example, first and last name, email address, phone number, address, city, state, insurance company, insurance agent name and/or phone number, and the like.

Additionally, the preliminary transaction confirmation page may include one or vehicle data fields displaying one or more vehicle data items for example, type (new or used), vehicle identification number (VIN), stock number, mileage, warranty status, in service date, make, model, year, demonstrator license plate number, and the like. In one form, one or more items of vehicle data may be auto-populated from the vehicle data summary 2810 of the selected vehicle. The customer data items and/or vehicle data items may be reviewed and/or revised as appropriate.

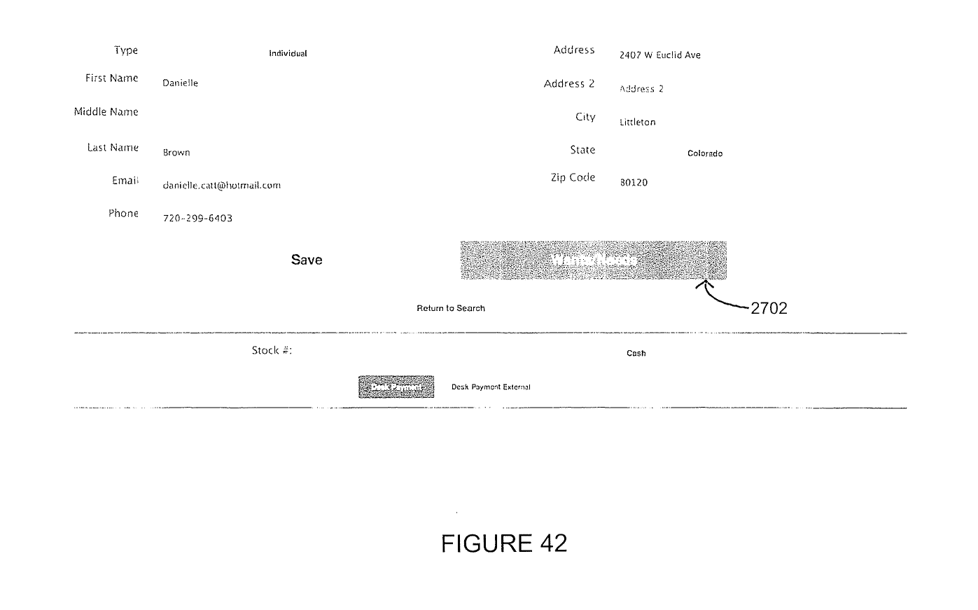

After the foregoing has occurred, steps may be taken in order to arrange a test or demo drive in advance of the test or demo drive 2610 in FIG. 40A. For example, as shown in FIG. 49, system 10 may display a test drive agreement page 2850. The test drive agreement page 2850 may include additional customer data fields 2852 for entering information such as the customer's driver's license number, issuing state, and expiration date. Additionally, it may include a field for any additional authorized drivers. The test drive agreement page 2850 may also include one or more return agreement fields 2854 which may include terms such as the maximum mileage for the test drive, the date and/or time that the vehicle will be returned. The test drive agreement page 2850 may also include one or more signature fields 2856.

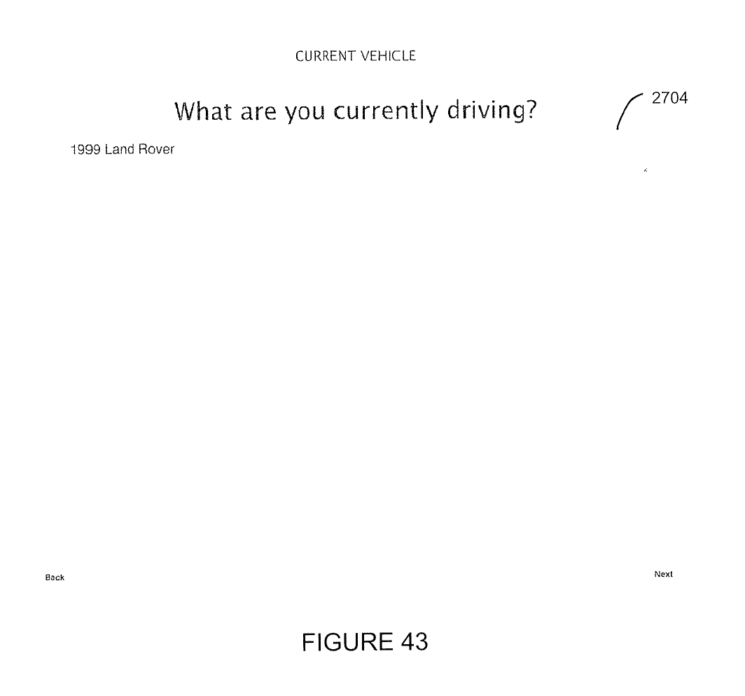

The test drive agreement page 2850 may also include an agreement details display 2858 which may display additional details and/or agreed terms to be incorporated in the test drive agreement. A save and print button 2860 on the test drive agreement page 2850 may allow the user and/or customer to save the information and print a hardcopy of the Test Drive Agreement including all of the customer data, return agreement data, and the additional details (as illustrated in FIG. 50).

In one form, the test drive agreement page 2850 (as well as other agreements discussed herein above and below) may be executed with electronic signatures, or e-signatures, which may comply with the requirements of the Electronic Signature in Global and National Commerce (E-SIGN) Act of 2000, the Uniform Electronic Transactions Act (UETA) model law, and/or other pertinent regulations. Thus, for example, the test drive agreement page 2850 (as well as any other page discussed herein that may include electronic signature fields, may include, for example, but not be limited to: (1) a confirmation of the signing parties' intent to sign; (2) a confirmation of the parties' consent to do business electronically; (3) confirmation of an association of the e-signature with a record (for example, a test drive agreement); and (4) confirmation that the e-signed record is capable of retention and accurate reproduction for reference by all parties entitled to retain the record. In one form, the e-signature function and any required document retention and/or archiving may be implemented through an integrated enterprise e-signature solution such as Adobe Document Cloud, DocuSign, Canon Deal Archiving, or the like. In yet another form, suitable e-signature pad hardware may be integrated with the system.

During this step, the user may press a button on the pertinent GUI which may alert others at the dealership that the desired car should be prepared for a test drive and brought up to the sales floor. In other embodiments, system 10 may use an instant messaging or chat mobile application, the Google Hangouts widget or other suitable tools to provide notifications. For example, the system may provide a physical cue, e.g., color-coded or flashing screen, or audible alarm.

As an example, the detailing department of the dealership may receive a notification that the desired car must be cleaned for the test drive. This preferably keeps the sales process moving forward to avoid the consumer losing interest and leaving the dealership. Also during this step, the user may obtain the consumer's e-signature regarding liability issues that could arise by the consumer's driving the vehicle during the test drive. The user may also obtain the consumer's insurance information and scan in a copy of the consumer's driver's license that may then be stored in the system.

Referring again to FIG. 40A, a test drive or demo drive 2610 of the selected vehicle may then occur. To this end, it is preferred that the type of route is selected to be in line with the type of consumer the user is dealing with. For example, the user may have discerned from earlier steps in the process that the consumer is an aggressive driver such that a hilly and/or curvy route may be preferable. Other types of routes for other types of drivers may be selected. This reflects another physical step performed by system 10, e.g., where a test drive route is programmed into a GPS or navigation system, and the route is displayed on the navigation screen in the vehicle.

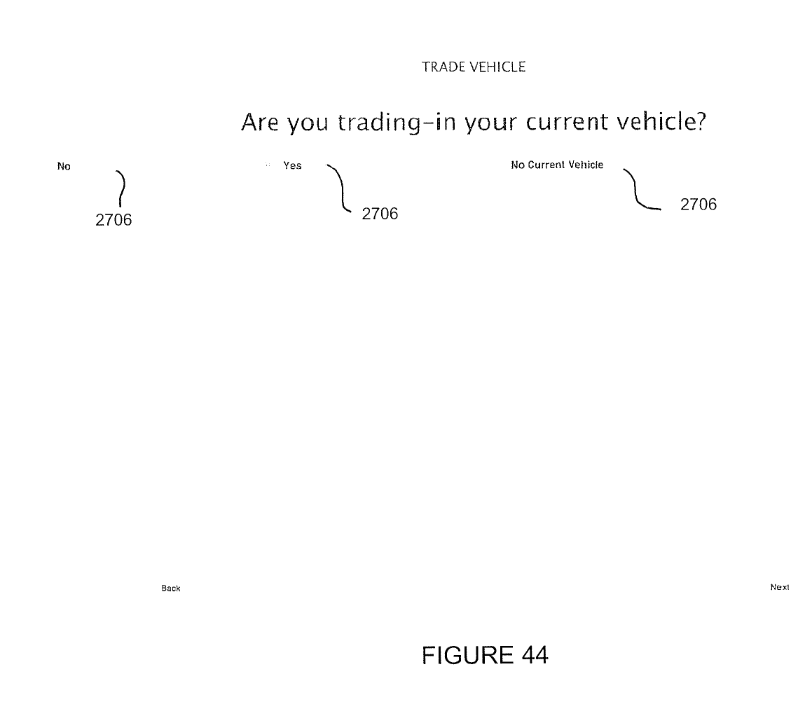

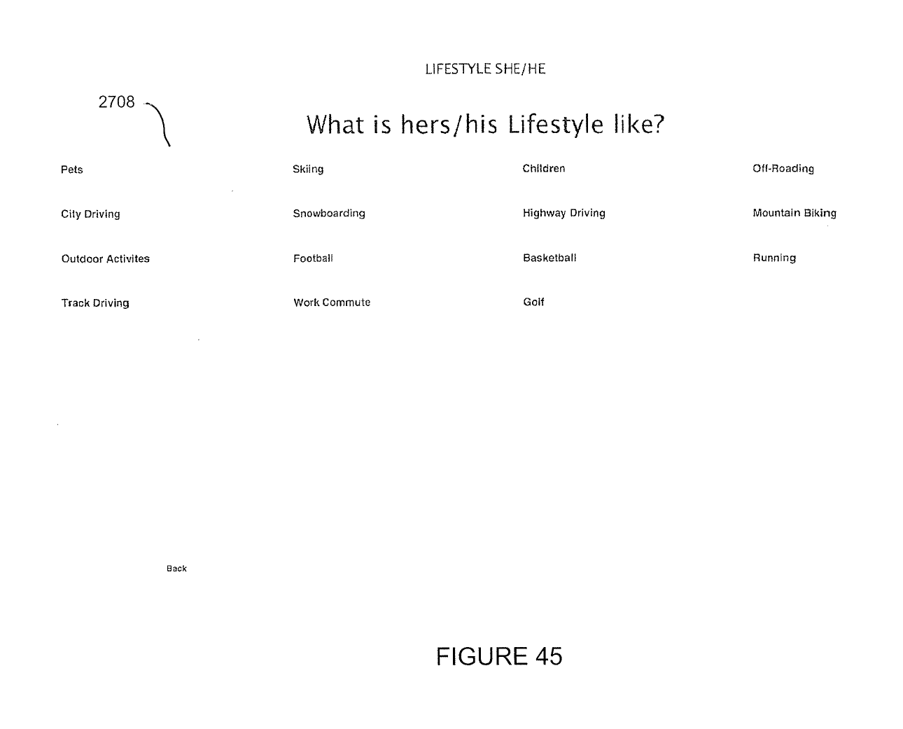

During the demo drive step 2610, or other step, of the process, system 10 may provide a test drive agreements list page 2870 which may provide a list of the customer's prior and/or pending test drives. The test drive agreements list page 2870 may allow the user to edit a test drive agreement, print a test drive agreement, delete a test drive agreement, add a new test drive, proceed to a finance calculator, or desking page, for a vehicle that was previously test-driven, and/or end a test drive. As shown in FIGS. 51 and 52, selecting an “end” test drive button 2872 may bring up an “end test drive” screen 2874, which may allow the user to enter the vehicle mileage and click a “complete test drive” button to terminate the specified test drive agreement.

Referring again to FIG. 40A, after the demo drive 2610, the sales person or user representative may conduct a trial close procedure 2612 as illustrated in FIGS. 40B and 40C to gauge the interest of the consumer in actually closing the transaction and/or to determine whether the salesperson is on the right track with the consumer, e.g., whether the salesperson has been presenting on the vehicle that is really of interest to the consumer.

FIG. 40A shows steps where the trial close question results in a “yes” by the consumer, while FIG. 40B shows steps where the trial close question results in a “no” by the consumer. If there is a “yes” or otherwise sufficient interest by the consumer in the vehicle under consideration, the transaction may proceed as shown in FIG. 40B.

For example, if the consumer has a vehicle to trade in, the vehicle trade-in potential may be evaluated. It should be noted that whether a consumer intends to trade in a used vehicle may be discerned during the wants and needs analysis 2606. In one form, the trade-in evaluation 2614 is interactive. It may involve an additional individual of the sales force such as a manager/supervisor who previously conducted a fly-by or other suitable trade-in evaluator. In one form, the trade-in evaluation system may be computer implemented and may be accessed and utilized through one or more user interface(s) similar to those described above for system 10.

The trade-in evaluation system may be integral with system 10 described above and/or the overall system 2600. Alternatively, it may be a separate or third party software or web-based system. In one form, the trade-in evaluation system may be a separate commercially available product. Where third party software is used, it is preferred that system 10 efficiently integrate therewith to avoid slowing down the transaction. It is also preferred that system 10 cull trade-in data from such third party service for internal storage in an appropriate database for future reference.

For example, an application named VAuto may be used to collect information on the trade-in vehicle. For example, the VIN may be scanned in and questions may be answered, or boxes checked, by a user to indicate the condition of the vehicle. Information in categories such as condition, damage, options and other aspects of the trade-in vehicle may be collected. During this step, the user and consumer may also go for a test drive of the trade-in vehicle to gather information on how the vehicle actually drives. The application may then provide a suggested trade-in-value and/or the user may also provide his or her input. Alternatively, the system may include software that provides this function.

If, after the demo drive 2610 and trade-in evaluation 2614, the consumer is interested in moving forward with the transaction, the user representative may proceed to a base payment calculation 2616 and a finance product presentation 2618 resulting in a final transaction payment agreement 2620. In one form, the steps of the base payment calculation 2616, finance product presentation 2618, and final payment agreement 2620 may proceed in accordance with the system 10 described above and illustrated in FIGS. 1-37.

Thus, in one form, the base payment calculation 2616, finance product presentation 2618, and final payment agreement 2620 steps may be computer-implemented and may include the user login 100, customer search 200, base payment determination or “desking” 300, base payment import 400, preliminary transaction confirmation 500, deal structuring 600, product selection 700, cost and coverage verification 800, product selection and finalization 900, and customer repayment option presentation 1000 described above.

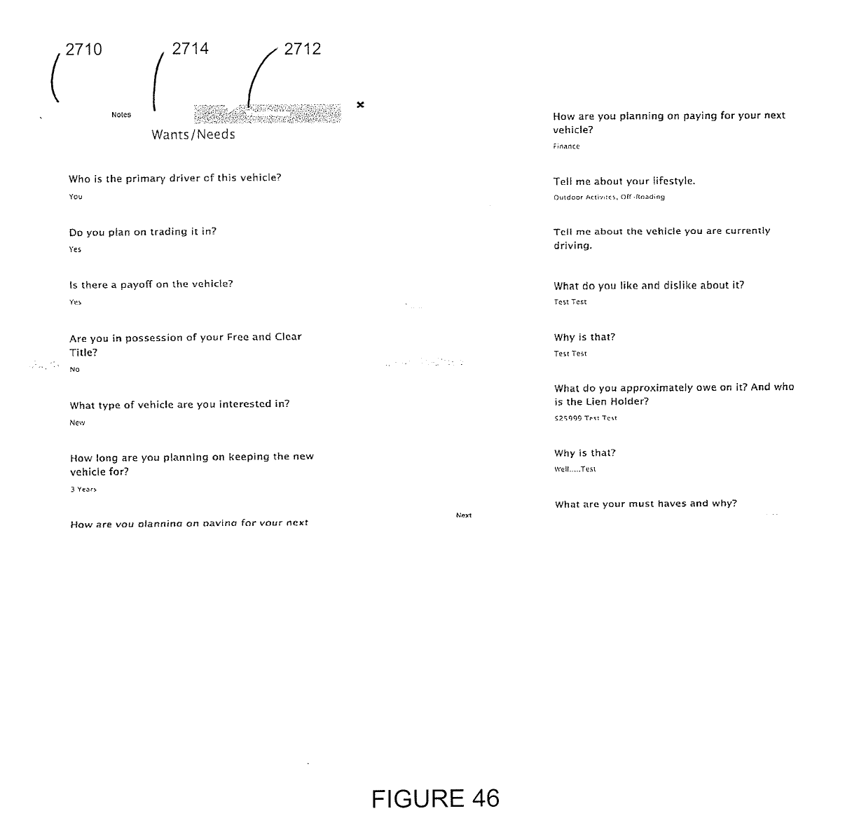

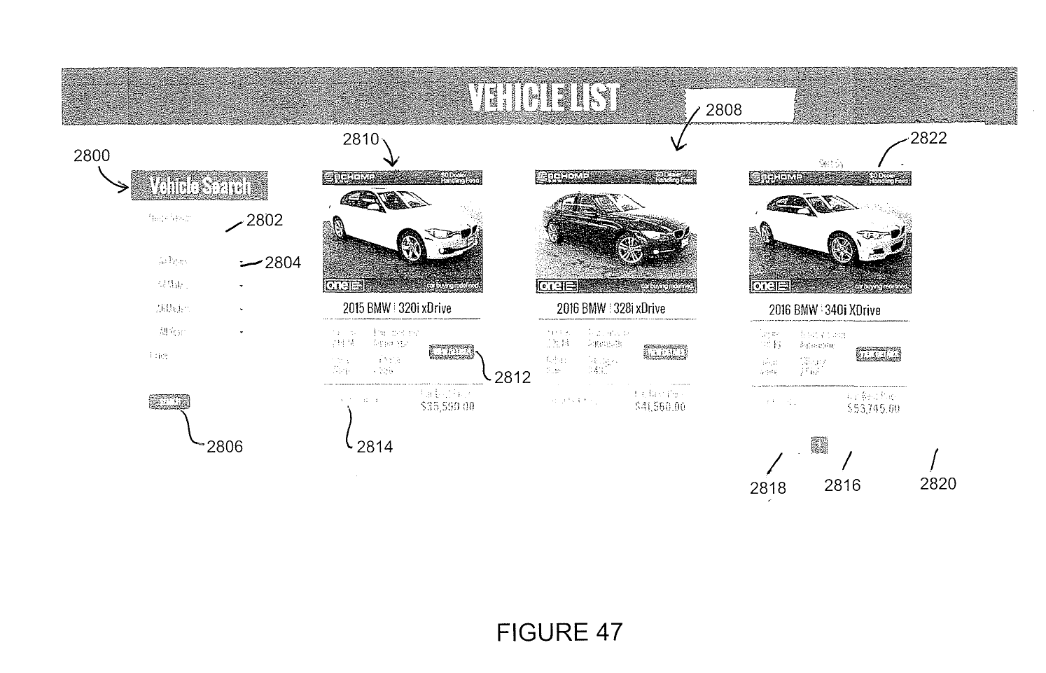

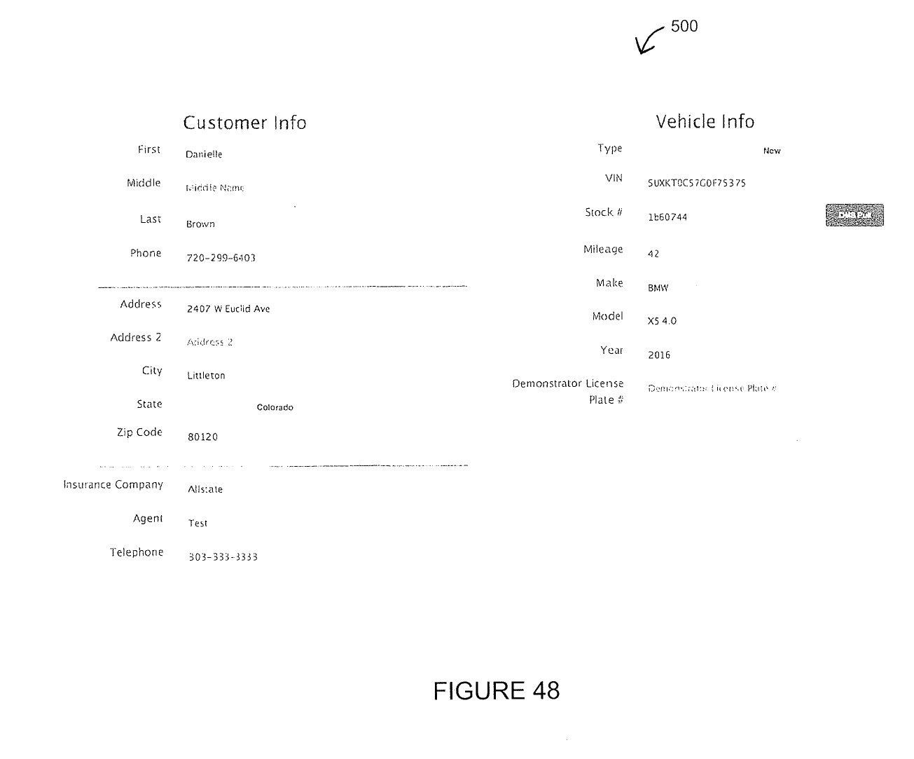

As noted above, the base payment calculator, or desking tool, may be a commercially available separate enterprise product or it may be integral with system 10 itself. For example, system 10 may provide a finance payment calculator 2900 such as illustrated in FIG. 53. The finance payment calculator may display one or more finance payment options 2902 and/or lease payment options 2904 depending on certain base payment variables 2906 such as the type of vehicle, the MSRP for the vehicle and/or the dealership's listed price for the vehicle, the term (i.e., number of months), the amount due at signing, the annual percentage rate, the amount of cash down the purchase tax amount, the trade value and/or trade payoff amount for any trade-in vehicle, and various additional fees or rebates that may be associated with the purchase. Upon selecting one of the one or more finance payment options 2902 and/or lease payment options 2904, the system may display a customer acknowledgement of basic terms agreement 2908, which may be signed traditionally and/or e-signed as described above.

Where the base payment calculator is integral with system 10 itself, for example, as illustrated in FIGS. 53 and 54, system 10 may provide quick access to the finance payment calculator 2900 for example, with a Quick Quote button 2910 as illustrated in FIG. 55.

Again referring to FIG. 40B, if the transaction proceeds, execution of state and finance documents may occur at a document finalization step 2620. This may include a bill of sale, tax receipt, DMV documents and other relevant documents. It is preferred that during the base payment step 2616, or other earlier step, the user may hit a button on the pertinent GUI that triggers preparation of the foregoing documents. In this manner, when the transaction reaches the document finalization step 2620, the documents are ready to be executed without delay, which may avoid providing the consumer an opportunity to back out of the deal at the last minute.

Vehicle delivery 2622 or the scheduling of delivery may then occur. The user may then provide the customer with a customer service index (CSI) presentation to complete the deal. This may comprise a short video presentation thanking the consumer for his or her business as well as solidify the dealership's philosophy and attention to customer satisfaction. This preferably encourages customer loyalty.

If during the trial close procedure 2612 of FIG. 40A, the consumer indicates that he or she is hesitant or does not wish to close the transaction, the user representative may proceed according the steps shown in FIG. 40C. This may include, for example, identifying and attempting to overcome the consumer's reasons for being hesitant. If successful, the user representative may proceed with the transaction according to FIG. 40B. If not, the user representative may proceed with a shopper's presentation to highlight the benefits of dealing with the business, an additional manager fly-by, and/or a CRM/DMS system entry of consumer data for follow-up marketing and/or consumer satisfaction inquiry.

The foregoing approach to the overall transaction and the GUIs that are used throughout to provide information to the consumer through the transaction preferably engenders the consumer's trust. This is in large part due to the transparency and real-time information provided by the salesperson user during the transaction. This is in sharp contrast to a salesperson who simply hands the consumer some literature that is bound to cause mistrust.

The GUIs described above preferably include a field for the user to input notes about the consumer and/or the transaction through the different steps. This further allows the user to cater to the user.

As noted above, the system of the current invention may include a time tracking capability. This may monitor the time spent by the user on each step. Besides time tracking, various other information may be collected by the system and used to provide various reports and business analytics. An example of such a report, e.g., a Deal Report, is shown in FIGS. 40.1-40.3. For example, the report may set forth basic information such as Customer Name, Salesperson, Vehicle Make Model and Deal Type (Finance/Lease or Cash). This time-monitoring feature may provide physical cues, e.g., visual or audible, regarding whether too much, too little or the appropriate amount of time is spent on various aspects of the transaction.

The report may also include a Profit/Loss portion for that transaction which may show all the products that the Client Advisor has sold and the Gross Profit that the Dealership has earned on that product. Also, it may display the Finance Reserve dollar amount the Bank will pay out to the dealer.

The report may also include a Time Taken portion, which may break down each step of the presentation and display how long the Client Advisor took on each page and part of the presentation. As mentioned above, this aspect of the report may be used as a training tool.

Other reporting tools may also be generated such as Individual Client Advisor Total Profit/Loss (breakdown of average closing ratios, gross profit and time taken on all deals the Client Advisor has done); Sales Team Report (displaying average numbers of all Client Advisors who are part of Team X,Y,Z . . . ); New, Used or CPO vehicles reporting (ability to pull up only Used, NEW or Certified Vehicles); the reports may also measure the time spent on each step of the sales process, e.g., Concept Conversation, Wants And Needs Analysis, Test Drive etc.; Each General Manager or other appropriate person may also have the ability to see when and by whom individual reports were viewed.

In an alternate embodiment, the foregoing method and associated GUIs may be completed by the user online. In this embodiment, the user may be the customer himself/herself. For example, the customer may visit the website of the dealer or other business and provide information in the various fields of the GUIs discussed above. As an alternative, the consumer may accomplish this on his/her computer, tablet, smartphone or other mobile device.

Where the consumer is proceeding through the GUIs discussed above, system 10, or the dealer's website or other portal may provide a real-time chat source to answer the consumer's questions or otherwise guide the consumer through the process. A dealer representative may also be available over the phone to discuss various items with the consumer.

In this embodiment, certain steps of system 10 may not be readily accomplished because the consumer is not physically at the dealership or other business providing system 10, e.g., the walk around step 2608 and demo drive step 2610 of FIG. 40A. However, the consumer may still proceed through sufficient steps of system 10, where the consumer provides the necessary information, at home or at another location to arrange a walk around or demo drive. To this end, the pertinent agreements and other documentation described above may be completed in advance of the consumer visiting the dealership or other business to perform the physical steps of a walk around and demo drive.

This embodiment, where a number of the steps may be completed by the consumer user remotely, may particularly appeal to younger consumers who have grown up with digital communication as part of their lives.

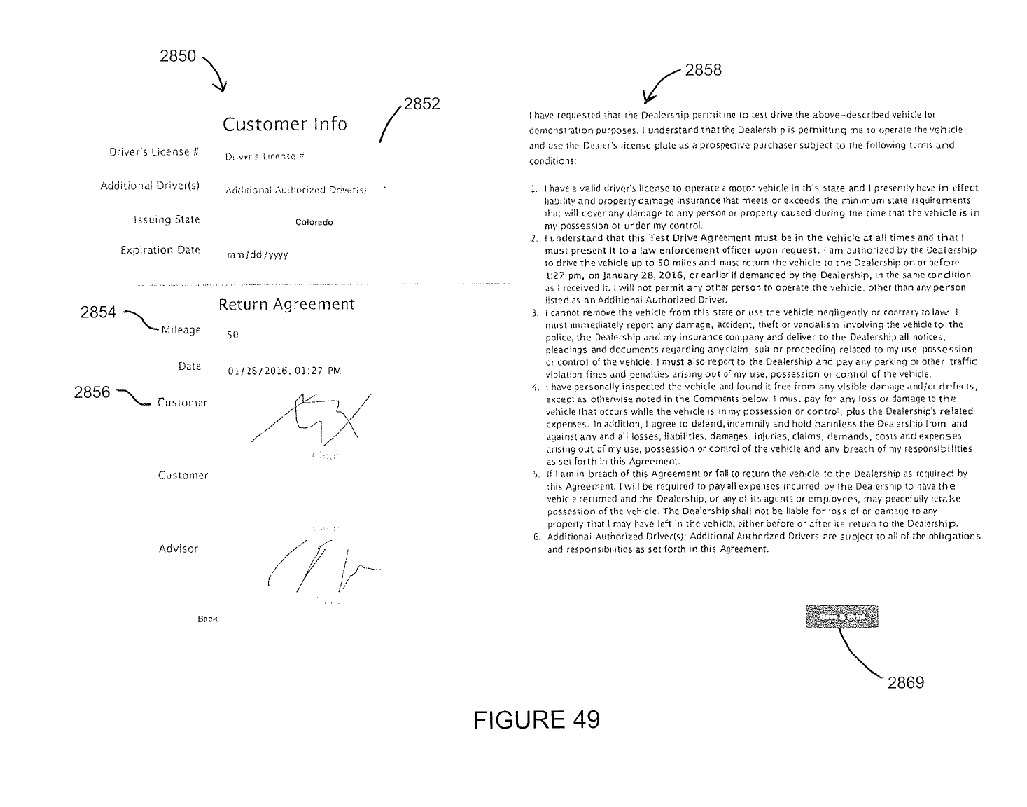

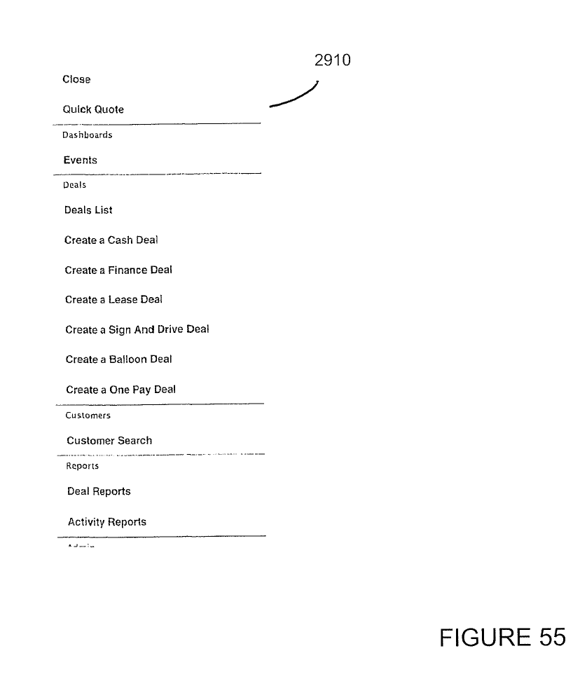

FIGS. 56-87 show examples of additional graphic user interfaces (GUIs) 3000 which may be utilized in connection with system 10 in accordance with other aspects of the invention. GUIs 3000 may include the features and functions of user interface(s) 12 described above with respect to FIGS. 2-36. Thus, the differences will be described in further detail herein.

FIG. 56 illustrates a menu 3002 that the user may access upon logging into system 10. Menu 3002 may include the features and functions of menu 204 described above and shown in FIG. 5. In one form, menu 3002 that is displayed to a user, may be customized based on the user's identity, user role, assigned permission(s) and/or IP address. Thus, for example, in one form, menu 3002 may display links to only those features/function available to a specific user.

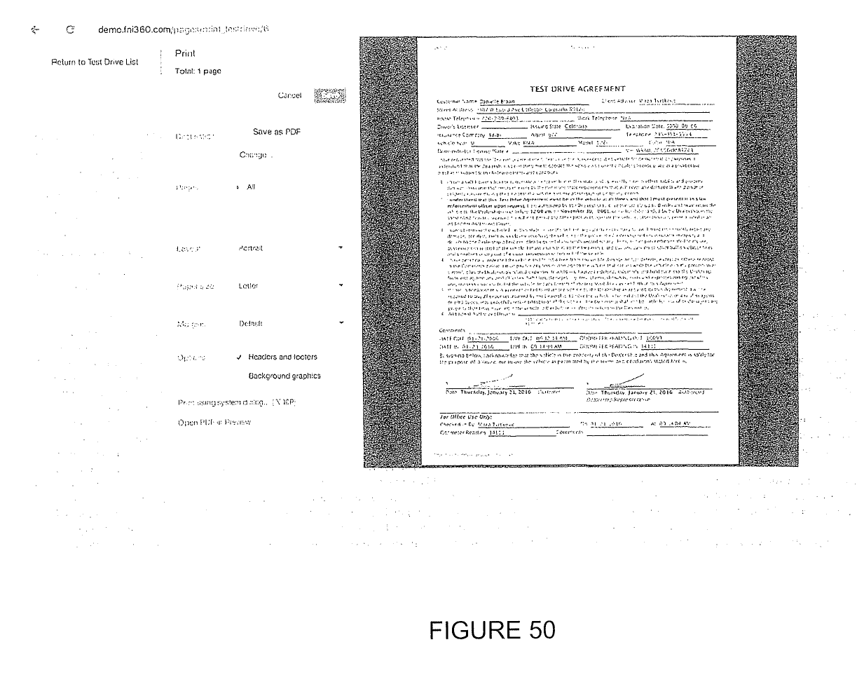

Menu 3002 may allow the user to view and/or access certain features and/or functions of system 10, including for example, deal information and/or customer information. By selecting a deals list 3004 from menu 3002, the user may view and/or access a deal search feature 3006 of system 10. As shown in FIG. 57, the deal search feature 3006 may allow the user to search for existing deals, including pending deals, completed deals, incomplete deals, etc. The user may search for deals using a plurality of search filters 3008. In one form, search filters 3008 may include for example, time frame, sales managers, user and combinations thereof. Each of the filters may include a drop down menu allowing the user to select one or more options for each search filter 3008. Upon selecting the desired search filters 3008, the user may click a filter button 3010 to display a filtered deal list 3012 including any deals that meet the requirements selected by the user.

Each deal listed in the deal list may provide one or more items 3014 of data about the specific transaction. For example, in one form, for each deal, the deal list may display, the date created, the VIN, the vehicle make, model, and year, the customer name, the sales person, the type of deal (i.e., finance or cash) and combinations thereof.

Each transaction listed in the deal list may have one or more function buttons associated therewith that the user may click, or select, to perform certain aspects of the transaction. In one form, for example, the function buttons may include action button 3016, print button 3018 and delete button 3020.

Thus, using the deal search feature 3006, the user may access an existing deal and then proceed through the steps of system 10 as described above in connection with FIG. 1, including for example, a base payment determination or “desking” 300, a base payment import 400, a preliminary transaction confirmation 500, a deal structuring 600, a product selection 700, a cost and coverage verification 800, a product selection and finalization 900 and a customer repayment option presentation 1000.

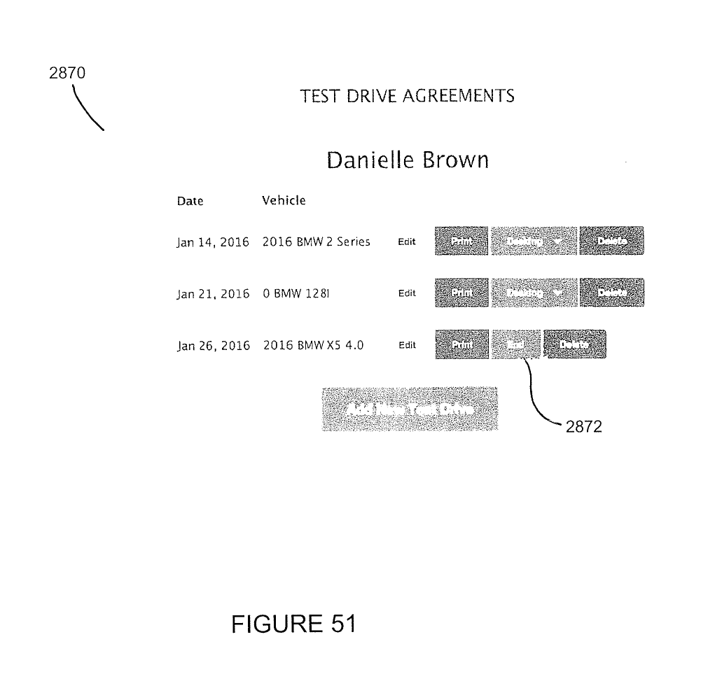

FIGS. 58-61 show examples of GUIs 3000 that may be used in connection with various steps of system 10. For example, FIG. 58 shows a trade-in evaluation notice 3022 which may be displayed, for example, prior to beginning the desking 300 step of system 10. The trade-in evaluation notice may include a trade-in evaluation overview 3024, which may provide a summary or overview of the trade-in evaluation process, including the information required and a summary of the customer's role in the process. The trade-in evaluation notice 3022 may also include a desk payment button 3026 allowing the user to proceed to the desking 300 step of system 10. As illustrated, in one form, the desk payment button 3026 may include a drop down menu 3028 allowing the user to select the type of payment, including for example, cash, finance, lease, sign and drive, balloon and one pay.

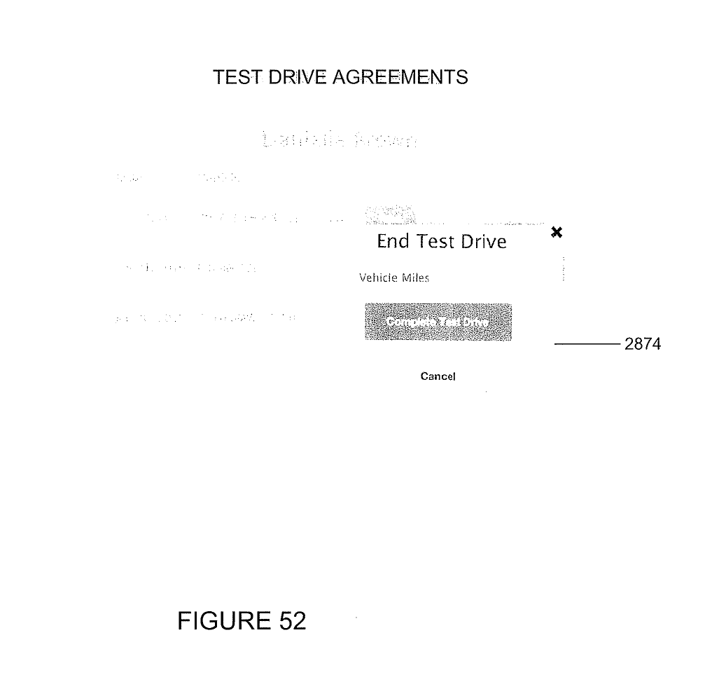

FIGS. 59A-E illustrate a number of finance payment calculator 3030 pages which may use a trade value of a customer's vehicle as determined by the trade-in evaluation. Finance payment calculator 3030 may include the features and functions of finance payment calculator 2900 discussed above and illustrated in FIG. 53. However, as shown in FIG. 59A, the payment calculation may begin with a user performing trade-in search 3032. Trade-in search 3032 may allow the user to search for a predetermined trade value of a customer's vehicle as determined by a trade-in evaluation. The trade-in search 3032 may allow the user to search for a trade value, for example, by customer name, time period and/or combinations thereof. A predetermined trade value may then be imported into the finance payment calculator 3030 to proceed with the base payment calculation and preliminary transaction confirmation.

As illustrated, for example, in FIG. 59B, the finance payment calculator 3030 may include a trade value field 3034 in which the user may manually enter a trade value. Import button 3036 may be associated with the trade value field 3034 allowing the user to access the trade-in search 3032 and import a predetermined trade value.

As illustrated, for example, in FIGS. 59B-59E, finance payment calculator 3030 may include a plurality of pages for displaying information to the user and/or customer. As illustrated, each page or GUI may display vehicle details such as MSRP and best price, monthly payment and term, and the amount due at signing. The user may select from a plurality of buttons or tabs to display different information on the page. In one form, the buttons or tabs may include, for example, an adjust finance tab 3038, a payment comparison tab 3040, and a detailed view tab 3042. The selected tab may be shown in a different color from the unselected tabs to give the user a visual confirmation of the selection.

As illustrated in FIG. 59B, selecting adjust finance tab 3038 causes a plurality of finance data fields 3044 to be displayed. The user may enter and/or edit finance data terms in the finance data fields 3044, by manually entering/editing the finance data term, by selecting a finance term from a drop down menu, and/or by importing a finance data term as described above.

As illustrated in FIG. 59C, selecting payment comparison tab 3040 may cause a comparison of finance payments and lease payments to be displayed. As illustrated, a plurality of different monthly finance payments and monthly lease payments may be displayed based on the amount due at signing and the term.

As illustrated in FIG. 59D, selecting detailed view tab 3042 may cause additional details of the selected monthly payment to be displayed. The detailed view 3042 may include, for example: capitalized costs, such as price, trade value, cash down, taxes, and/or license fees; financing costs, such as the total due, the financing term and annual percentage rate, and finance charge(s); and an amount due at signing, including for example, cash down and/or title for a trade vehicle.

As illustrated in FIG. 59E, upon selecting one of the one or more finance monthly payment options and/or monthly lease payment options, the system may display a base payment acknowledgement 3046. The base payment acknowledgment may state the approximate monthly base payment, the term, and the annual percentage rate. It may also include a disclaimer to the effect that the payment terms are based on standard rate and are subject to change and/or dealership approval. The base payment acknowledgement 3046 may include a signature block 3048 for the customer to sign to acknowledge.

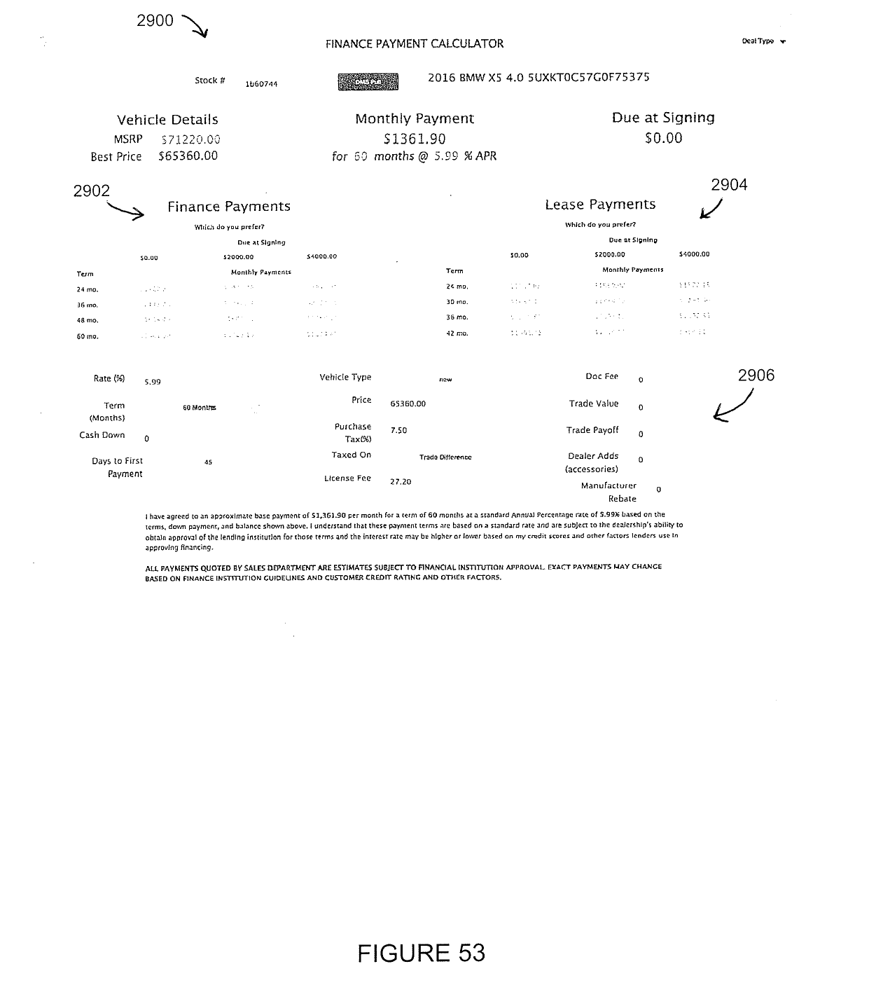

As illustrated in FIG. 60, upon acknowledging the base payment, a customer acknowledgement of basic terms agreement 3050 may be displayed. The basic terms agreement 3050 may include the same features as the customer acknowledgement of basic terms agreement 2908 discussed above and illustrated in FIG. 54. Similarly, it may be signed traditionally and/or e-signed as described above.

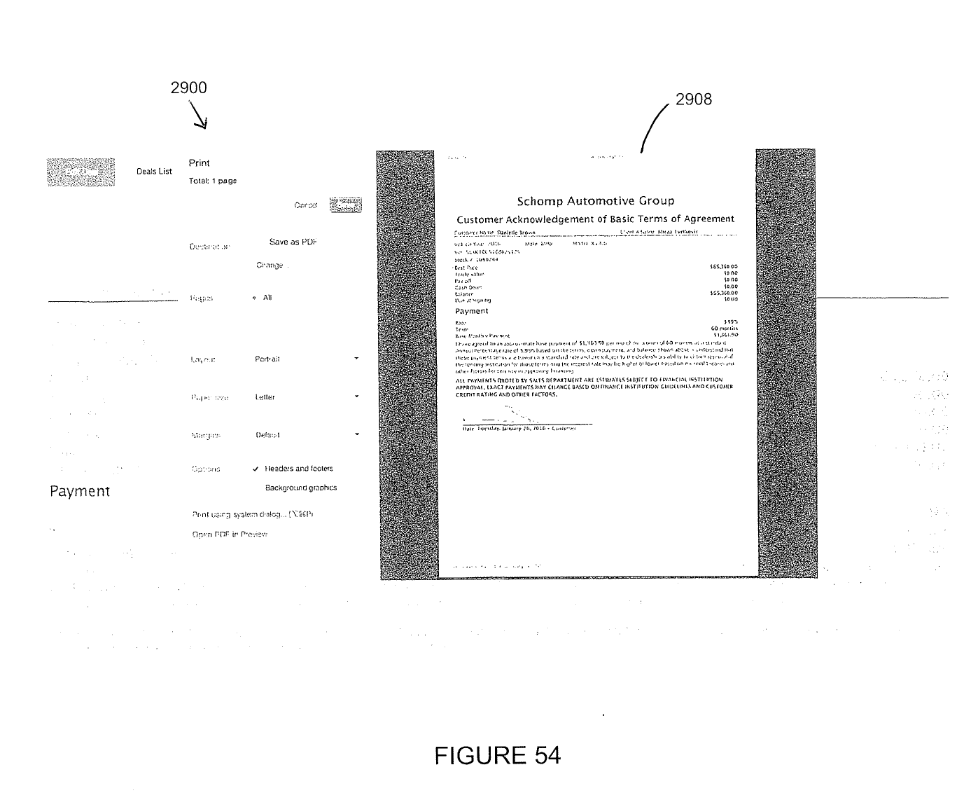

FIG. 61 illustrates a product selection page 3060 for facilitating the product selection 700 step of system 10 as shown in FIG. 1. Product selection page 3060 may include the features and functions of the production selection 700 page described above and shown in FIG. 13. Thus, product selection page 3060 page may include a list of available intangible products and tangible products. One or more tangible and/or intangible products may be selected by the user and added to the customer's transaction, for example, by highlighting a product and clicking an add button 3062. As illustrated, the tangible products may be added and displayed in a preferred/budget option field 3064, and/or a standard option field 3066 depending on which add button 3062 the user clicks after selecting a product. Likewise, intangible products may be added to one or more equity protection package fields 3068 by clicking the appropriate add button. It is preferred that the products selected reflect the customer's wants and needs as would have preferably been communicated by the customer through appropriate inquiries (for example, during the wants and needs analysis) by the user/salesperson.

As illustrated, upon adding an intangible and/or tangible product to one or more plans, the product may appear in the plan field with an associated delete button 3070. The user may also click the delete button to remove the product from the plan.

Product selection page 3060 may also include a drag and drop option as discussed above. For example, in one form, the user may select a product and drag the product over to one or more plan field to add it to the plan.

Product selection page 3060 may also include a print button 3072 and/or a present button 3072, allowing the user to display an overview of the plan selections on paper or screen.

With reference again to FIG. 56, menu 3002 may also include an option allowing the user to access the customer search 200 function of system 10 as described above and illustrated in FIGS. 1 and 4-7. In one form, by selecting the customer search from menu 3002, a find a customer page 3080 may be displayed. The find a customer page 3080 may include the features and functions of the customer search pages described above and shown in FIGS. 4-7. Additionally, the find a customer page 3080 may include a recent customers list 3082 listing a plurality of customers whose customer information the user has recently viewed and/or accessed. The user may select a customer from the recent customers list 3082, or he or she may search for a customer by entering one or more customer data item(s), such as the first or last name, e-mail address, phone number, social security number, home address and the like in a customer search field 3084 and clicking a search button 3086.

Where the information about that customer is already stored in the system 10, the find a customer page 3080 may display a customer list 3088 of any search results containing matching customer data, and the user may select from the displayed search results by clicking an edit button 3090 next to a particular search result to retrieve any stored customer data. As illustrated, each customer listed in the customer list 3088 may include one or more stored data indication(s) 3092 indicating the type of stored customer data and/or where such data is stored within system 10.

For example, in one form, the indication may include the letters DMS to indicate there is stored customer information in the dealership management system. Likewise, the indication may include the letters “F&I” to indicate there is stored customer information in the desking system and/or finance payment calculation system. As noted above, accessing any stored customer data from prior transactions may help the salesperson in the current transaction.

For example, the salesperson may more quickly learn about the customer and thus need not spend time gaining background information. This is preferred in order to avoid prolonging the overall transaction which may cause the consumer to lose interest and result in a lost sale.

Alternatively, if the customer search does not return any matching customers, the user may select an add customer button 3094 to begin entering new customer data.

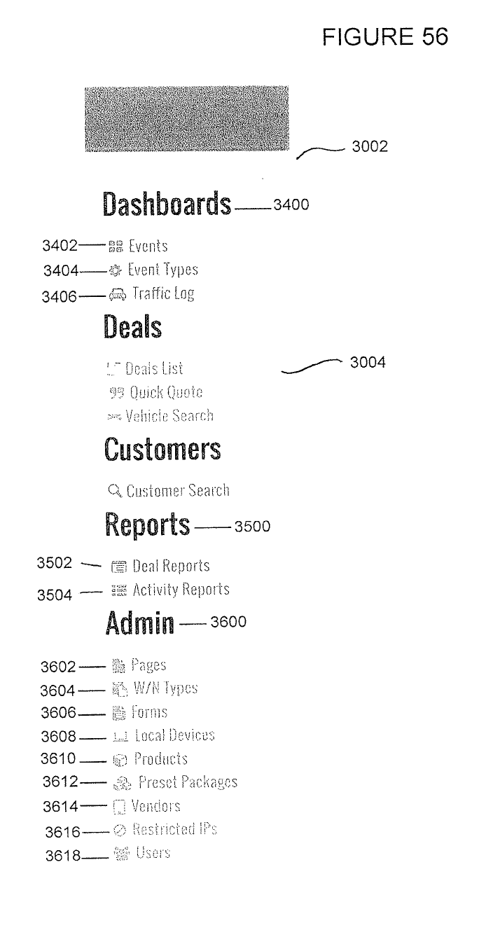

As shown in FIG. 63, upon selecting a certain search result, the user may access an edit customer page 3096 and edit any stored customer data items by making additions, deletions and/or revisions within a number of customer data fields, and saving the revised customer data to the database by clicking a save button 3098.

As illustrated, in one form, the edit customer page 3096 may also include begin button 3100 to proceed to the desking 200 feature of system 10 and return button 3104 to return to customer search page 3080.

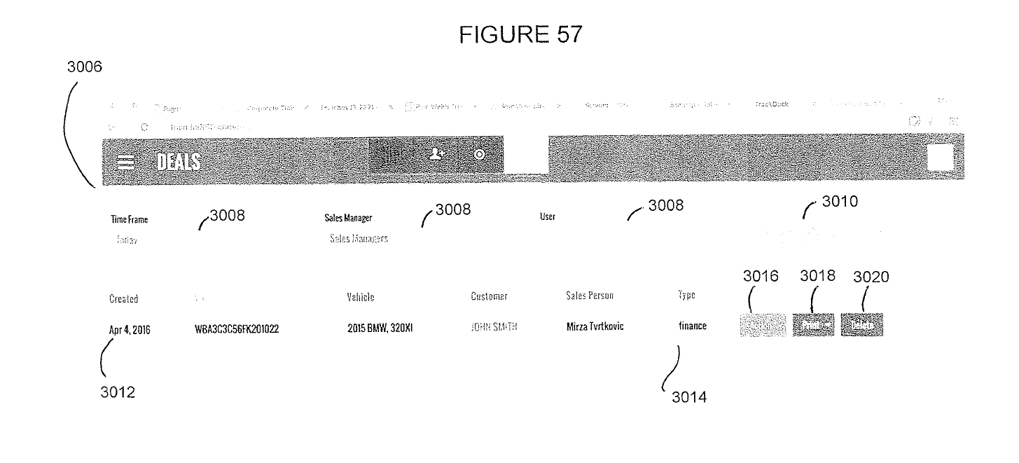

Additionally, edit customer page 3096 may include history button 3102 providing access to customer history page 3200 as illustrated in FIG. 64. As illustrated, customer history page 3200 may provide access to any stored customer data available in system 10. Thus, from a single customer history page 3200, the user may directly link to a plurality of customer data items stored in multiple places in the system 10. As discussed in more detail later, this storage of information within system 10, or with various third party services preferably allows the efficient and improved operation of a computer. That is, multiple, separate applications need not be accessed, or if they are accessed, system 10 efficiently interfaces therewith to avoid slowing the transaction.

In one form, the customer history page may itself display one or more items of customer data, for example, customer name, phone number, email address, and mailing address. Additionally, the customer history page 3200 may include one or more tabs for accessing stored customer data in system 10. In one form, the tabs may include, for example: notes 3202, deals 3204, wants and needs 3206, and test drives 3208.

By selecting notes 3202 tab, the user may access and/or view a list of notes entered by any user associated with the particular customer. The listing of notes may itself display the content of the note, or it may include a link to access the content of the note. The customer history page 3200 may include an add note field 3210 for allowing the user to add his/her own note to the listing.

By selecting deals 3204 tab, the user may access and/or view a listing of any deals the customer has started and/or completed. The listing may include links to access the deal data and/or any deal forms. This may allow a user to view any previously completed deals and any forms associated therewith. Additionally, as noted above, accessing any stored customer data from prior transactions (whether completed or not) may help the salesperson more efficiently complete the current transaction.

By selecting the wants and needs 3206 tab, the user may access any stored wants and needs analyses for the customer. By selecting test drives 3208 tab, the user may access and/or view a listing of any test drives the customer has had.

In another form, customer history page 3200 may include one or more additional tabs for accessing other stored customer data. The tabs may include, but need not be limited to a listing of forms that the customer has previously signed, with links to view to individual forms. In another form, the tabs may include a customer interaction flow, which may include information concerning, for example, the time spent with the customer on various aspects of the transaction, such as the wants and needs analysis, vehicle selection and so forth.

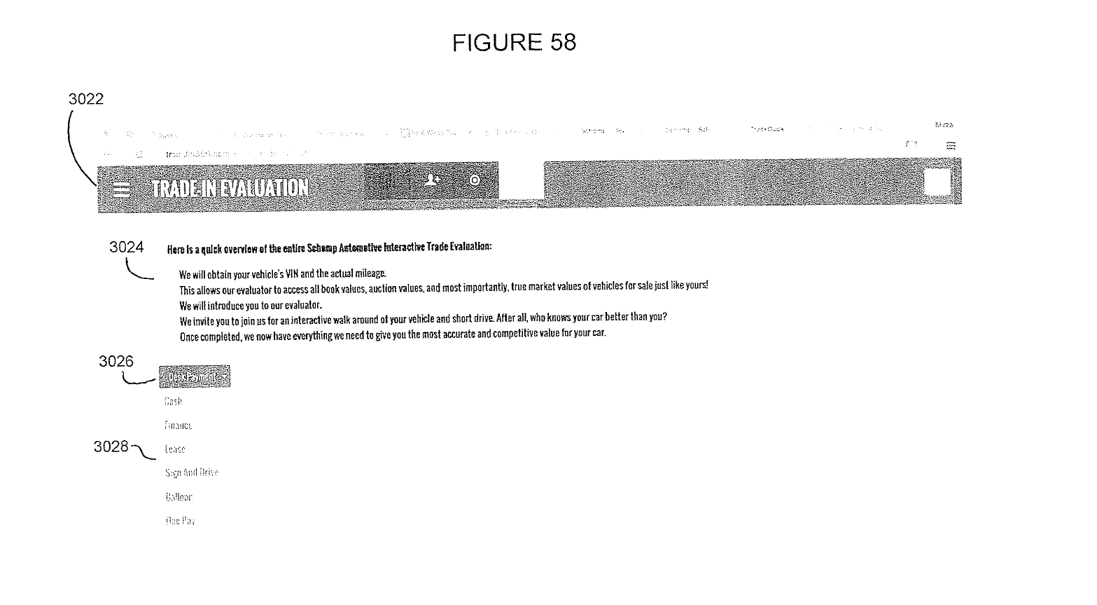

In another form, customer history page 3200 may provide access to any stored customer authorization for electronic signature. Alternatively, if the customer has not signed such an authorization for the current transaction, he or she may do so via a customer authorization for electronic signature page 3300 such as illustrated in FIG. 65. Using the customer authorization for electronic signature page 3300, the customer may provide authorization to sign one or more documents or forms for the transaction via electronic signature. The customer may select the forms that he/she wishes to sign electronically, which may include, for example, a base payment agreement, an agreement to provide insurance, a we owe you agreement, an affidavit representation trade in vehicle, an employee incentive program agreement or other forms. This may occur, for example, by the customer clicking a box associated with each form to display a check in the box and thereby consent to sign the document electronically.

The authorization for electronic signature page 3300 may also include an election to receive a copy of each electronically signed document by email and/or printed hardcopy.

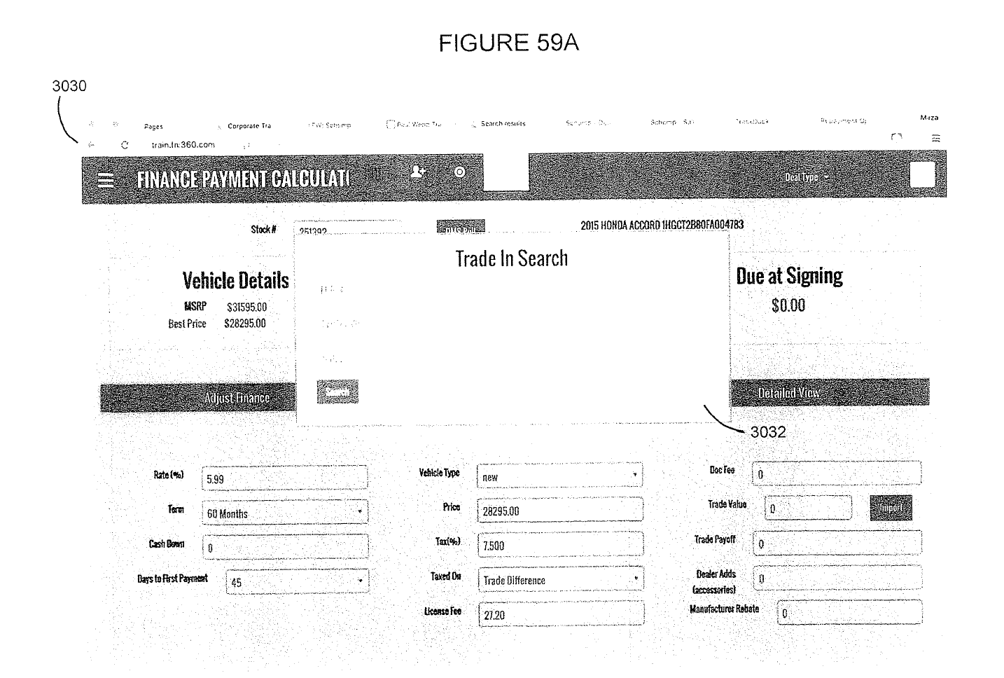

The customer may sign the authorization for electronic signature page 3300 in a number of ways. He or she may type in a signature, draw a signature using a mouse and/or enter a signature using a signature pad and stylus. FIGS. 66A and B illustrate exemplary signature capture pages.

The customer authorization for electronic signature page 3300 may preferably comply with the requirements of the E-SIGN Act and UETA as described above. Additionally, it may include a legal statement that the customer must acknowledge (e.g., by checking a box) by which the customer states he/she understands and acknowledges that the electronic signature constitutes a legal and binding signature.

In yet another form, the customer authorization for electronic signature page 3300 may include a two factor authentication. For example, the customer may be required to enter a cell phone number where he/she may receive an authentication code via text message. The customer may then enter the authentication code on the authorization for electronic signature page 3300 as confirmation of his/her authorization.

With reference again to FIG. 56, in one form, menu 3002 may include links to one or more additional features and/or functions of system 10, including for example, dashboards, reports and administrator functions.

As illustrated, in one form, the user may view and/or access one or more dashboards 3400. The dashboards 3400 may include, but not be limited to, an events dashboard 3402, an event type dashboard 3404, and/or a traffic log dashboard 3406.

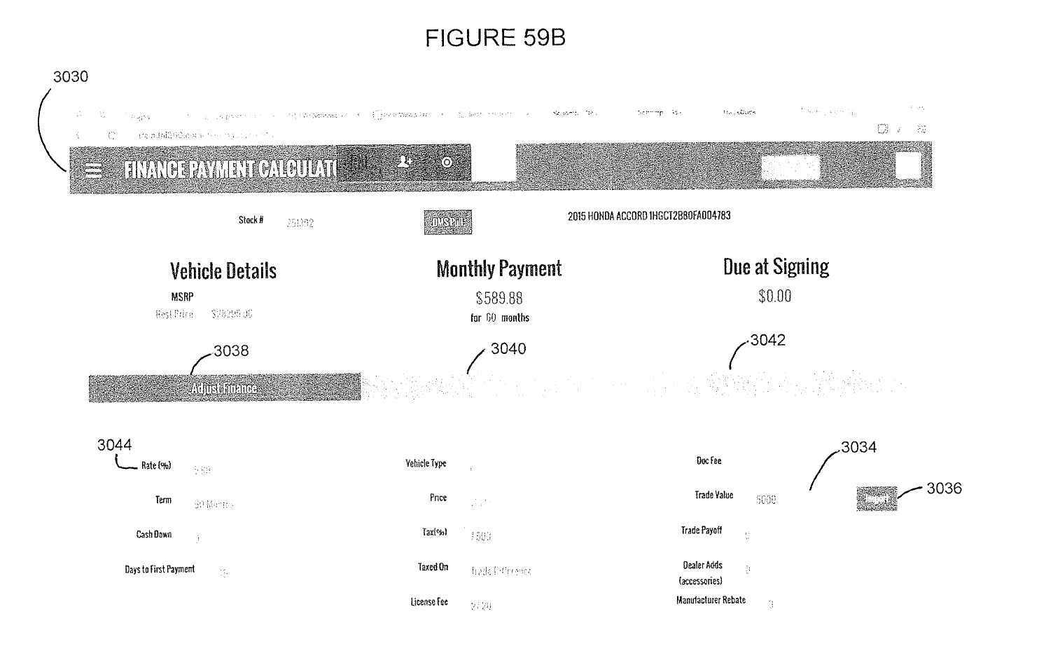

An events dashboard page 3408 is illustrated in FIG. 67. As illustrated, the events dashboard page 3408 may display a plurality of event buckets 3410 each corresponding to an event type or category. The event types may be customizable for the specific dealership or other end user. In one form, the event types may include, for example, customer analysis, trade, menuing, selection/test drive, desking and delivery.

Each event type may correspond to one or more steps in the process 2500 as illustrated in FIG. 39 and/or the process 2600 as illustrated in FIGS. 40A-C. Thus, users who are currently engaged with a customer in a process 2500 and/or 2600 are listed in a user list 3412 in an event bucket 3410 based on their current status. Thus, for example, a user engaged with a customer in a wants and needs analysis may be listed in a user list 3412 of the customer analysis bucket 3410. Another user who is currently engaged with a customer in a finance payment calculation may be displayed in the user list 3412 within the desking bucket 3410. As the user proceeds through the process 2500 or 2600 with the customer, the user is moved to the appropriate bucket 3410.

The event dashboard page 3408 may include one or more filters for filtering the user lists 3412 displayed in each event bucket 3410. For example, in one form, the event dashboard page may include filters for dealership, manager, user, and combinations thereof.

A user may select one of the specific event buckets 3410 from the events dashboard page 3408 to view an event type page 3414 for that event type. Alternatively, from the menu 3002, the user may select event type dashboard 3404 to bypass the events dashboard page 3408 and pull up a specific event type page 3414 (for example, desking, delivery, etc.).

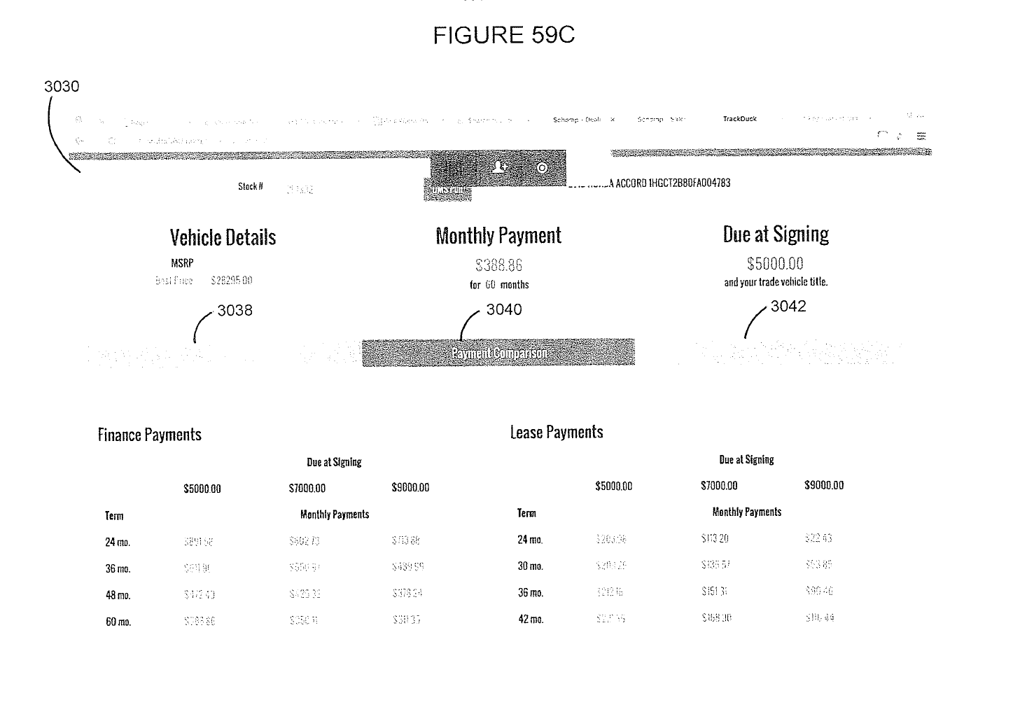

FIG. 68 illustrates an event type page 3414 for the desking event. Event type page 3414 may include the user list 3412 showing each user in that event bucket 3410.

As illustrated, each item listed in the user list 3412 may display a plurality of data items relative to the pending transaction. This may include, for example, customer data, vehicle data, deal structuring data, data about the status of the transaction (for example, the event bucket and the time spent in that bucket).

Thus, in one form, each item in the user list 3412 may display, for example, the customer name and the user name. Additionally, it may include a plurality of icons corresponding to additional data items. For example, it may include an event type icon 3416 to indicate the current event type. It may include a workstation icon 3417 such as a laptop or other suitable icon to identify the specific workstation at which the user is engaged with the customer. This preferably makes it easier for a manager to locate the user and do a manager “flyby” as discussed above. This is another example where the software of the current invention effects a physical step, i.e., by identifying the physical location to which the manager may proceed.

A car icon 3418 or other suitable icon may be used to identify the stock number of the specific vehicle that is involved in that step of the process (e.g., test drive, base payment calculation and the like). A % icon 3420 or other suitable icon may be used to indicate the base rate, qualified rate or chosen rate depending on the step in the process in which the user is. A clock icon 3422 or other suitable icon may be used to indicate the base term, qualified term or chosen term depending on the part of the process in which the user is. As illustrated, the information displayed in connection with each icon will vary based on the stage in the process.

A manager action button 3424 may provide notification of the status (for example, manager flyby or base payment huddle) and prompt a manager to become involved in the transaction as needed. By clicking the manager action button 3424, a time stamp and user identification is recorded and pushed to any screens displaying the event dashboard page 3408 or the event type page 3414 thereby prompting manager to take physical action.

A time stamp indicator 3426 may indicate the date and time. It may also include a customizable color coding to indicate the amount of time the user has spent on the event relative to the preselected maximum desired amount of for that event. Thus, in one form, the time stamp indicator 3426 may be one color (for example, white) to indicate that the user has currently spent less than 80% of the maximum desired amount of time on that event. The time stamp indicator may change to a second color (for example, yellow) to indicated the user that currently spent 80%-99% of maximum desired time for that event. The time stamp indicator may change to a third color (for example, red) to indicate the user has spent 100% or more of the maximum desired time for that event. These color-coded indications provide a physical (visual) cue to the user or manager.

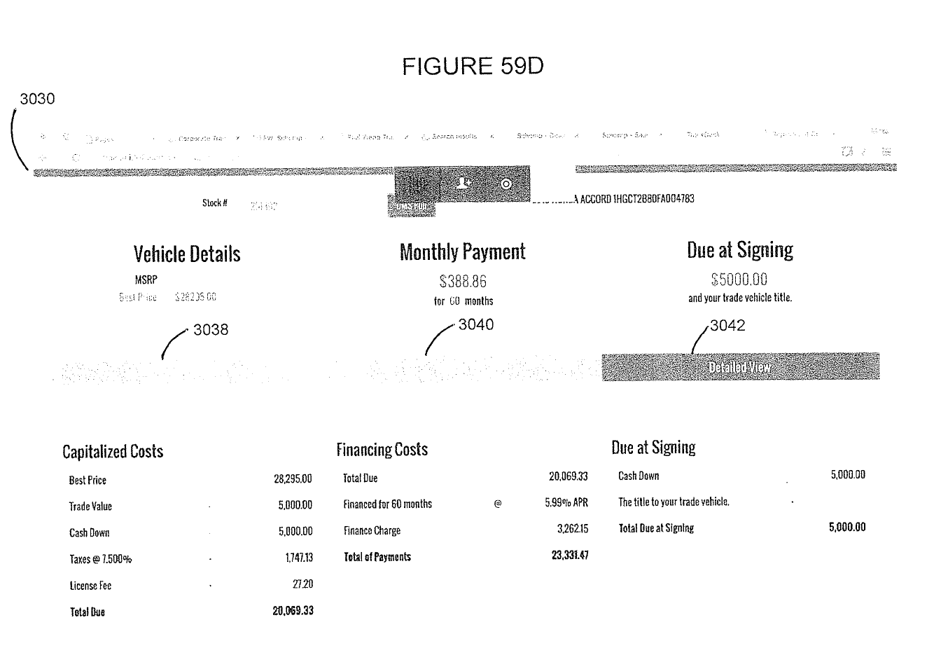

In another form, one or more event type page(s) 3414 may include additional buttons (for example, a more info” button) to access additional information on the transaction. When clicked, the more info button may display real time information based on the customer interaction. This may include for example, pulling up the wants and needs analysis overview as illustrated in FIG. 69, deal structure information, profit and loss information and other information.

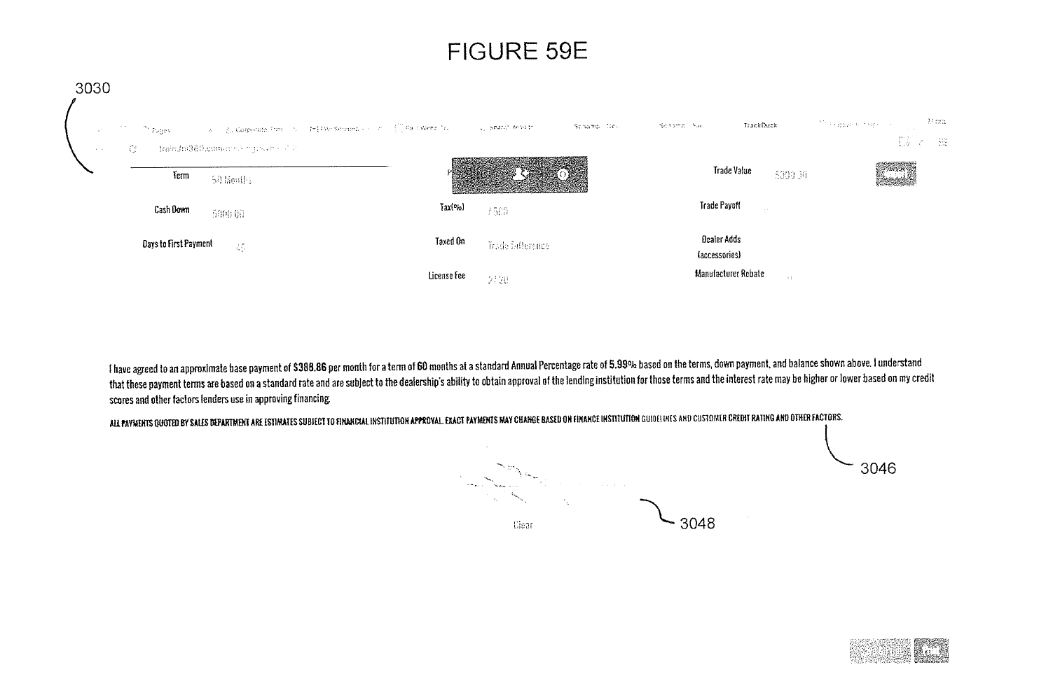

By selecting traffic log dashboard 3406 from menu 3002, the user may access traffic log page 3430, as illustrated, for example, in FIG. 70. Traffic log page 3430 may display the number of customer interactions during the indicated time periods, for example, the current day, the last 7 days, the current month, the last month or some other time. The traffic log page 3430 may also display a list of customer interactions 3432 during the selected time period. The list of customer interactions may be filtered using a number of variables, including for example, time period, dealership, user and combinations thereof. The list of customer interactions may display information about the customer interaction, including, for example, the customer name, the dealership, the date of the interaction and the last event type. It may also include link 3434 to the customer history page for that particular customer.

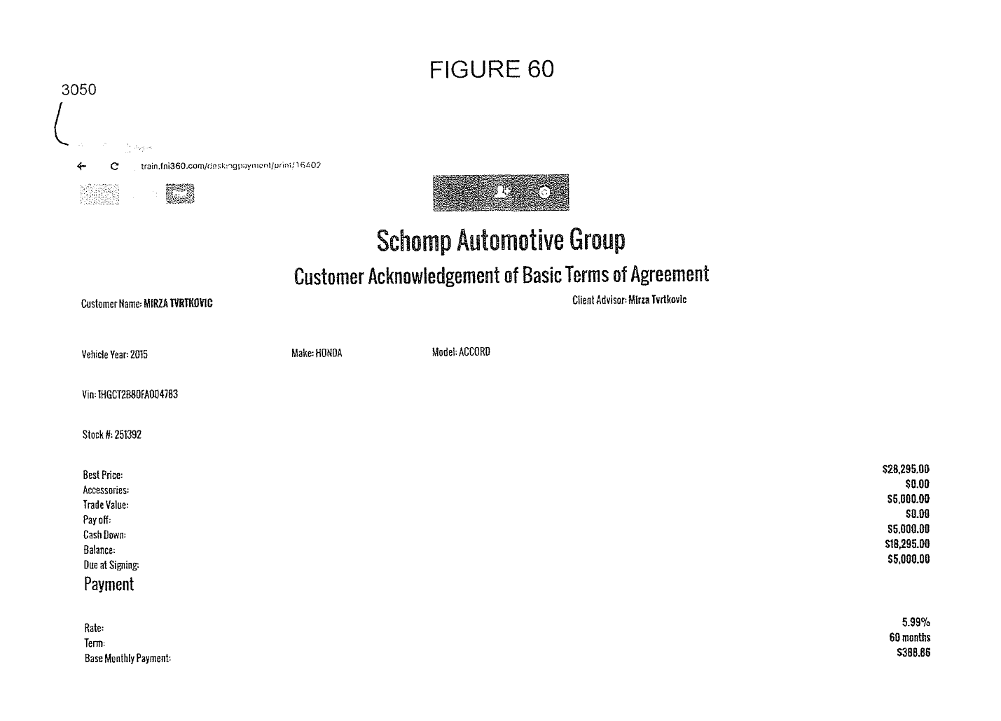

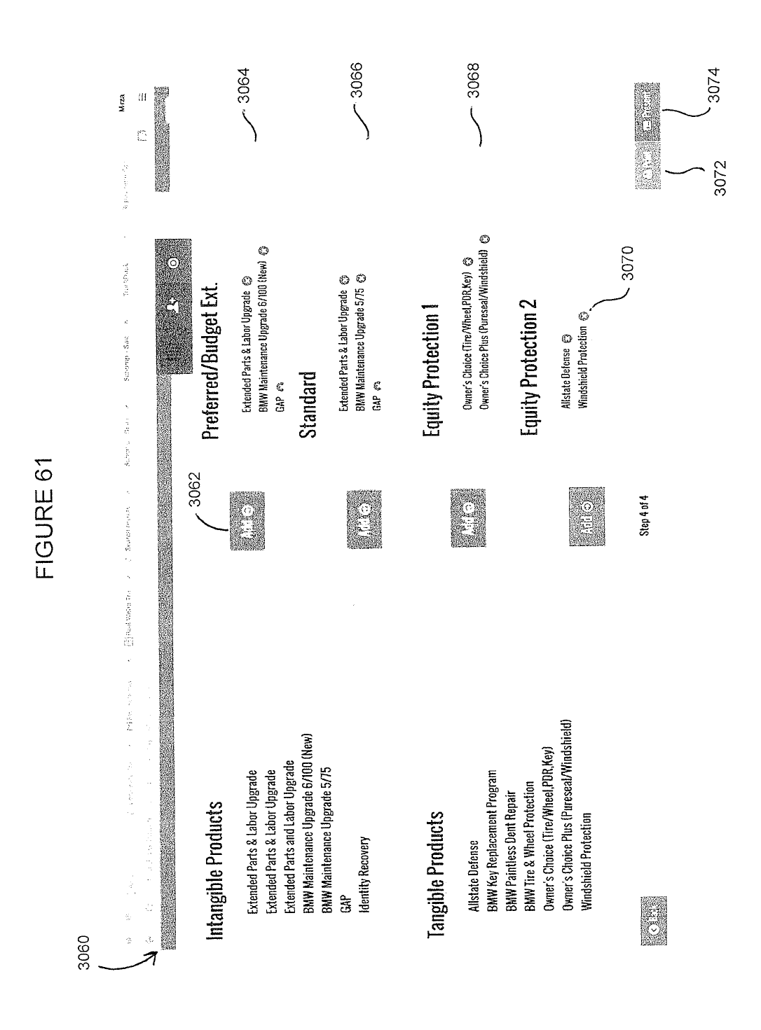

With reference again to FIG. 56, in another aspect, menu 3002 may allow the user to view and/or access various reports 3500, including for example, deal reports 3502 and/or activity reports 3504. Exemplary deal report pages 3506 are illustrated in FIGS. 71 and 72. As illustrated, the deal report pages 3504 may display a list of transactions which may be filtered by several variables, including for example, time frame, sales manager, user and combinations thereof. The list of deals may display for each transaction, deal information, including for example, date created, VIN, vehicle make/model/year, customer name, sales person, type of deal and the like.

In another form, the report pages may include a customizable color scheme or theme configured for the dealership and/or for the manufacturer. This is another example of a physical (visual) aspect of the current invention.

In still another form, menu 3002 may allow the user to view and/or access one or more system administration features and/or functions 3600, including for example, administration pages 3602, W/N types 3604, electronic forms 3606, local devices 3608, products 3610, preset packages 3612, vendors 3614, restricted IPs 3616 and/or users 3618.

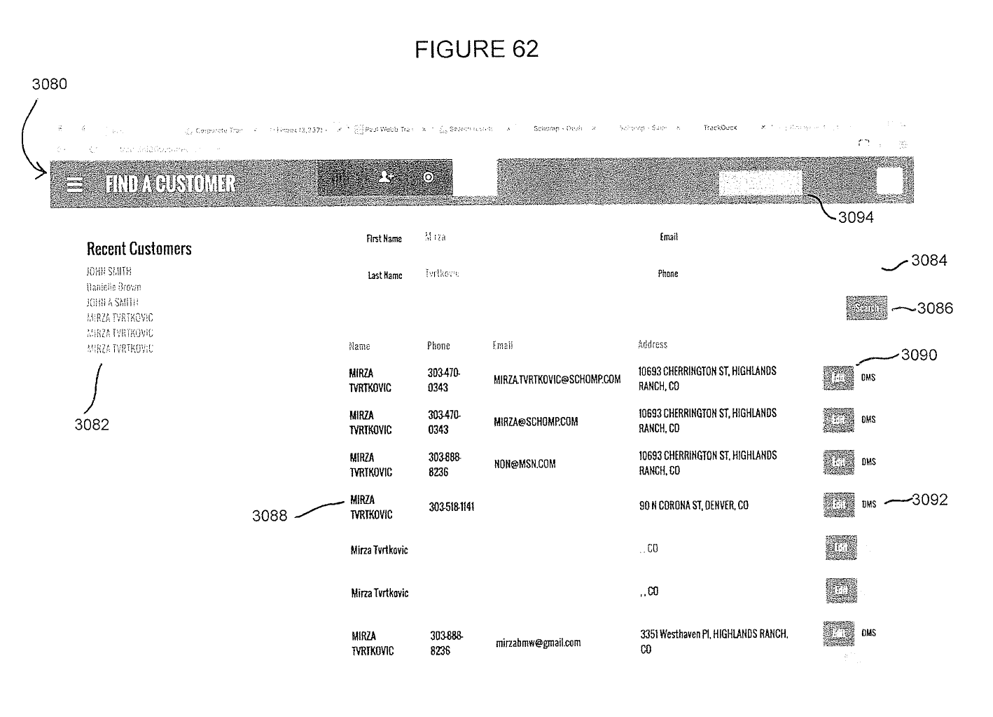

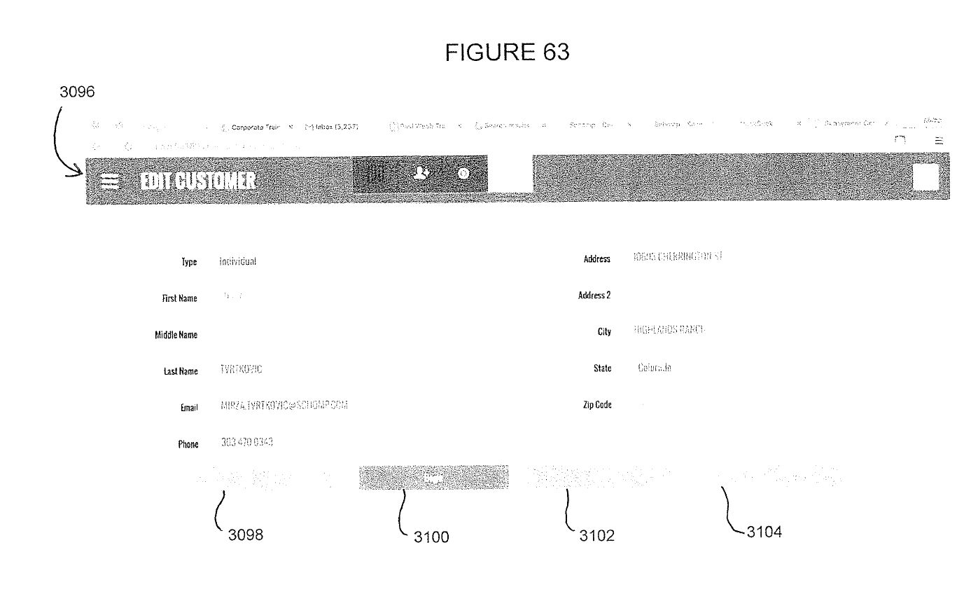

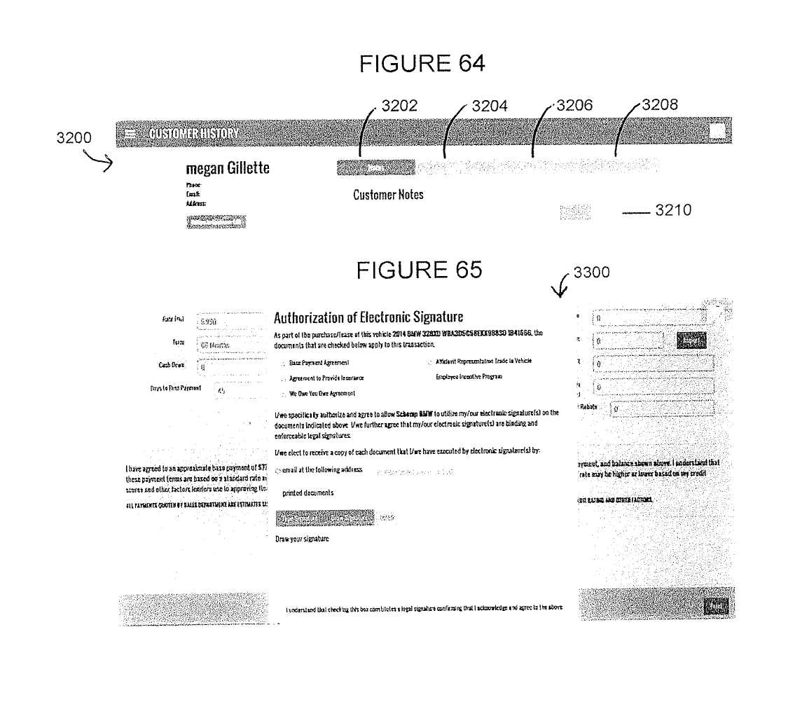

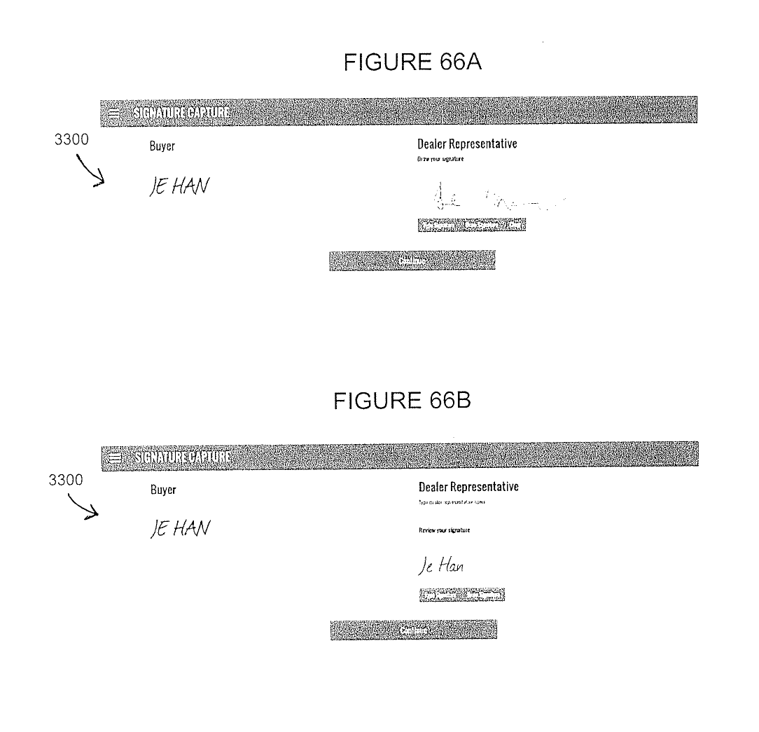

In one aspect, the user may select the electronic forms 3606 feature to access an electronic forms configuration feature 3620. The user may thereby configure electronic forms in a number of ways. In one form, the user may import existing PDF templates as illustrated in FIG. 73. In another from, the user may map fields to existing data/logic for automatic population into a form as illustrated in FIG. 74. In another from, the user may configure a form base on vehicle type, dealership and/or deal type as illustrated in FIG. 75. In another form, the user may preview and/or access existing file templates as illustrated in FIG. 76.

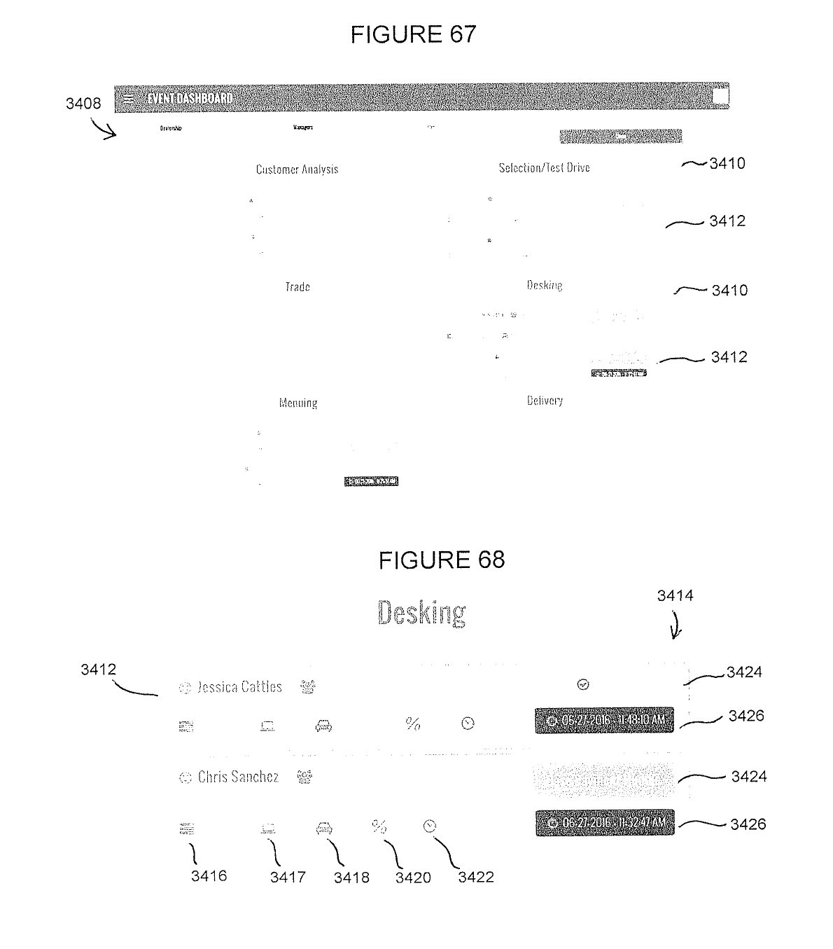

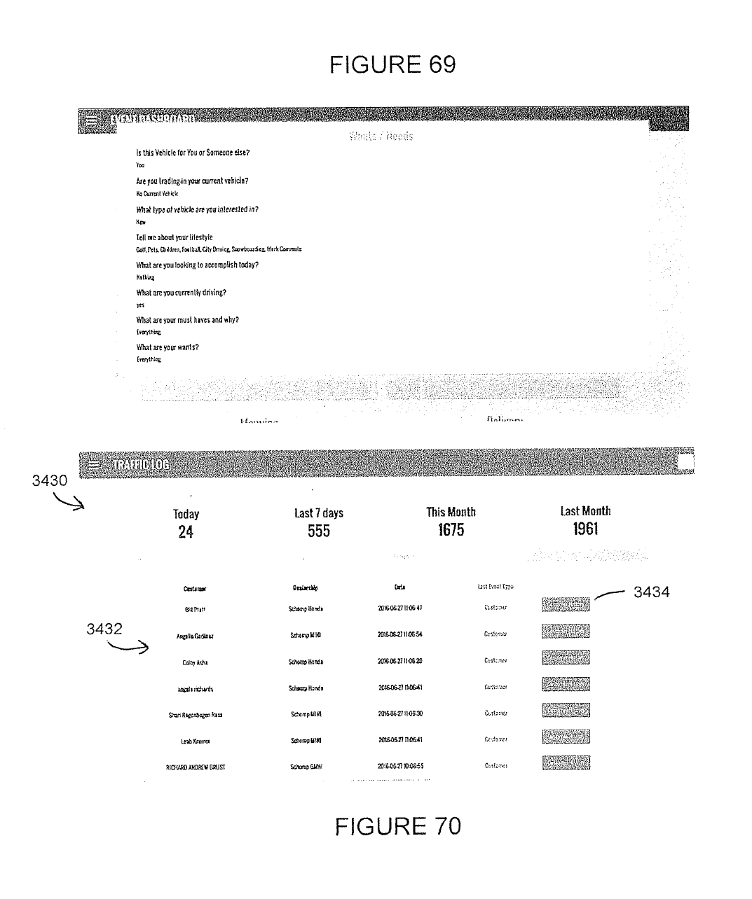

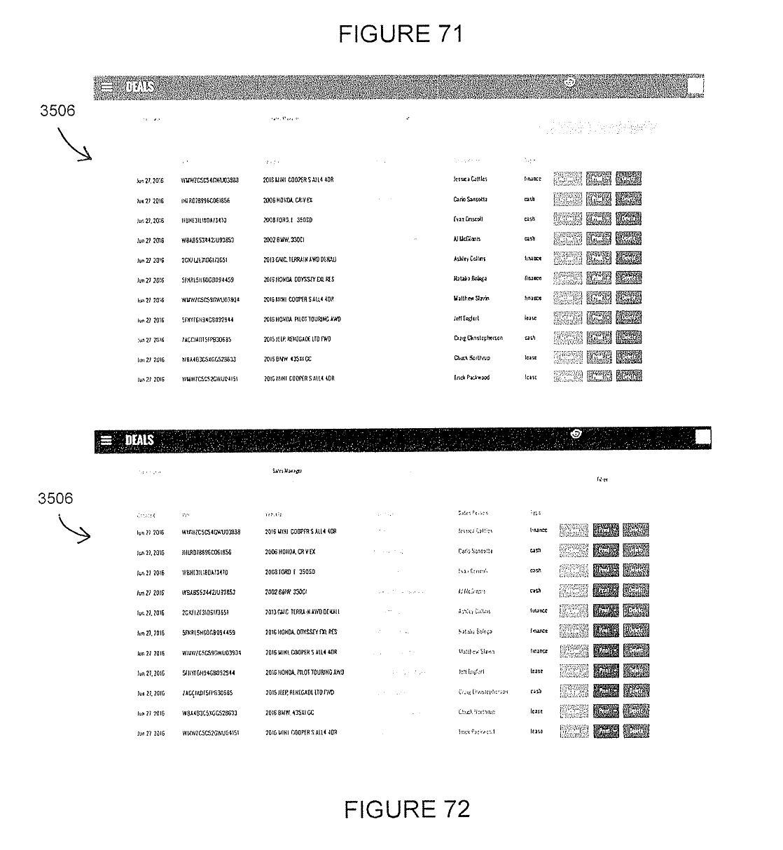

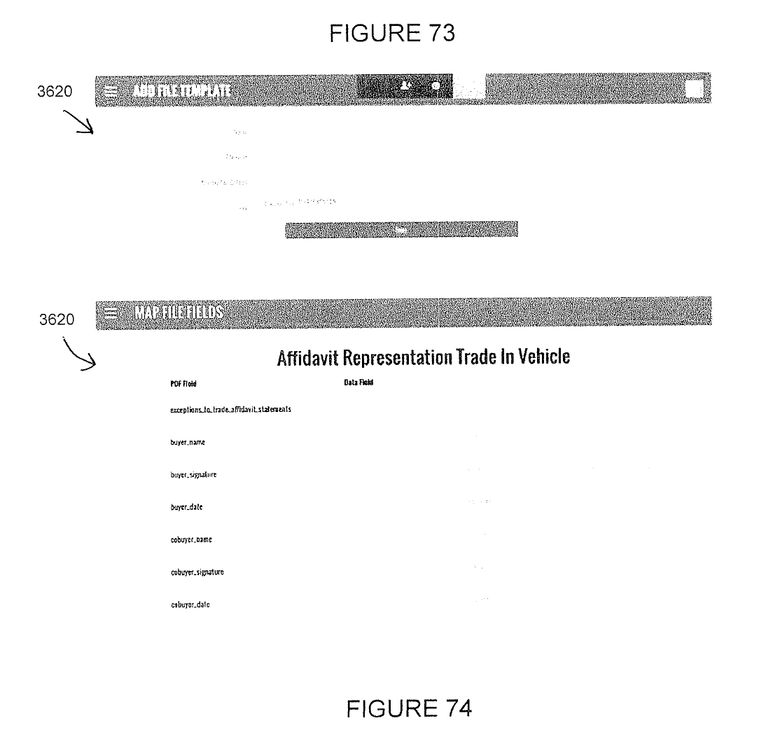

In another aspect, the user may select the electronic forms 3606 feature to access an electronic forms presentation feature 3622 as illustrated in FIGS. 77-80. In one form, illustrated in FIG. 77, the electronic forms presentation feature 3622 may include auto population of one or more form fields based on previous form configuration or other information stored by system 10. In another from, as illustrated in FIG. 78, the user may manually enter form fields that are not automatically populated. As illustrated in FIGS. 79-80, the electronic forms presentation feature 3622 may also include live document presentation and electronic signing. Electronic documents may be signed and stored in compliance with the E-SIGN Act, UETA and/or other pertinent regulations as discussed above.

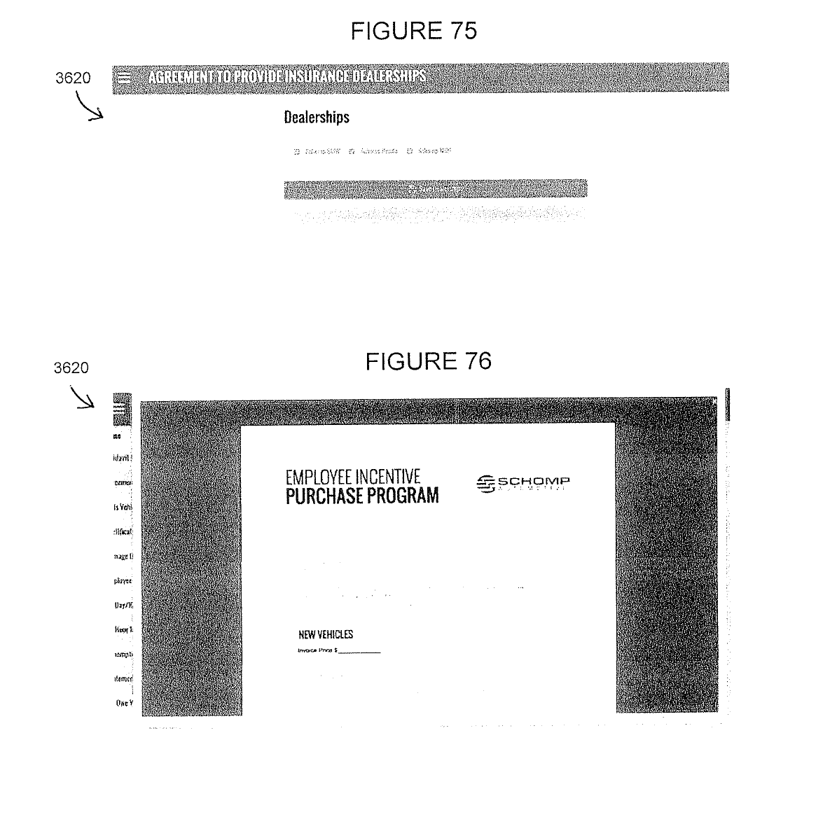

In another aspect, the user may view and/or access a roles and permissions function 3630 as illustrated in FIGS. 81-83. In one form, roles and permissions function 3630 may include permissions page 3632 whereby the user may assign user permissions (for example, to allow or restrict access to certain features) based on designated user roles as illustrated in FIG. 81. In one form, this may include, for example, user role categories 3634 such as admin, dealership admin, dealership business manager, dealership sales manager, dealership sales person, and super admin. Assignable permissions 3636 for each user role may include, for example, manage customers, manage dealerships, manage deals, manage product types, manage products, manage uses, manage vehicles, manage vendors and/or manage warranties. As illustrated, for each user role category 3634, the user may click a box next to each of the assignable permissions to be granted to that user role category.

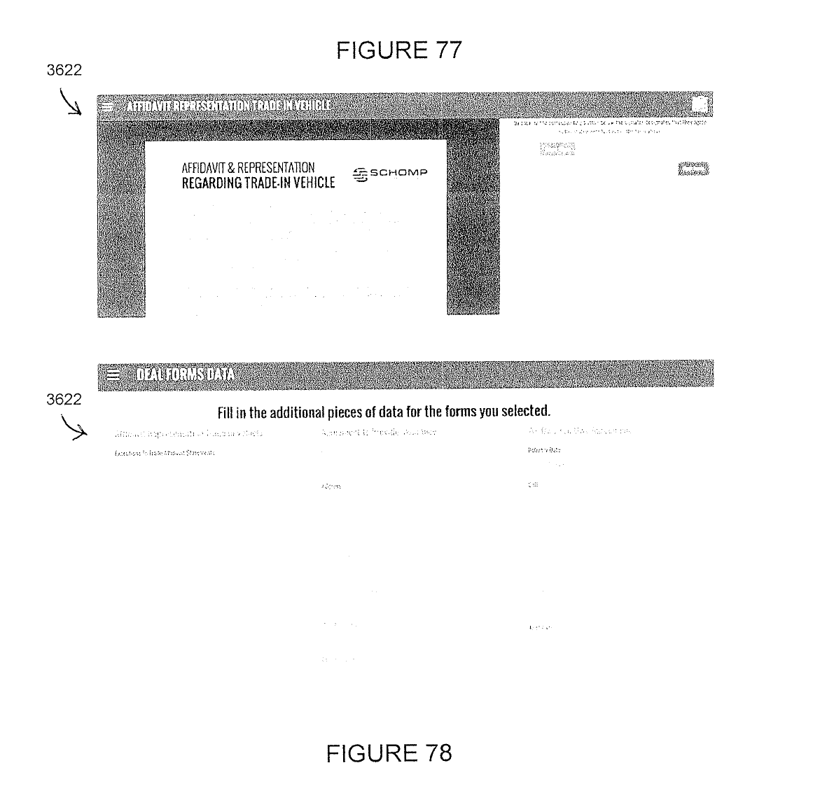

As illustrated in FIG. 82, in another form, the roles and permissions function 3630 may include an assigned roles page 3640 for each individual user. Using assigned roles page 3640, a user may assign one or more user roles 3634 and the associated permissions 3636 to each user.

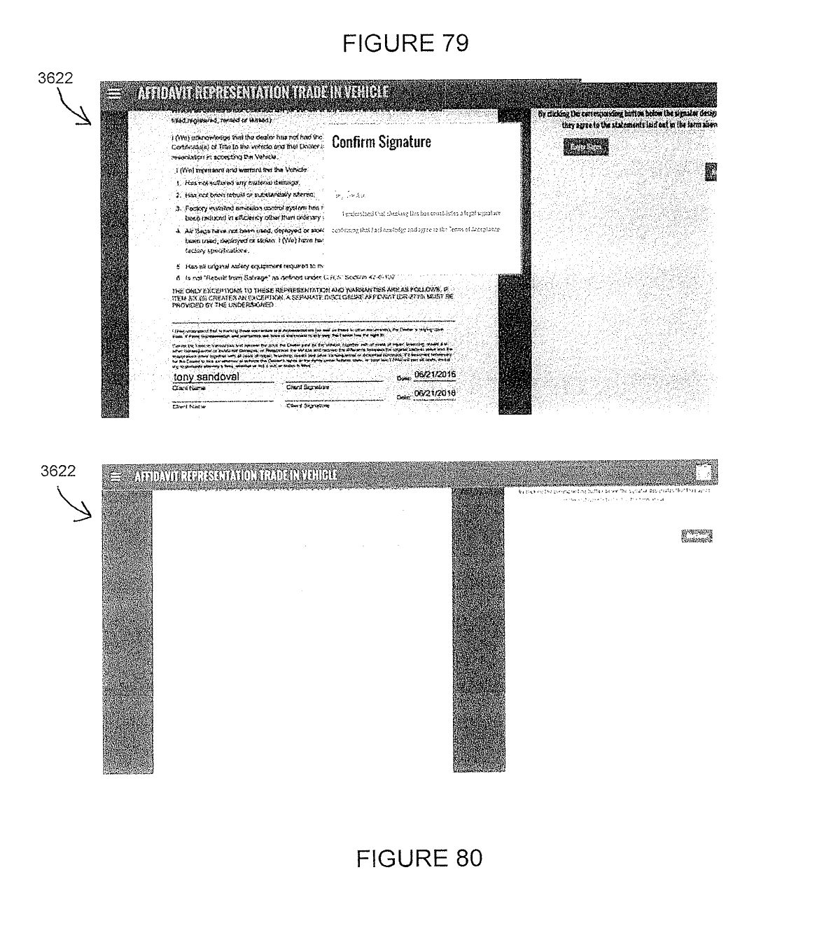

As illustrated in FIG. 83, in yet another form, the roles and permissions function 3630 may include the ability to assign individual permissions to specific users or groups of users, separate from the permissions granted based on the designated user roles.

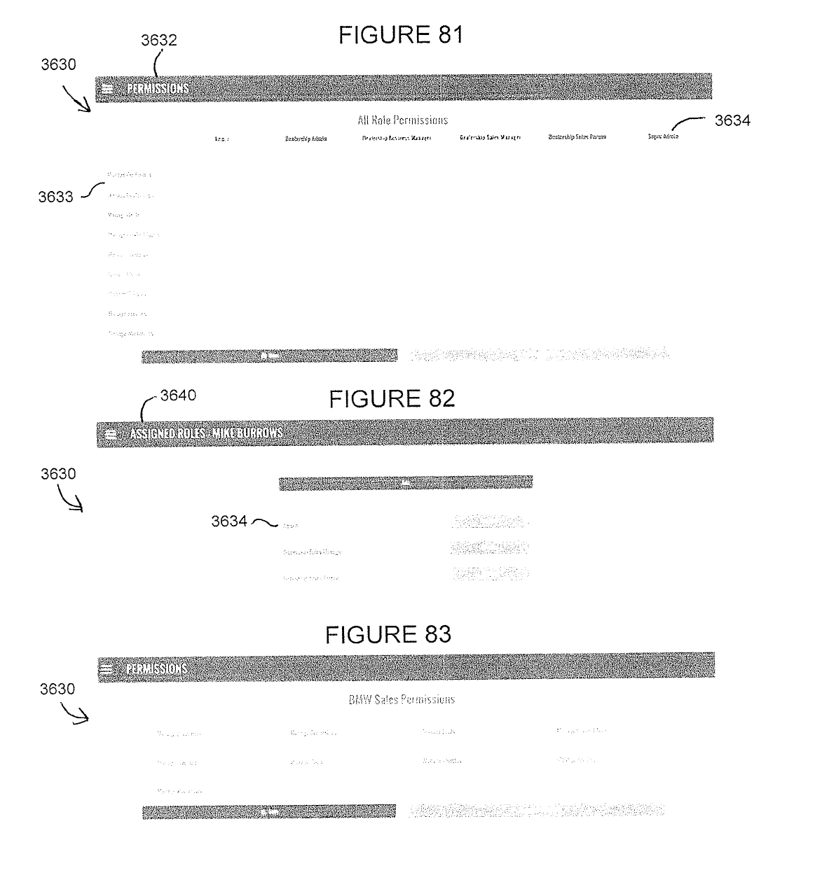

In accordance with another aspect, FIG. 84 illustrates an exemplary residual rate configuration page 3650. Using the residual rate configuration page 3650, a user may add, edit, and/or delete residual percentages based on vehicle model code and lease term length. The residual rates may be used to automatically populate rates for selected vehicles across various features of system 10, for example, the finance payment calculator. As illustrated in FIG. 84, the residual rate configuration page 3650 may include an option to mass import residual rates via csv file or the like.

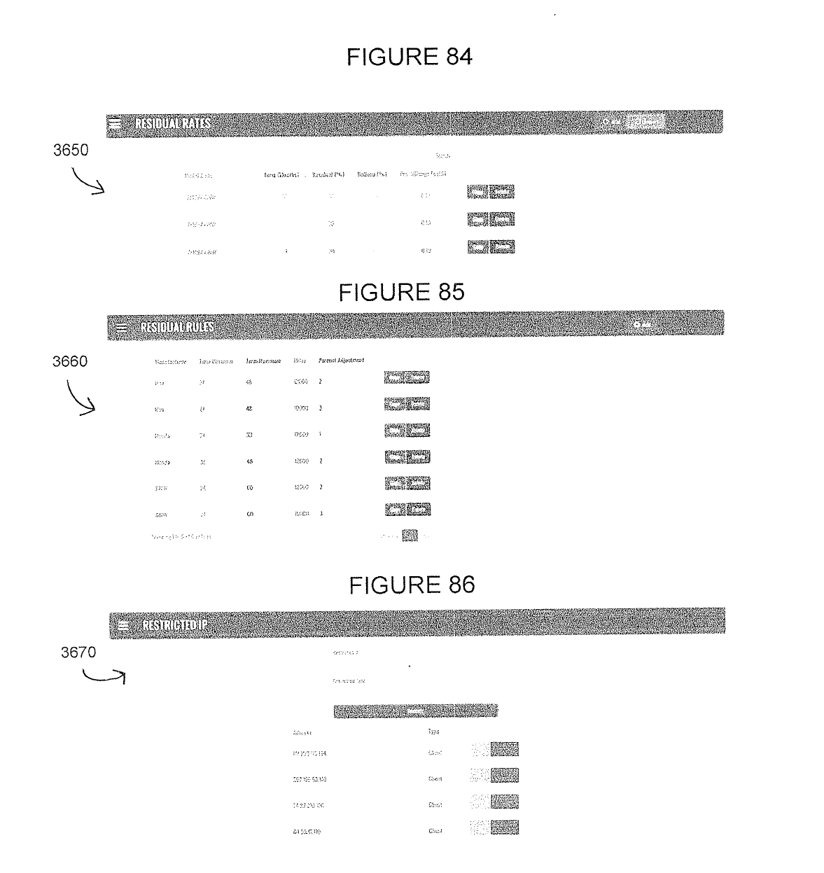

As illustrated in FIG. 85, a residual rules page 3660 may permit a user to set automatic residual rate adjustment rules based on, for example, vehicle manufacturer, lease term, and lease miles per year.

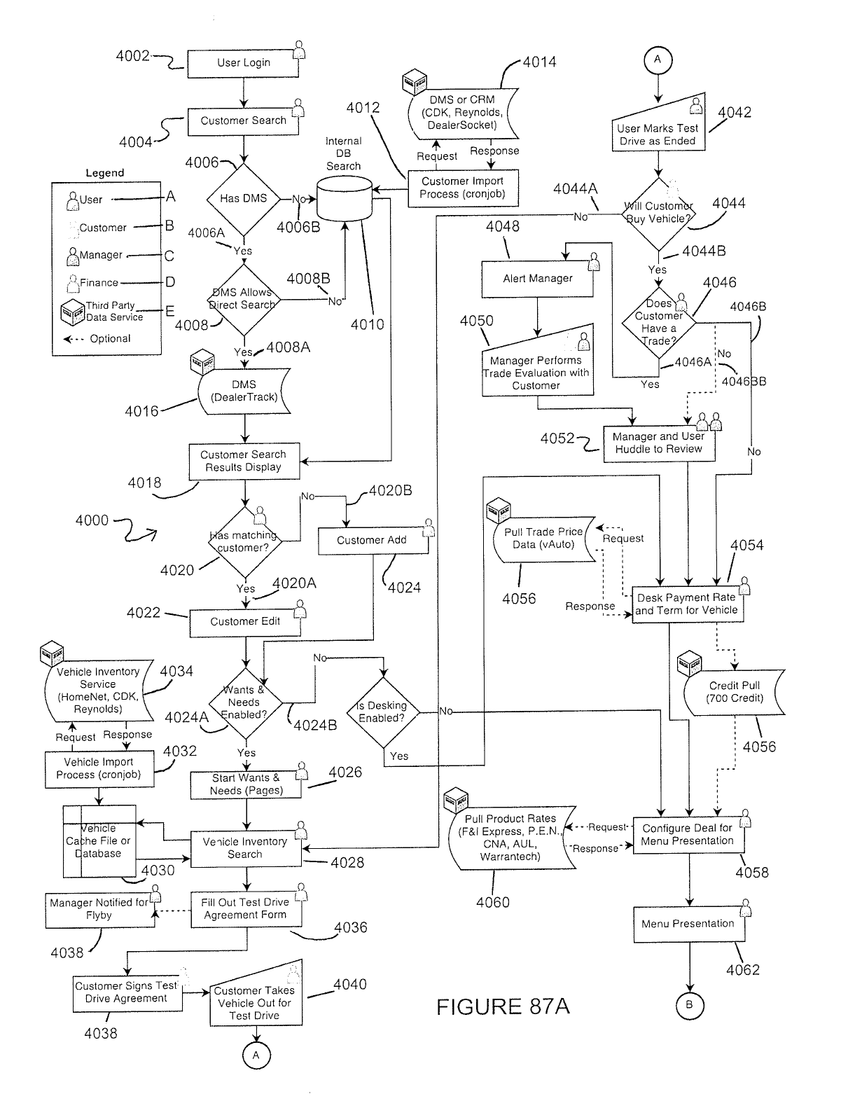

In accordance with yet another aspect, a restricted IP page 3670 as illustrated in FIG. 86, for example, may permit a user to restrict user access to specific IP addresses. For example, this may be used to prevent a user, for example, a sales person, from accessing the system and/or certain features thereof, from an offsite or unrecognized IP address.

The manner in which the computer application of the current invention may operate, the manner in which it improves the operation of a computer, and the structure of the computer system of the current invention are now further described with reference to FIGS. 87A, 87B and 88. As shown in FIGS. 87A-87B, computer application 4000 may include various software modules to perform numerous tasks involving different participants. The tasks and participants may be as described above, but the structural relationships between these modules and tasks are now further described.

It is preferred that various tasks may be performed by application 4000 without the need to access another application. Alternatively, application 4000 may be integrated with other applications so that tasks involving these other applications may be seamlessly or efficiently performed to avoid slowing the transaction. As a further alternative, application 4000 may exist so that other applications may be integrated later on. In this manner, the application 4000 of the current invention improves the operation and efficiency of a computer system. This is important in certain transactions, such as a vehicle sale or lease, because the more time it takes to complete the transaction, the more likely a customer will become dissatisfied and fail to complete the transaction.

The participants involved with application 4000 may include user A (such as a salesperson), customer B, manager C (such as a sales manager) and finance representative D (which may be an individual that the customer B deals with in person, or may also be represented by the presentation of financial information). It is also preferred that customer B primarily deal with user A, and that the involvement of manager C be on an as-needed basis to avoid overwhelming customer B and/or otherwise slowing the transaction down. In any event, application 4000 provides for the one-on-one customer attention that facilitates completing the transaction.

Application 4000 may begin with a user log-in/customer search module. As shown, user A may log-in 4002 to application 4000 and perform customer search 4004. At this point, application 4000 may query 4006 whether a dealer management system (DMS) is used in connection with application 4000. (As noted earlier, a DMS may generally include customer and other types of information regarding the transaction.) If so, as in step 4006A, application 4000 may then query 4008 whether the DMS allows a direct customer search. If not, as in step 4008B, or if application 4000 does not include a DMS as in step 4006B, internal database 4010 may be searched for customer information.

That application 4000 may include database 4010 with customer information is an example of how the current invention avoids the need for accessing another application to obtain this information. Alternatively, application 4000 may be integrated with customer import process (cronjob) 4012, which may in turn access an independent DMS or CRM (customer relationship management) application 4014. As shown, customer import process 4012 may involve a request to DMS/CRM 4014 and a response. This customer information may then be saved to the internal database 4010 for later reference. Over time, internal database 4010 may house a wealth of customer information which preferably increases efficiency in performing various steps of the transaction.

If DMS 4008 does allow direct searches as in step 4008A, a third party DMS data service 4016 may be queried to obtain the customer information. The customer information from DMS data service 4016 or from internal database 4010 may then be displayed 4018 so that user A may see if customer B matches 4020 with information already in the system (whether internally in application 4000 or in a third party database). If so, as in step 4020A, user A may determine whether the stored customer information is accurate or sufficient and may edit 4022 information as need be. If not, as in step 4020B, user A may add customer B as in step 4024. To this end, application 4000 may create a new ID for customer B and store that information.

At this point, application 4000 may continue with a customer wants and needs module. If this module is not enabled as in step 4024B or is otherwise not desired, such as where customer B knows exactly which vehicle he or she wants, this module may be skipped and other tasks performed as described below. If this module is enabled as in step 4024A, user A may perform the wants and needs analysis 4026 and gather information about the customer and the desired vehicle as described earlier.

The inclusion of the wants and needs module in application 4000 represents another example where the current invention improves the operation of a computer. That is, prior to the current invention, a customer's wants and needs, if addressed at all, would typically comprise a series of questions from a salesperson to a customer; where the answers may be recorded or not. Any recording of answers would typically occur by hand, and even where this occurred, such answers were not logged into any type of system for future reference. And if some type of electronic system was used to record such answers, this still would have involved another application which would have to be accessed, thereby slowing down the transaction and/or would not have been integrated with other information when performing a transaction.

With the current invention, however, the wants and needs module serves to record useful information in an efficient manner, within application 4000, without the time-consuming need to write information by hand or access another application. Furthermore, the information collected by the wants and needs module may then be integrated with other modules of application 4000 to effectively use such information to help select a vehicle as now described.

Application 4000 may then proceed with a vehicle inventory search module where the dealer's inventory is searched 4028 to determine whether the desired vehicle, or other suitable vehicle, is available. To this end, application 4000 may include an internal vehicle cache file or database 4030 containing information on the available vehicles. Alternatively, application 4000 may interface with a vehicle import process (cronjob) 4032, which may in turn access a third party vehicle inventory service 4034 through requests and responses. However, even if such a third party service is used, it is preferred that application 4000 seamlessly engages this service to avoid slowing down the flow of the transaction.

This inclusion of the vehicle inventory search module within application 4000 represents yet another example of how application 4000 improves the operation of a computer. That is, separate applications or inventory search tools need not be accessed thereby avoiding waste of time.

Furthermore, when it comes time to search inventory in other existing systems, the salesman will typically search the dealer's website. However, this poses problems. For example, such salesman searches will skew analytics that may be measured by the dealer's website. That is, a salesman search will generally be counted as a prospective customer search when in fact it is not. As such, analytics which measure the traffic visiting the site will be inaccurate. And this inaccuracy can be significant assuming that many salespeople are accessing the dealer's site to see if a car is available.

Application 4000 may then proceed with a test drive initiation module. When this module is initiated, application 4000 may alert another part of the dealership that the desired car should be readied and brought up to the showroom for a test drive. Application 4000 may also notify manager C to drop by and chat with customer B. This application may also use information gathered from the wants and needs analysis about the customers driving style and plan a test drive route accordingly. As such, application 4000 may effect various physical steps and activity. The test drive initiation module may also include filling out of a test drive agreement form 4036. As described earlier, this form may be prepopulated with customer information that has already been gathered by application 4000.

Application 4000 may then proceed with a customer signature module where customer B signs the agreement electronically as in step 4038. Hardcopies of this agreement may in any event be readily provided. As these modules are completed, the vehicle may be awaiting user A and customer B to go on a test drive 4040.

At the conclusion of the test drive, application 4000 may then proceed with a module which marks the test drive as ended 4042. At this point, user A may log in the miles driven during the test drive, the route taken and any other information that may be relevant to customer B. Such information may be stored in database 4010 for future reference.

At this point, customer B may be asked whether he or she wants to actually buy or lease the vehicle 4044. If the answer is “no” as in step 4044A, application 4000 may initiate another vehicle inventor search 4028 if appropriate. Alternatively, aspects of the wants and needs analysis may be performed again to make sure the user/salesperson has the customer's thinking correct. As another alternative, the wants and needs analysis may be performed for the first time if not done already.

If the answer is “yes” as in step 4044B, application 4000 may proceed with a vehicle trade-in module. This module may begin with query 4046 regarding whether customer B has a trade-in to consider. If so, as in step 4046A, application 4000 may again alert manager C as in step 4048 to become involved and perform a trade-in evaluation with customer B. As such, application 4000 may effect another physical event. At this point, user B and manager C may confer and review 4052 the trade-in information and make an initial determination whether the trade-in is worth pursuing.

Application 4000 may then proceed with a desking module in which price and other terms may be calculated 4054 as described earlier. Where a trade-in is at issue, the desking module may also include determining trade-in valuation step 4056. Alternatively, trade-in valuation step 4056 may have been performed by application 4000 earlier in the transaction.

As shown, trade-in valuation step 4056 may involve interfacing with a third party service, such as V Auto, which provides trade-in information for similarly classified vehicles that have been recently traded in within that region, across the US or according to some other criteria. In addition, application 4000 may maintain an internal database with trade-in information. But where a third party service is used, application 4000 preferably interfaces with such service in a seamless or otherwise efficient manner so as to not slow down the transaction. This is another example of how the current invention improves the operation of a computer in that V Auto or some other third party trade-in service need not be separately accessed.

In any event, the desking module may then proceed as described earlier to arrive at financing and other terms. This module may include credit pull 1056 to determine whether customer B is qualified for the proposed finance terms. To this end, application 4000 may interface with a credit check service to quickly provide a credit pull. A finance representative D may be involved with this module. In any event, application 4000 again avoids the need to access a separate credit check application.

Application 4000 may then proceed with a deal configuration module including presentation 4058 where items such as finance terms, insurance, accessories, and other items such as warranty plans, GAP and other add-ons may be presented. This deal configuration presentation may include accessing a third party service 4060 to obtain interest rates, warranty terms and other items relevant to the deal configuration. As with the other third party services engaged by application 4000, it is preferred that such accessing occur seamlessly or efficiently. This again avoids the time-wasting need to access a separate application.

This module may then proceed with user A making a menu presentation 4062. As discussed earlier, the current invention includes the feature where different combinations of add-ons may be readily evaluated by the drag and drop feature described earlier. Referring now to FIG. 87B, the deal configuration module may conclude with customer B signing the mandatory disclosure form 4064 thereby confirming that user A has presented all the information to customer B as required by pertinent laws and regulations.

Application 4000 may continue with a forms module during which customer B executes various forms to consummate the transaction. User A may begin the forms process 4066 by selecting the forms to fill in 4068 and filling in the pertinent fields 4070 in the forms. Alternatively, manager C may select forms to pre-fill 4068A and pre-fills form fields 4070A to further increase the efficiency of the transaction. Furthermore, the forms may be prepopulated with information previously collected by application 4000. A finance representative D may also be involved with this module.

The filled-out forms may then be saved to a cloud or other storage 4072 which is easily accessible by application 4000. Signatures may be collected or verified 4074, and customer C may review the forms and sign them 4076. At this point, the forms stored on the cloud or other storage device may be updated 4076A to reflect signed forms. User A may also sign forms 4078 as necessary and appropriate updating 4078A in the stored forms may again occur. The forms may then be finalized and/or combined as necessary and saved to storage 4080.

Application 4000 may then conclude with a module whereby the necessary forms are provided to customer B. This may occur by e-mail 4082, or alternatively, by printing 4082A and physically providing them to customer B, or by loading the forms on a USB drive 4082B for customer B.

In view of the foregoing, it can be seen how the computer application of the current invention improves the operation of a computer by addressing many different steps of a transaction by internally providing functionality that would typically require accessing a separate application. Alternatively, application 4000 of the current invention may readily access third party services without wasting time associated with accessing separate applications.

The infrastructure of system 5000 which provides application 4000 is now further described with reference to FIG. 88. As shown, system 5000 may include application server 5002 on which application 4000 may reside. Application server 5002 may interface with database server 5004, cloud file storage or other type of storage 5006, third party data service(s) 5008 (to the extent such services are not included within application 4000), e-mail service 5010 and user device 5012, which may itself comprise a PC, tablet, laptop, smartphone or other suitable device. Application server 5002 may comprise a LAMP stack and database server 5004 may comprise Lin with MySQL.

As the transaction proceeds as shown in FIGS. 87A-87B, the user may send various user requests 5020 to application server 5002. Depending on the type of user request, application server 5002 may communicate with database server 5004 via SQL, may send and receive various types of files, e.g., PDF, JPG, GIF, PNG and SQL backups, with cloud file or other storage 5006. Application server 5002 may also send requests to third party services and receive back data or, if appropriate, some type of error message. Application server may also request that e-mail service 5010 send an e-mail 5022 to the user, and when doing so, e-mail service may advise application server 5002 whether the e-mail was successfully sent or not.

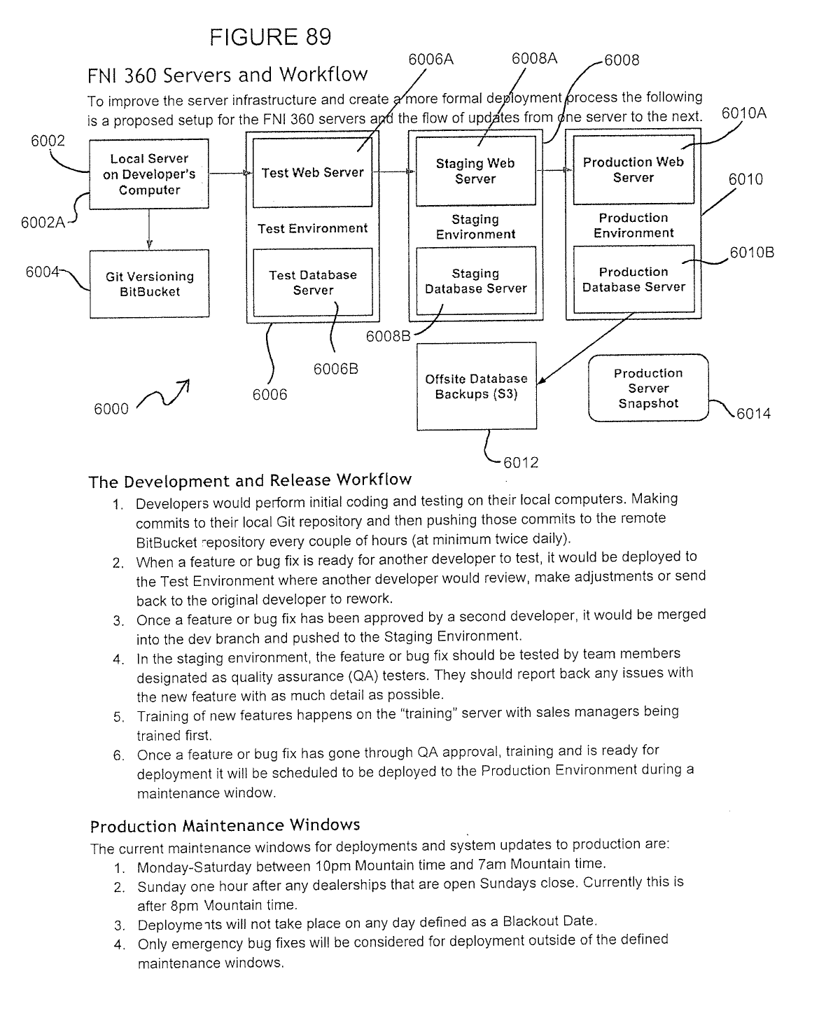

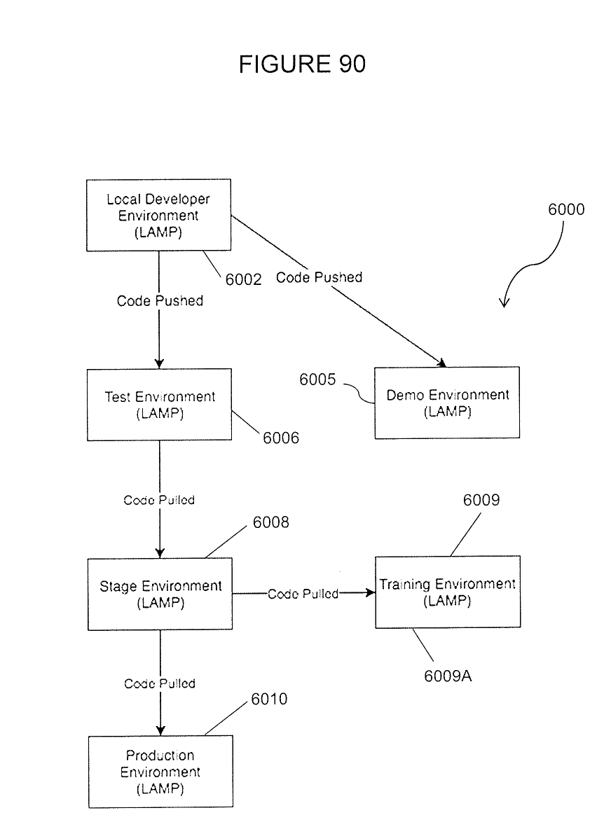

Unique aspects of the current invention regarding the manner in which the application 4000 may be deployed and developed are now discussed with reference to FIGS. 89 and 90. More specifically, these aspects of the current invention regard the server infrastructure of system 5000 and workflow, e.g., flow of updates from one server to the next. With these aspects of the current invention, application 4000 may be tested, demonstrated or used for training while development work continues simultaneously. This provides various benefits, e.g., allowing efficient deployment of application 4000 while bugs are fixed, etc.

FIGS. 89-90 show an embodiment of a server infrastructure and workflow 6000 which contemplates one or more developers, as well as one or more users, managers and/or others to whom demonstrations may be made or who may be trained on application 4000.

As shown, developers may perform initial coding and testing on their local computers 6002. As such, the developers may work onsite or remotely. The developers may make commits to their local Git repository 6002A, and may then push those commits to the remote BitBucket repository 6004. It is preferred that this occur every few hours or at some other interval so that the developers' progress may be assessed in real time. For example, the developers may push their commits to repository 6004 twice daily.

When the feature, bug fix or other aspect of application 4000 has been coded on a local developer computer 6002, the code may be pushed to demo environment 6005 as shown in FIG. 90 where the item may be demonstrated to appropriate individuals. The demo may lead to suggestions for further coding by the developer.

When a feature, bug fix or other aspect of application 4000 is ready for another developer to test, it may be deployed, i.e., code pushed, to test environment 6006, which may include test web server 6006A and test database server 6006B. At this point, another developer may review, revise or send back the item being tested to the original developer to rework or further develop. Alternatively, the second developer may approve the item for further processing.

Once a feature, bug fix or other aspect of application 4000 has been approved by a second developer, the item may be merged into the development branch and code may be pulled to staging environment 6008, which may include production web server 6008A and production database server 6008B. In staging environment 6008, the item is preferably tested by development team members designated as quality assurance (QA) testers. The QA testers preferably report back any issues with the new item with as much detail as possible. Where issues are encountered, the item may be sent back to the original developer who may then further work on the item at his or her local computer 6002. The foregoing development and approval process may again occur as necessary.

At this point, the item may also be merged, i.e., code pulled, into training environment 6009. Training of new features may occur on training server 6009A, and it is preferred that sales managers be trained first, so that they may see what features are coming in the future and so that they may help train and/or supervise their subordinates.

Once a feature, bug fix or other aspect of application 4000 has gone through QA approval and training, and is ready for deployment as part of application 4000, the item may be scheduled to be deployed, i.e., code pulled, to production environment 6010, which may itself include production web server 6010A and production database server 6010B. To avoid disrupting any existing use of application 4000, this deployment preferably occurs during a maintenance window.

Production maintenance windows for deployments and system updates to production may be scheduled as desired. But in a preferred embodiment, however, these events occur outside of business hours and take the business location's time zone into account. Accordingly, developers working remotely in another time zone would need to take that into account. Certain blackout dates may also be established so that deployments and maintenance do not occur during those times. It is preferred that only emergency bug fixes be considered for deployment outside of the defined maintenance windows.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A system for processing a transaction, comprising:
a plurality of graphical user interface screens;
wherein the plurality of graphical user interface screens facilitate the processing of one or more of the following steps of a transaction: user login, customer search, base payment determination, base payment import, preliminary transaction confirmation, deal structuring, product selection, cost and coverage verification, product selection and finalization, and customer repayment option presentation.
